(19) United States
(12) Patent Application Publication
(10) Pub. No.: US 2024/0247114 A1
(43) Pub. Date: Jul. 25, 2024

(54) HYBRID STARCH/PVOH FILMS WITH BIO-CONTENT

(71) Applicant: MONOSOL, LLC, Merrillville, IN (US)

(72) Inventors: James A. Clark, Asheville, NC (US); Tyberius Torres, LaPorte, IN (US)

(21) Appl. No.: 18/399,001

(22) Filed: Dec. 28, 2023

Related U.S. Application Data
(60) Provisional application No. 63/477,561, filed on Dec. 28, 2022.

(51) Int. Cl. C08J 5/18; C08L 3/02; C08L 29/04; C11D 17/04

(52) U.S. Cl. CPC C08J 5/18; C08L 3/02; C08L 29/04; C11D 17/043; C08J 2303/02; C08J 2329/04; C08J 2403/02; C08J 2429/04; C08L 2201/54; C11D 2111/12; C11D 2111/14

(57) ABSTRACT

Provided herein are water-soluble films comprising a water soluble polymer such as polyvinyl alcohol (PVOH) and high content of water-soluble starch, and related water-soluble film forming solutions, articles made therefrom e.g., pouches or packets, and methods of preparation and use of same.

### CROSS-REFERENCE TO RELATED APPLICATION

The benefit under 35 U.S.C. § 119(e) of U.S. Provisional Patent Application No. 63/477,561, filed Dec. 28, 2022, is claimed and the entire disclosure thereof is incorporated herein by reference.

### FIELD OF THE INVENTION

The present disclosure relates generally to water-soluble films and related water-soluble film forming solutions, articles including pouches or packets made therefrom, and methods of preparation and use of same. More specifically, the present disclosure relates to water-soluble films comprising a water-soluble polymer such as polyvinyl alcohol (PVOH) and high content of starch, and related water-soluble film forming solutions, articles made therefrom e.g., pouches or packets, and methods of preparation and use of same.

### BACKGROUND

Water-soluble polymeric films are commonly used as packaging materials to simplify dispersing, pouring, dissolving and dosing of a composition to be delivered. For example, packets made from water-soluble film are commonly used to package household care compositions, e.g., a pouch containing a laundry or dish detergent. A consumer can directly add the packaged composition in the pouch to a mixing vessel, such as a bucket, sink or any vessel suitable for holding water. Advantageously, this provides for accurate dosing while eliminating the need for the consumer to measure the composition. The packaged composition may also reduce mess that would be associated with dispensing a composition from a product container, such as pouring or scooping a material. In sum, soluble pre-measured polymeric film pouches provide for convenience of consumer use in a variety of applications.

Currently consumers are increasingly inclined to use environmentally friendly or renewable products. However, one problem with conventional water-soluble films is that such films are not generally environmentally friendly or renewable and typically have a low renewable carbon index (RCI). Moreover, because many renewable components are very stiff in nature and are not miscible or compatible with the other polymeric components in conventional water-soluble films, their use in these films has been limited due to a need to maintain mechanical properties suitable for conversion into and use as packages, e.g. a high level of elongation, deformation recovery, and strength properties.

### SUMMARY

Embodiments disclosed herein address the foregoing needs by providing sustainable water-soluble films for use with consumer compositions such as liquid detergents, and sustainable consumer compositions that are packaged in the sustainable water-soluble films to result in a highly-sustainable, eco-friendly consumer product. The water-soluble films can have a high renewable carbon index (RCI) of 50% or higher and also desirable physical properties.

One aspect of the disclosure provides a water-soluble film comprising: a water-soluble polyvinyl alcohol (PVOH); and a water-soluble starch, wherein the water-soluble starch has a cook % of at least about 5 wt. %, wherein the water-soluble starch can be present in an amount of about 5-65 wt. % by weight of the water-soluble film, and wherein the PVOH and the water-soluble starch are miscible or have a phase domain smaller than 2000 μm in the water-soluble film. The water-soluble polyvinyl alcohol can be dissolvable in water at a temperature of about 60° C. or less within about 60 minutes, or dissolvable in water at a temperature of about 60° C. within about 60 minutes, dissolvable in water at a temperature of about 40° C. within about 60 minutes, dissolvable in water at a temperature of about 20° C. within about 60 minutes, or dissolvable in water at a temperature of about 10° C. within about 60 minutes. The water-soluble polyvinyl alcohol can comprise an anionic group-modified polyvinyl alcohol. The water-soluble starch can comprise a cationic group-modified starch. The water-soluble starch can comprise a neutral group-modified starch.

Another aspect of the disclosure provides an aqueous solution suitable for forming a water-soluble film of the disclosure, the aqueous solution comprising: a water-soluble polyvinyl alcohol (PVOH); a water-soluble starch; and water, wherein the water-soluble starch has a cook % of at least about 5 wt. %, wherein the aqueous solution has a total solid content of at least 15 wt. % by weight of the aqueous solution, wherein the water-soluble starch can be present in an amount of about 5-65 wt. % by weight of the total solid content, and wherein the water-soluble polyvinyl alcohol (PVOH) and the water-soluble starch are miscible or have no bulk phase separation in the aqueous solution for at least 24 hours at a temperature in a range of about 20° C. to 100° C. by visual inspection.

Another aspect of the disclosure provides a method of forming a water-soluble film of the disclosure, the method comprising: casting the aqueous solution of the disclosure onto a substrate at a specified thickness; and drying water from the cast aqueous solution to form the water-soluble film.

Another aspect of the disclosure provides an article comprising a pouch or packet made of the water-soluble film of the disclosure defining an interior pouch volume. The article may further comprise a consumer or chemical composition contained in the interior pouch volume and enclosed inside the pouch.

For the water-soluble films, the aqueous solutions for forming the water-soluble film, and the articles described herein, optional features, including but not limited to components and compositional ranges thereof, film forming materials, film forming solution compositions and features, and/or mechanical properties are contemplated to be selected from the various aspects and embodiments provided herein.

Further aspects and advantages will be apparent to those of ordinary skill in the art from a review of the following detailed description. While the water-soluble films, aqueous solutions and articles of the disclosure are susceptible of embodiments in various forms, the description hereafter includes specific embodiments with the understanding that the disclosure is illustrative and is not intended to limit the disclosure to the specific embodiments described herein.

### BRIEF DESCRIPTION OF THE DRAWINGS

For further facilitating the understanding of the present disclosure, the drawing figures are appended hereto. The drawings described herein are for illustrative purposes only of selected embodiments and not all possible implementations and are not intended to limit the scope of the present disclosure.

FIGS. 1A and 1B shows an image of the single phase aqueous solution Sample 2 with Starch A and Resin A at starch loading level of 55 PHR; and an image of the solution phase separation of aqueous solution Sample 6 with Starch E and Resin A at starch loading level of 49 PHR respectively.

FIG. 2 plots the cold-water dissolution and disintegration times for films according to Example 1.

FIGS. 3A to 3C are micrographs of stretched and unstretched films as described in Example 2.

FIG. 4 is an illustration of film moisture content as a function of ambient humidity, as described in Example 8.

FIG. 5 is an illustration of a Dynamic Vapor Sorption test result as described in Example 8.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. A non-limiting discussion of terms and phrases intended to aid understanding of the present technology is provided at the end of this Detailed Description.

Conventional water-soluble films have high raw material cost because of the high loading content of water-soluble polymers, such as polyvinyl alcohol (PVOH), in the formulations. PVOHs are typically petroleum-derived polymer products. The increase in the price of oil, and concomitant petroleum-derived products, have led to volatile prices and supply for many polymer products. The present invention can be used in a way to replace petroleum-based polymers with those derived from renewable sources such as plants, as such materials are relatively cheaper and more environmentally friendly and are therefore both economically and socially beneficial. Previously, it had been challenging to achieve a desired miscibility between a water-soluble polymer and high loading levels of renewable components such as starch in an aqueous solution for water-soluble film forming process, e.g. solution casting, which in turn led to phase separation of the water-soluble polymer and the renewable components, and either the inability to form films or unacceptable degrees of phase separation of the water-soluble polymer and renewable components in the resulting water-soluble film. Previous water-soluble films employing high levels of renewable components, such as starch, have also had one or more negative aspects, including poor processability, high brittleness, limited flexibility, and poor water solubility, low pouch compression strength and poor mechanical strength properties.

The present disclosure provides a water-soluble film comprising a water-soluble polyvinyl alcohol and a water-soluble starch at high loading levels of the starch and related aqueous solutions for forming the water-soluble film, pouches or packets, and methods of preparing and using same.

One aspect of the disclosure provides a water-soluble film comprising: a water-soluble polyvinyl alcohol (PVOH); and a water-soluble starch, wherein the water-soluble starch has a cook % of at least about 5 wt. %, wherein the water-soluble starch is present in an amount of about 5-65 wt. % by weight of the water-soluble film, and wherein the PVOH and the water-soluble starch are miscible or each have an average phase domain size smaller than about 2000 μm, about 1500 μm, about 1000 μm, about 900 μm, about 800 μm, about 700 μm, about 600 μm, about 500 μm, about 400 μm, about 300 μm, about 200 μm, about 100 μm, about 90 μm, about 80 μm, about 70 μm, about 60 μm, about 50 μm, about 40 μm, about 30 μm, about 20 μm, about 10 μm, or even about 1 μm in the water-soluble film. Domain size can be measured by various methods, such as Atomic Force Microscopy (AFM), Time-of-Flight Secondary Ion Mass Spectrometry (ToF-SIMS), and refractive methods including optical refraction and x-ray refraction. In one aspect, the domain size can be measured by AFM.

As used herein and unless specified otherwise, the term “water-soluble polyvinyl alcohol” refers to a polyvinyl alcohol dissolvable in water in water at a temperature of about 60° C. within about 60 minutes, about 50, about 40, about 30, about 20, about 10, about 5, or about 3 minutes. The water-soluble polyvinyl alcohol can be dissolvable in water at a temperature of about 40° C. within about 60 minutes, about 50, about 40, about 30, about 20, about 10, about 5, or about 3 minutes. The water-soluble polyvinyl alcohol can be dissolvable in water at a temperature of about 10° C. within about 60 minutes, about 50, about 40, about 30, about 20, about 10, about 5, or about 3 minutes.

The water-soluble polyvinyl alcohol can comprise one or more polyvinyl alcohol homopolymers and/or copolymers, e.g., one or more selected from an unmodified polyvinyl alcohol, a non-ionic group-modified polyvinyl alcohol, an anionic group-modified polyvinyl alcohol, and a cationic group-modified polyvinyl alcohol. The water-soluble polyvinyl alcohol can comprise an anionic group-modified polyvinyl alcohol. The water-soluble starch can comprise one or more starches selected from an unmodified starch, a non-ionic group-modified starch, an anionic group-modified starch, and a cationic group-modified starch. The water-soluble starch can comprise a cationic group-modified starch. The water-soluble polyvinyl alcohol can comprise an anionic group-modified polyvinyl alcohol, and the water-soluble starch can comprise a cationic group-modified starch.

The water-soluble film can be a free-standing film, i.e., one which does not require a substrate in order to maintain integrity of the film structure, and optionally one which does not include such a substrate.

The water-soluble film can have any renewable carbon index (RCI) and optionally one of at least about 30%, 40%, 50%, 55%, 60%, 65%, 70%, or 80%, or in a range of about 50-90%, or about 50-80%, for example.

The water-soluble starch can comprise substantially gelatinized starch.

The water-soluble starch can have a cook % of at least about 5 wt. %, at least 6 wt. %, at least about 7 wt. %, at least about 8 wt. %, at least about 9 wt. %, at least about 10 wt. %, at least about 11 wt. %, at least about 12 wt. %, at least about 13 wt. %, at least about 14 wt. %, at least about 15 wt. %, at least about 16 wt. %, at least about 17 wt. %, at least about 18 wt. %, at least about 19 wt. %, at least about 20 wt. %, at least about 21 wt. %, at least about 22 wt. %, at least about 23 wt. %, at least about 24 wt. %, at least about 25 wt. %, at least about 26 wt. %, at least about 27 wt. %, at least about 28 wt. %, at least about 29 wt. %, or at least about 30 wt. %, or in a related range, e.g. at least 10 wt. % and up to 40 wt. %, or at least 10 wt. % and up to 30 wt. %, for example. The water-soluble starch can have cook % of at least about 15 wt. %.

The water-soluble starch can have an average molecular weight in a range of about 10³-10⁷ g/mol, or about 10³-10⁶ g/mol or about 10⁴-10⁵ g/mol.

The water-soluble starch can comprise an amylose content in a range of about 0-50 wt. %, about 0-40 wt. %, about 0-30 wt. %, or about 0-25 wt. % of the water-soluble starch.

The water-soluble starch can have a 5 wt. % aqueous solution Brookfield viscosity in a range of about 1-2000 cP, about 1-1500 cP, about 1-1000 cP, about 1-900 cP, about 1-800 cP, about 1-700 cP, about 1-600 cP, about 1-500 cP, about 2-400 cP, about 2-300 cP, about 2-200 cP, or about 2-100 cP at a shear rate of about 20 rpm and a temperature of about 87.8° C.

The water-soluble starch can be present in an amount of about 10-65 wt. %, 15-65 wt. %, 20-60 wt. %, about 25-60 wt. %, about 30-60 wt. %, about 30-55 wt. %, about 30-50 wt. %, or about 30-45 wt. % by weight of the water-soluble film.

The water-soluble film can dissolve in water leaving a residue less than about 10 wt. %, about 5.0 wt. %, about 4.0 wt. %, about 3.0 wt. %, about 2.5 wt. %, or about 2.0 wt. % by weight of the water-soluble film at a temperature of about 15° C. according to the Accelerated Quantitative Residue Assessment test method described below. The residue can be measured at a temperature of about 15° C., e.g., leaving a residue of less than 5.0 wt. % by weight of the water-soluble film at a temperature of about 15° C.

The water-soluble starch can comprise an unmodified starch.

The water-soluble starch can comprise a neutral group or non-ionic group-modified starch, optionally having a level of modification of about 0.1-10 mol. %, or about 1-5 mol. %.

The water-soluble starch can comprise a cationic group-modified starch, optionally having a degree of modification of about 0.01-10 mol. %, about 0.1-5 mol. %, about 0.1-2 mol. %, or about 0.1-0.5 mol. %.

The cationic group-modified starch can comprise a cationic quaternary ammonium group-modified starch, e.g. one having a structure of Formula A, wherein R₁, R₂, and R₃ each independently are H or a C₁-C₁₀ alkyl or C₁-C₁₀ hydroxyalkyl group and R₄ is a linear or branched C₁-C₁₀ alkylene or C₁-C₁₀ hydroxyalkylene group, optionally substituted with one or more heteroatom-containing groups, and wherein X is an ether or an ester linkage connecting R₄ to the starch, or an oxygen-, nitrogen-, or sulphur-containing hydrocarbon group.

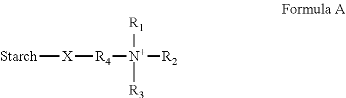

R₁, R₂ and R₃ can be identical C₁-C₄ alkyl groups and R₄ can be a linear or branched C₁-C₆ hydroxyalkylene group. In another aspect, R₄ can be a C₃-C₆ hydroxyalkylene group. In another aspect, R₁, R₂ and R₃ each can be a methyl group and R₄ can be a C₃-C₆ hydroxyalkylene group.

The cationic quaternary ammonium group can be a quaternary 2-hydroxy-3-(trimethylammonium)propyl, 2-diethylaminoethyl, or 2,3-epoxypropyltrimethylammonium group, or a combination thereof.

The cationic group-modified starch can comprise cationic trimethyl ammonium group-modified starch.

The cationic group-modified starch can comprise a starch modified with a 2-diethylaminoethyl salt, a 2,3-epoxypropyltrimethylammonium salt, or a 2-hydroxy-3-(trimethylammonium)propyl salt, or a combination thereof.

The 2-diethylaminoethyl salt can comprise 2-diethylaminoethyl halide, the 2,3-epoxypropyltrimethylammonium salt can comprise 2,3-epoxypropyltrimethylammonium halide, and the 2-hydroxy-3-(trimethylammonium)propyl salt can comprise 2-hydroxy-3-(trimethylammonium)propyl halide.

The 2-diethylaminoethyl salt can comprise 2-diethylaminoethyl chloride, the 2,3-epoxypropyltrimethylammonium salt can comprise 2,3-epoxypropyltrimethylammonium chloride, and the 2-hydroxy-3-(trimethylammonium)propyl salt can comprise 2-hydroxy-3-(trimethylammonium)propyl chloride.

The water-soluble starch further can comprise an unmodified starch, and/or a non-ionic group-modified starch having a level of modification of about 0.05-5 mol %, or about 0.5-5 mol %, or about 1-5 mol %.

The water-soluble polyvinyl alcohol can comprise an unmodified polyvinyl alcohol, an anionic group-modified polyvinyl alcohol, a cationic group-modified polyvinyl alcohol, or a combination thereof.

The polyvinyl alcohol can comprise an anionic group-modified polyvinyl alcohol having a degree of modification in a range of about 0.1-10 mol. %, or about 1.0-5.0 mol. %.

The anionic group-modified polyvinyl alcohol can comprise a polyvinyl alcohol modified with one or more groups derived from itaconic acid, monomethyl maleate (MMM), methyl acrylate (MA), aminopropyl sulfonate, maleic acid, maleic anhydride, vinyl pyrrolidones, n-vinylpyrrolidone, n-vinylcaprolactam, a derivative of any of the foregoing, or a combination thereof.

The anionic group-modified polyvinyl alcohol can comprise the polyvinyl alcohol modified with monomethyl maleate, methyl acrylate, or a combination thereof.

The water-soluble film further can comprise a plasticizer present in a range of about 5.0-50.0 wt. %, about 5.0-40.0 wt. %, or 10.0-40.0 wt. % of by weight of the water-soluble film.

The plasticizer can comprise sorbitol, glycerine, glycerol, diglycerol, propylene glycol, dipropylene glycol, ethylene glycol, diethylene glycol, triethylene glycol, a polyethylene glycol up to MW 400, 2-methyl-1,3-propanediol, ethanolamines, trimethylolpropane (TMP), a polyether polyol, isomalt, maltitol, xylitol, erythritol, adonitol, dulcitol, pentaerythritol, mannitol, a sugar alcohol, or a combination thereof.

The plasticizer can comprise a bio-based plasticizer. The bio-based plasticizer can comprise glycerin and/or sorbitol.

The water-soluble film further can comprise a surfactant.

The surfactant can comprise a linear aliphatic ethoxylated surfactant. The linear aliphatic ethoxylated surfactant can comprise laureth-6 carboxylic acid, a C₉-C₁₅ ethylene oxide, or a combination thereof.

The water-soluble film further can comprise one or more auxiliary agents in the group of an anti-foaming agent, an antioxidant, a disinfectant, an anti-blocking agent, a filler, sodium metabisulfite, sodium hydroxide, a matting agent, a slip agent, a dispersant, or a combination thereof.

The water-soluble film can have a solubility time in water no more than 300 seconds, or in a range of 30-300 seconds at a temperature of about 40° C. according to MSTM-205. The solubility time in water can be no more than 300 seconds or in the range of 30-300 second at a temperature of about 30° C., or about 20° C., or about 15° C. The solubility time in water can be in the range of 30-300 second at a temperature of about 10° C. or alternatively about 5° C.

The water-soluble film can have a maximum stress of at least about 10 MPa, about 11 MPa, about 12 MPa, about 13 MPa, about 14 MPa, about 15 MPa, about 16 MPa, about 17 MPa, about 18 MPa, about 19 MPa, or about 20 MPa. The maximum stress is the stress at break of the water-soluble film.

The water-soluble film can have a strain at break of at least of about 100%, about 150%, about 160%, about 170%, about 180%, about 190%, about 200%, about 210%, about 220%, about 230%, about 240%, or about 250%.

A weight ratio of the polyvinyl alcohol to the water-soluble starch can be in a range of about 10:1 to about 1:8, about 9:1 to about 1:7, about 6:1 to about 1:6, or about 5:1 to about 1:6, or about 4:1 to 1:2, or about 4:1 to about 1:1.

The polyvinyl alcohol can have a degree of hydrolysis in a range from about 74 mol. % to about 99 mol. %, or about 74 mol. % to about 91 mol. %.

The water-soluble film can comprise: a water-soluble anionic group-modified polyvinyl alcohol having a degree of modification of about 1-5 mol. %; and a water-soluble cationic group-modified starch having a degree of modification of 0.05-5 mol. %, and a 5 wt. % aqueous solution Brookfield viscosity in a range of about 1-200 cP at about 20 rpm and about 87.8° C., wherein the cationic group-modified starch has a cook % of at least about 5 wt. %, wherein the cationic group-modified starch is present in an amount of about 20-60 wt. % by weight of the water-soluble film, and wherein the anionic group-modified PVOH and the cationic group-modified starch are miscible or have a phase domain smaller than about 2000 μm, about 1500 μm, about 1000 μm, about 900 μm, about 800 μm, about 700 μm, about 600 μm, about 500 μm, about 400 μm, about 300 μm, about 200 μm, about 100 μm, about 90 μm, about 80 μm, about 70 μm, about 60 μm, about 50 μm, about 40 μm, about 30 μm, about 20 μm, about 10 μm, or about 1 μm, in the water-soluble film.

Another aspect of the disclosure provides an aqueous solution for forming the water-soluble film of the disclosure, the aqueous solution comprising: a water-soluble polyvinyl alcohol (PVOH); a water-soluble starch; and water, wherein the water-soluble starch has a cook % of at least about 5 wt. %, wherein the aqueous solution has a total solid content of at least 15 wt. % by weight of the aqueous solution, wherein the water-soluble starch is present in an amount of about 5-65 wt. % by weight of the total solid content, and wherein the water-soluble polyvinyl alcohol and the water-soluble starch are miscible or have no bulk phase separation in the aqueous solution for at least 24 hours at a temperature in a range of about 5-100° C. by visual inspection. Various aspects of such a film-forming solution will now be described.

The water-soluble polyvinyl alcohol can be dissolvable in water at a temperature of about 60° C. within about 60, about 50, about 40, about 30, about 20, about 10, about 5, or about 3 minutes. The water-soluble polyvinyl alcohol can be dissolvable in water at a temperature of about 40° C. within about 60, about 50, about 40, about 30, about 20, about 10, about 5, or about 3 minutes. The water-soluble polyvinyl alcohol can be dissolvable in water at a temperature of about 40° C. within about 10 minutes. The water-soluble polyvinyl alcohol can be dissolvable in water at a temperature of about 20° C. within about 60, about 50, about 40, about 30, about 20, about 10, about 5, or about 3 minutes.

The total solid content can have a renewable carbon index (RCI) of at least about 30%, or about 40%, about 50%, or about 60%, or about 70%, or about 80%, or about 85%, or about 60%, or in a range of about 50-90%, or about 50-80%.

The water-soluble starch can comprise substantially gelatinized starch.

The water-soluble starch can have a cook % of at least about 5 wt. %, at least about 6 wt. %, at least about 7 wt. %, at least about 8 wt. %, at least about 9 wt. %, at least about 10 wt. %, at least about 11 wt. %, at least about 12 wt. %, at least about 13 wt. %, at least about 14 wt. %, at least about 15 wt. %, at least about 16 wt. %, at least about 17 wt. %, at least about 18 wt. %, at least about 19 wt. %, at least about 20 wt. %, at least about 21 wt. %, at least about 22 wt. %, at least about 23 wt. %, at least about 24 wt. %, at least about 25 wt. %, at least about 26 wt. %, at least about 27 wt. %, at least about 28 wt. %, at least about 29 wt. %, or about 30 wt. %. The water-soluble starch has the cook % of at least about 15 wt. %.

The water-soluble starch can have an average molecular weight in a range of about 10³-10⁶ g/mol, or about 10⁴-10⁵ g/mol.

The water-soluble starch can comprise an amylose content in a range of about 0-50 wt. %, about 0-40 wt. %, or about 0-30 wt. % of the water-soluble starch.

The water-soluble starch can have a 5 wt. % aqueous solution Brookfield viscosity in a range of about 1-2000 cP, about 1-1500 cP, about 1-1000 cP, about 1-900 cP, about 1-800 cP, about 1-700 cP, about 1-600 cP, about 1-500 cP, about 2-400 cP, about 2-300 cP, about 2-200 cP, or about 2-100 cP at a shear rate of about 20 rpm and a temperature of about 87.8° C.

The aqueous solution can have a total solid content of at least about 20 wt. %, about 25 wt. %, or about 32 wt. %, or in a range of about 15-45 wt. %, about 20-40 wt. %, about 25-38 wt. %, or about 28-35 wt. % by weight of the aqueous solution. The total solid content can be in a range of about 25-40 wt. % or about 28-35 wt. % of the aqueous solution.

The water-soluble starch can be present in an amount of about 10-65 wt. %, about 15-65 wt. %, about 20-60 wt. %, about 25-60 wt. %, about 30-55 wt. %, about 30-50 wt. %, or about 30-45 wt. % by weight of the total solid content.

The water-soluble starch can comprise an unmodified starch, a non-ionic group-modified starch, an anionic group-modified starch, and/or a cationic group-modified starch.

The water-soluble starch can comprise a cationic group-modified starch having a degree of modification in a range of about 0.01-10 mol. %, about 0.1-5 mol. %, about 0.1-3 mol. %, about 0.1-2 mol. %, about 0.1-1 mol. %, or about 0.1-0.5 mol. %.

The cationic group-modified starch can comprise a cationic quaternary ammonium group-modified starch, e.g., one having a structure of Formula A, wherein R₁, R₂, and R₃ each independently are H or a C₁-C₁₀ alkyl or C₁-C₁₀ hydroxyalkyl group and R₄ is a linear or branched C₁-C₁₀ alkylene or a C₁-C₁₀ hydroxyalkylene group, optionally substituted with one or more heteroatom-containing groups, and wherein X is an ether or an ester linkage connecting R₄ to the starch, or an oxygen-, nitrogen-, or sulphur containing hydrocarbon group.

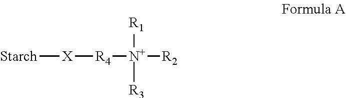

R₁, R₂, and R₃ can be identical C₁-C₄ alkyl groups and R₄ can be a C₁-C₆ hydroxyalkylene group. Alternatively, R₄ can be a C₃-C₆ hydroxyalkylene group. Alternatively, R₁, R₂ and R₃ each can be a methyl group and R₄ can be a C₃-C₆ hydroxyalkylene group.

The cationic quaternary amine group can be a quaternary 2-hydroxy-3-(trimethylammonium)propyl, 2-diethylaminoethyl, 2,3-epoxypropyltrimethylammonium group, or a combination thereof.

The cationic group-modified starch can comprise cationic trimethyl ammonium group-modified starch. The cationic group-modified starch can comprise a starch modified by a cationic trimethyl ammonium salt.

The cationic group-modified starch can comprise a starch modified with a 2-diethylaminoethyl salt, a 2,3-epoxypropyltrimethylammonium salt, or a 2-hydroxy-3-(trimethylammonium)propyl salt, or a combination thereof.

The 2-diethylaminoethyl salt can comprise 2-diethylaminoethyl halide, the 2,3-epoxypropyltrimethylammonium salt can comprise 2,3-epoxypropyltrimethylammonium halide, and the 2-hydroxy-3-(trimethylammonium)propyl salt can comprise 2-hydroxy-3-(trimethylammonium)propyl halide.

The 2-diethylaminoethyl salt can comprise 2-diethylaminoethyl chloride, the 2,3-epoxypropyltrimethylammonium salt can comprise 2,3-epoxypropyltrimethylammonium chloride, and the 2-hydroxy-3-(trimethylammonium)propyl salt can comprise 2-hydroxy-3-(trimethylammonium)propyl chloride.

The water-soluble starch can comprise a combination of the cationic group-modified starch and an unmodified starch.

The polyvinyl alcohol (PVOH) can comprise an unmodified polyvinyl alcohol, a non-ionic group-modified polyvinyl alcohol, an anionic group-modified polyvinyl alcohol, a cationic group-modified polyvinyl alcohol, or a combination thereof.

The polyvinyl alcohol can comprise an anionic group-modified polyvinyl alcohol having a degree of modification of about 0.1-10 mol. %, about 0.5-8 mol. %, about 1-6 mol. %, about 1-5 mol. %, about 1-4 mol. %, or about 1-3.5 mol. %.

The anionic group-modified polyvinyl alcohol can comprise a polyvinyl alcohol modified with one or more groups derived from itaconic acid, monomethyl maleate (MMM), methyl acrylate (MA), aminopropyl sulfonate, maleic acid, maleic anhydride, vinyl pyrrolidones, n-vinylpyrrolidone, n-vinylcaprolactam, a derivative of any of the foregoing, or a combination thereof.

The anionic group-modified polyvinyl alcohol can comprise a polyvinyl alcohol modified with monomethyl maleate, methyl acrylate, or a combination thereof.

The aqueous solution further can comprise a plasticizer present in a range of about 5-40 wt. % by weight of the total solid content.

The plasticizer can comprise sorbitol, glycerine, glycerol, diglycerol, propylene glycol, dipropylene glycol, ethylene glycol, diethylene glycol, triethylene glycol, a polyethylene glycol up to MW 400, 2-methyl-1,3-propanediol, ethanolamines, trimethylolpropane (TMP), a polyether polyol, isomalt, maltitol, xylitol, erythritol, adonitol, dulcitol, pentaerythritol, mannitol, a sugar alcohol, or a combination thereof. The plasticizer can exclude trimethylolpropane (TMP).

The plasticizer can comprise a bio-based plasticizer. The bio-based plasticizer can comprise glycerin and/or sorbitol.

The aqueous solution further can comprise a surfactant.

The surfactant can comprise a linear aliphatic ethoxylated surfactant. The linear aliphatic ethoxylated surfactant can comprise laureth-6 carboxylic acid, a C₉-Cis ethylene oxide, or a combination thereof.

The aqueous solution further can comprise at least one auxiliary agent in the group of an anti-foaming agent, an antioxidant, a disinfectant, an anti-blocking agent, a filler, sodium metabisulfite, sodium hydroxide, a matting agent, a slip agent, a dispersant, or a combination thereof.

A weight ratio of the polyvinyl alcohol to the water-soluble starch can be in a range of about 10:1 to about 1:8, about 9:1 to about 1:7, about 6:1 to about 1:6, or about 5:1 to about 1:6.

Another aspect of the disclosure provides a method of forming a water-soluble film of the disclosure, the method comprising: casting an aqueous solution of the disclosure onto a substrate at a specified thickness; and drying water from the cast aqueous solution to form the water-soluble film.

Another aspect of the disclosure provides an article comprising a pouch or packet made from the water-soluble film of the disclosure and defining an interior pouch volume.

The article may further comprise a consumer or chemical composition contained in the interior pouch volume and enclosed inside the pouch. The chemical composition can be a household care composition. The household care composition can be a laundry detergent or a dishwashing detergent in either liquid or solid form, e.g., in liquid form.

The pouch can have a compression strength of at least about 300 N, at least about 600 N, at least about 800 N, or at least about 1000 N.

The pouch can have a matte to matte type, a matte to gloss type, or a gloss to gloss type of seal, e.g., a matte to matte type of seal.

The pouch can have a release time of the chemical composition no more than 300 seconds after mixing the pouch in water at a temperature of about 20° C. according to the Liquid Release Test described herein. The release time can be in a range of about 30-300, about 30-200, or about 30-150 seconds after mixing the pouch in water at about 20° C., or alternatively a temperature of about 5° C. or about 15° C. according to the Liquid Release Test described herein.

### Water-Soluble Film

The present disclosure provides a water-soluble film comprising a water-soluble polymer and a bio-based polysaccharide at high loading levels. Such a film can have desired physical properties. The bio-based polysaccharide can comprise homopolysaccharides and heteropolysaccharides. The bio-based polysaccharides can include starch, glycogen, galactogen, inulin, cellulose, chitin, hyaluronic acid, heparin, chondroitin-4-sulfate, gamma globulin, or a combination thereof. The bio-based polysaccharide can be a water-soluble bio-based polysaccharide. The water-soluble bio-based polysaccharide can comprise a water-soluble starch. The water-soluble starch can be present in an amount of about 5-65 wt. %, about 10-65 wt. %, about 10-60 wt. %, about 15-60 wt. %, about 20-60 wt. %, about 20-55 wt. %, about 20-50 wt. %, or about 25-45 wt. % by weight of the water-soluble film.

As used herein and unless specified otherwise, the term “water-soluble film” refers to a film having a dissolution time of 300 seconds or less at a temperature of about 40° C. according to MSTM-205 as set forth herein. For example, the dissolution time optionally can be 200 seconds or less, 100 seconds or less, 60 seconds or less, or 30 seconds or less at a temperature of about 80° C., about 70° C., about 60° C., about 50° C., about 40° C., about 20° C., about 10° C., or about 5° C. As used herein and unless specified otherwise, the term “cold-water soluble” refers to any film having a dissolution time of 300 seconds or less at 10° C. as determined according to MSTM-205. For example, the dissolution time optionally can be 200 seconds or less, 100 seconds or less, 60 seconds or less, or 30 seconds at 10° C. A “water-soluble film” at a thickness of 1.5 mil can dissolve in 300 seconds or less at a temperature of 80° C. Optionally, a 1.5 mil (about 38 μm) thick water-soluble film can have a dissolution time of 300 seconds or less, 200 seconds or less, 100 seconds or less, 60 seconds or less, 30 seconds or less, or 20 seconds or less at a temperature of about 70° C., about 60° C., about 50° C., about 40° C., about 30° C., about 20° C., about 10° C., or about 5° C.

As used herein, the term “water-soluble starch” refers to a starch has a cook % of at least about 5 wt. %, for example at least about 6 wt. %, or at least about 7 wt. %, or at least about 8 wt. %, or at least about 9 wt. %, or at least about 10 wt. %, or at least about 11 wt. %, or at least about 12 wt. %, or at least about 13 wt. %, or at least about 14 wt. %, at least about 15 wt. %, at least about 16 wt. %, at least about 17 wt. %, at least about 18 wt. %, at least about 19 wt. %, or at least about 20 wt. %. The starch must be gelatinized in water first to dissolve in water. Gelatinization is the process where water swells starch granules and breaks intermolecular bonds of starch molecules to disrupt the semicrystalline region of the starch in the presence of heat. The inventors surprisingly found that starches with a unique combination of low molecular weight, lower amounts of amylose, and/or the chemical modification of the disclosure are more easily gelatinized and dissolve in water to achieve a cook % of at least about 5 wt. %, or about 10 wt. % or about 15 wt. % after heating and mixing in water at about 95° C. for about 30 minutes and can yield useful water-soluble film forming solutions and related useful water-soluble films and articles made therefrom.

The water-soluble starch can be substantially gelatinized starch in the water-soluble film.

The water-soluble starch can comprise water-soluble unmodified starch, water-soluble modified starch, or a combination thereof. The water-soluble unmodified starches can comprise naturally derived polysaccharides consisting of anhydroglucose units with 1-4a and 1-6a glycoside bonds resulting in linear or branched chains. The linear chains are known as amylose and the branched chains are known as amylopectin. Generally, starches with lower molecular weight and lower amounts of amylose are easier to gelatinize and dissolve in water. The water-soluble unmodified starches may include starches having no chemical moieties added to the polysaccharide. For example, the unmodified starches may include starches that has had its molecular weight reduced by techniques such as acid hydrolysis.

The water-soluble modified starch can comprise physically modified starches, enzyme modified starches, and chemically modified starches. The chemically modified starches can comprise chemically decomposed starch such as acid treated starch, hypochlorous acid-oxidized starch or dialdehyde starch; and non-ionic group-modified starch including esterified starch and etherified starch; and/or ionic group-modified starch including anionic group-modified starch and cationic group-modified starch. The water-soluble starch can include the starches whether unmodified starches or modified starches disclosed herein that have one or more features including desired molecular weight, amylose to amylopectin ratios, and modification type and level to achieve a cook % of at least about 5 wt. %, or about 10 wt. % or at least about 15 wt. % under batch cooking conditions (heating and mixing in water at about 95° C. for about 30 minutes).

The molecular weight, the amylose/amylopectin ratio, and the modification type, and the modification level of the starch can significantly impact the cook % (which is the maximum weight percentage of starch dissolved in water after heating and mixing in water at 95° C. for 30 minutes, often called cook % in the starch industry), the rheology of the resulting starch solution, and further the interaction and miscibility with the polyvinyl alcohol. Unmodified starch directly extracted from a plant often has a cook % of only 1-2%. Starch molecular weight can be reduced through acid hydrolysis, which increases the maximum cook %. Certain types of chemical modifications to starch can increase cook %, inhibit retrogradation, and reduce starch solution viscosity. The chemical modifications are typically located at the 2^{nd} and 3^{rd} carbon of the glucose unit via reactions with the secondary alcohols at those sites. The chemical modifications include examples of nonionic (e.g., hydroxyethyl, hydroxypropyl), anionic (e.g., carboxyl), and cationic (e.g., trimethyl ammonium) modifications of the starch.

A water-soluble starch of the present disclosure can have combination of desired low molecular weight, amylose/amylopectin ratio, and modification type and level, can have a cook % of at least about 5 wt. %, at least about 10 wt. %, at least about 15 wt. %, at least about 16 wt. %, at least about 17 wt. %, at least about 18 wt. %, at least about 19 wt. %, at least about 20 wt. %, or even 25 wt. %, and can have good miscibility with a PVOH of the present disclosure and no phase separation from the PVOH in an aqueous PVOH-based film-forming solution having a total solid content in a range of about 5-50 wt. %, about 10-40 wt. %, about 15-35 wt. %, about 20-35 wt. %, about 25-35 wt. %, about 25-32 wt. %, or even about 32-35 wt. %.

The water-soluble modified starch can comprise a physically modified starch such as discrete amylose or amylopectin, or moist heat processed starch; an enzyme-modified starch such as hydrolyzed dextrin, enzyme decomposed dextrin or amylose; and/or chemically decomposed starch such as acid treated starch, hypochlorous acid-oxidized starch or dialdehyde starch.

The water-soluble modified starch can comprise a chemically modified starch including: non-ionic group-modified starch such as esterified starch and etherified starch; and/or ionic group-modified starch such as anionic group-modified starch and cationic group-modified starch. The esterified starch can include acetic acid esterified starch, succinic acid esterified starch, nitric acid esterified starch, phosphoric acid esterified starch, urea-phosphoric acid esterified starch, xanthic acid esterified starch, acetoacetic acid esterified starch, and the like. The etherified starch can include allyl etherified starch, methyl etherified starch, carboxymethyl etherified starch, hydroxyethyl etherified starch, hydroxypropyl etherified starch, and the like. Non-limiting examples of the nonionic group-modified starch can include hydroxyethyl or hydroxypropyl group-modified starch.

The water-soluble modified starch can comprise ionic group-modified starch including cationic group-modified starch or anionic group-modified starch. The modified starch can comprise anionic group-modified starch. Non-limiting examples of anionic group-modified starch can include carboxyl group-modified starch.

The modified starch can comprise cationic group-modified starch. The cationic group-modified starch can include a cationic amine or ammonium group-modified starch, including a primary amine group-modified starch, a secondary amine group-modified starch, a tertiary amine group-modified starch, or a quaternary amine or ammonium group-modified starch. The cationic group-modified starch can comprise a quaternary ammonium group-modified starch. Non-limiting examples of quaternary ammonium group-modified starch can include trimethylammonium group-modified starch, a starch modified by a 2-diethylaminoethyl halide salt, a starch modified by a 2,3-epoxypropyltrimethylammonium halide salt, and the like.

The modified starch can comprise a chemically modified starch, and the degree of modification of the starch can be in a range of about 0.01-10 mol. %, about 0.05-5 mol. %, about 0.05-4 mol. %, about 0.05-3 mol. %, about 0.05-2 mol. %, about 0.05-1 mol. %, about 0.1-1 mol. %, about 0.1-0.5 mol. %, about 0.1-0.3 mol. %, about 0.05-3.5 mol. %, about 1.0-5.0 mol. %, or about 1-3.5 mol. %, for example about 0.18 mol. % or 0.21 mol. %.

The modified starch can comprise a cationic group-modified starch, and the degree of modification of the starch may be in a range of about 0.01-10 mol. %, about 0.05-5 mol. %, about 0.05-4 mol. %, 0.05-3.5 mol. %, about 0.05-3 mol. %, about 0.05-2 mol. %, about 0.05-1 mol. %, about 0.1-1 mol. %, about 0.1-0.5 mol. %, or about 0.1-0.3 mol. %.

The loading level of the water-soluble starch in the water-soluble film can be relatively high, for example, at least about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, or even higher than about 65 wt. %, or in a range of about 5-70 wt. %, about 10-65 wt. %, about 10-60 wt. %, about 15-60 wt. %, about 20-55 wt. %, about 25-50 wt. %, or about 25-45 wt. % by weight of the dry water-soluble film.

The water-soluble film can exhibit desirable physical properties for applications in pouches and packets for packaging liquid detergent compositions even with high loading levels of the water-soluble starch.

The water-soluble films can further comprise one or more plasticizers, optionally at least one of which is bio-based plasticizer. The water-soluble films can have a high renewable carbon index (RCI) which can be higher than about 50%. The water-soluble film can further comprise one or more of a disinfectant, antioxidant or preservative agents, a defoamer or defoaming agent, a surfactant, an antiblocking agent, a filler, and a matting agent.

The water-soluble film can have a renewable carbon index (RCI) higher than about 30%, about 35%, about 40%, about 45%, about 50%, about 55%, about 60% about 65%, about 70%, about 75%, about 80%, or even about 85%, or in a range of about 30-85%, 40-75%, 45-70%, about 50-75%, or about 50-70%. The water-soluble film can comprise a bio-based plasticizer.

The water-soluble film can dissolve in water with a residue (undissolved film) no more than about 10 wt. % by weight of the water-soluble film at a temperature of about 15° C. according to test method of Accelerated Quantitative Residue Assessment described herein, for example, no more than about 9 wt. %, 8 wt. %, 7 wt. %, 6 wt. %, 5.5 wt. %, 5 wt. %, 4.5 wt. %, 4 wt. %, 3.5 wt. %, 3 wt. %, 2.5 wt. %, 2 wt. %, 1.5 wt. %, 1 wt. %, or 0.5 wt. %, or even 0 wt. % (completely dissolved without undissolved film). The water-soluble film can have a residue of no more than about 7 wt. %, no more than about 6.0 wt. %, no more than about 5.0 wt. %, no more than about 4.0 wt. %, no more than about 3.0 wt. %, or no more than about 3.5 wt. % by weight of the film at a temperature of about 90° C., about 80° C., about 70° C., about 60° C., about 50° C., about 40° C., about 30° C., about 20° C., about 10° C., or about 5° C. The water-soluble film can have a residue no more than about 5.0 wt. % by weight of the film at a temperature in a range of about 5-95° C., at cold water temperature of about 5° C. or about 10° C., or at about room temperatures.

### The Water-Soluble Polyvinyl Alcohol (PVOH)

The water-soluble polymers can include, but are not limited to, a polyvinyl alcohol (PVOH), polyacrylamide, poly(acrylic acid), poly(methacrylic acid), polyvinylpyrrolidone, polyacrylate, water-soluble acrylate copolymer, vinyl pyrrolidone modified PVOH, polyethyleneimine, pullulan, a cellulose ether, copolymers of the foregoing and combinations of any of the foregoing. Such water-soluble polymers, whether PVOH or otherwise are commercially available from a variety of sources.

The water-soluble polymer is or can comprise a water-soluble polyvinyl alcohol (PVOH).

As used herein and unless specified otherwise, the term “water-soluble polyvinyl alcohol” refers to a polyvinyl alcohol dissolvable in water in water at a temperature of about 60° C. within about 60, about 50, about 40, about 30, about 20, about 10, about 5, or about 3 minutes. The water-soluble polyvinyl alcohol can be dissolvable in water at a temperature of about 40° C. within about 60, about 50, about 40, about 30, about 20, about 10, about 5, or about 3 minutes. The water-soluble polyvinyl alcohol can be dissolvable in cold water at about room temperature within about 60, about 50, about 40, about 30, about 20, about 10, about 5, or about 3 minutes. The water-soluble polyvinyl alcohol can be dissolvable in cold water at a temperature of about 10° C. within about 60, about 50, about 40, about 30, about 20, about 10, about 5, or about 3 minutes.

The water-soluble polyvinyl alcohol in a film of the disclosure can include bio-based polyvinyl alcohol. Bio-based polyvinyl alcohol includes polyvinyl alcohol in which at least a portion of the carbon comprising the polyvinyl alcohol is derived from biomass. In particular, bio-based polyvinyl alcohol can include polyvinyl alcohol produced by hydrolysis or saponification of bio-based polyvinyl acetate or of a blend of polyvinyl acetates that includes a bio-based polyvinyl acetate. In turn, bio-based polyvinyl acetate can include polyvinyl acetate produced by polymerizing a bio-based vinyl acetate or a blend of vinyl acetates that includes a bio-based vinyl acetate. In general, bio-based vinyl acetate includes vinyl acetate for which at least a portion of the carbon comprising the vinyl acetate is derived from biomass. Vinyl acetate can be obtained, for instance, by a gas phase reaction of ethylene, acetic acid, and oxygen; bio-based vinyl acetate can refer to vinyl acetate for which at least a portion of the ethylene and/or acetic acid is derived from biomass. For instance, bio-based vinyl acetate includes vinyl acetate obtained by a reaction of ethylene, acetic acid, and oxygen in which at least a portion of the ethylene and/or at least a portion of the acetic acid is bio-based. Accordingly, bio-based polyvinyl alcohol includes polyvinyl alcohol in which a portion of the carbon comprising the polyvinyl alcohol is derived from bio-based ethylene and/or bio-based acetic acid.

Plants that can be a source of bio-based ethylene and/or bio-based acetic acid include, but are not limited to, potato, sweet potato, sugar beet, rice, wheat, palm oil, algae, corn, sugar cane, sorghum, and cassava. Similarly, bio-based acetic acid can be produced by a bioethanol route.

Bio-based polyvinyl alcohol can be characterized by a carbon-14 (¹⁴C) content. In general, biomass-derived resources have a greater abundance of ¹⁴C (i.e., the amount of 14° C. as a percent of total carbon content) relative to petroleum-derived resources. In particular, bio-based ethylene and acetic acid generally have higher abundances of ¹⁴C relative to petroleum-derived ethylene and acetic acid, and in turn bio-based polyvinyl alcohol generally has a higher abundance of ¹⁴C relative to polyvinyl alcohol that is completely petroleum-derived. Accordingly, the abundance of ¹⁴C in a polymer, such as a polyvinyl alcohol resin, can serve as a marker of the polymer's bio-based content. A material's ¹⁴C content can be measured by known means, for instance, by mass spectrometric methods.

The films of the disclosure can include bio-based polyvinyl alcohol, as described in U.S. Patent Application Publication No. 2023/0257491A1, U.S. Patent Application Publication No. 2023/0070770A1, and International Patent Application Publication WO 2022/034906A1, which are hereby incorporated by reference in their entirety. The polyvinyl alcohol resin comprising a film of the disclosure can comprise only petroleum-derived polyvinyl alcohol, or only bio-based polyvinyl alcohol, or a blend of petroleum-derived polyvinyl alcohol and bio-based polyvinyl alcohol. For a film comprising a blend of petroleum-derived (i.e., non-bio-based) polyvinyl alcohol and bio-based polyvinyl alcohol, the ratio of the amounts (by weight) of bio-based polyvinyl alcohol to non-bio-based polyvinyl alcohol is not particularly limited and can be, for instance, in a range of about 99:1 to about 1:99, or about 95:5 to about 5:99, or about 80:20 to about 20:80, or about 70:30 to about 30:70, or about 60:40 to about 40:60.

Generally speaking, polyvinyl alcohol can often be chemically incompatible with starches. However, the present inventors have discovered that phase separation between a water-soluble polyvinyl alcohol (PVOH) and a water-soluble starch may be eliminated or minimized by selectively controlling one or more aspects of the film and film-forming solution, such as the nature of the water-soluble PVOH and water-soluble starch, the types of the plasticizers and other film components, the relative amounts of the film components, and the process for making the water-soluble films.

The present inventors surprisingly found that the phase separation issue of the water-soluble PVOH and the water-soluble starch in the final water-soluble films and/or in the film-forming aqueous solutions during the preparation process can be completely eliminated or minimized, as desired, by selectively using a combination of an ionic group-modified water-soluble polymer, such as an ionic group-modified polyvinyl alcohol (PVOH), and an ionic group-modified starch, to prepare the water-soluble films, even at high solid contents and/or high loading levels of the starch. For example, a combination of an anionic group-modified polyvinyl alcohol (PVOH) and a cationic group-modified starch can be used, and the resulting water-soluble films do not have any phase separation issues in both the water-soluble films and the water-soluble film-forming aqueous solutions. The anionic group-modified PVOH and the cationic group-modified starch were characterized by single glass transition temperature (Tg) measured by differential scanning calorimetry (DSC) test shown in Table 11 of Example 7. In another aspect, a combination of a cationic group-modified polyvinyl alcohol (PVOH) and an anionic group-modified starch can be used to prepare the water-soluble films without any phase separation issues.

The water-soluble polymer can comprise a polyvinyl alcohol (PVOH) resin present in an amount of about 10 wt. % to about 95 wt. %, about 20 wt. % to about 95 wt. %, about 25 wt. % to about 85 wt. %, about 30 wt. % to about 75 wt. %, about 30 wt. % to about 65 wt. %, about 30 wt. % to about 55 wt. %, about 30 wt. % to about 50 wt. %, about 35 wt. % to about 45 wt. %, or about 35 wt. % to about 55 wt. % based on the total weight of the water-soluble film.

The polyvinyl alcohol (PVOH) resin can include a modified polyvinyl alcohol (PVOH) resin and/or an unmodified polyvinyl alcohol (PVOH) resin. The water-soluble polymer can comprise a modified PVOH which includes an anionic group-modified polyvinyl alcohol (PVOH) resin or a cationic group-modified polyvinyl alcohol (PVOH) resin.

The modified (PVOH) can include an anionic group-modified polyvinyl alcohol (PVOH) resin modified with an anionic group selected from the group of an itaconic acid, a monomethyl maleate (MMM), a maleic anhydride, a methyl acrylate (MA), an aminopropyl sulfonate, a maleic acid, a n-vinylpyrrolidone, a n-vinylcaprolactam, a derivative of any of the foregoing, or a combination of any of the foregoing. The degree of modification of the PVOH can be about 0.01-10 mol. %, about 0.05-9 mol. %, about 0.1-8 mol. %, about 0.2-7 mol. %, about 0.3-6 mol. %, about 0.4-5 mol. %, about 0.5-5 mol. %, about 1-5 mol. %, about 1-4 mol. %, or about 1-3.5 mol. %. The modified PVOH can be present in the water-soluble film in an amount of about 10-95 wt. %, about 15-95 wt. %, about 20-85 wt. %, about 25-75 wt. %, about 30-65 wt. %, about 30-55 wt. %, about 35-55 wt. %, or about 30-50 wt. % based on the total weight of the water-soluble film.

Polyvinyl alcohol is a synthetic polymer generally prepared by the alcoholysis, usually termed hydrolysis or saponification, of polyvinyl acetate. Fully hydrolyzed PVOH, where virtually all the acetate groups have been converted to alcohol groups, is a strongly hydrogen-bonded, highly crystalline polymer which dissolves only in hot water—greater than about 140° F. (about 60° C.). If a sufficient number of acetate groups are allowed to remain after the hydrolysis of polyvinyl acetate, that is the PVOH polymer is partially hydrolyzed, then the polymer is more weakly hydrogen-bonded, less crystalline, and is generally soluble in cold water—less than about 50° F. (about 10° C.). As such, the partially hydrolyzed polymer is a vinyl alcohol-vinyl acetate copolymer that is a PVOH copolymer but is commonly referred to as homopolymer PVOH or an unmodified polyvinyl alcohol (PVOH). As used herein, the term “unmodified polyvinyl alcohol” refers to a PVOH that is a fully or partially hydrolyzed polyvinyl acetate and have a vinyl alcohol monomer unit and optionally a vinyl acetate monomer unit (when partially hydrolyzed) without any third monomer unit.

The polyvinyl alcohol includes a modified polyvinyl alcohol, for example, a copolymer. As used herein, the term “modified polyvinyl alcohol” refers to a polyvinyl alcohol resin chemically modified by a chemical group and can include a co-polymer or higher polymer (e.g., ter-polymer) including one or more monomers in addition to the vinyl acetate/vinyl alcohol groups. The modification can be neutral, e.g., provided by an ethylene, propylene, N-vinylpyrrolidone or other non-charged monomer species. In other aspects modification can be a cationic modification, e.g., provided by a positively charged monomer species. In other aspects, the modification can be an anionic modification, e.g., provided by a negatively charged monomer species.

Pyrrolidone comonomers may include compounds having a polymerizable carbon-carbon double bond and a pyrrolidone ring substituent group represented by the following formula:

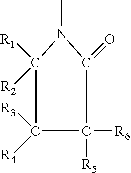

wherein R₁, R₂, R₃, R₄, R₅ and R₆ are each individually selected from a hydrogen atom or an alkyl group, such as an alkyl group having 1 to 8 carbon atoms. Examples of the group represented by the general formula (I) are 2-oxopyrrolidin-1-yl group, 3-propyl-2-oxopyrrolidin-1-yl group, 5-methyl-2-oxopyrrolidin-1-yl group, 5,5-dimethyl-2-oxopyrrolidin-1-yl group, 3,5-dimethyl-2-oxopyrrolidin-1-yl group, and the like. The carbon-carbon double bond contained in the pyrrolidone comonomer may include vinyl, allyl, styryl, acryloxyl, methacryloxyl, vinyloxyl, allyloxyl, and other groups that are copolymerizable with the above noted vinyl esters of aliphatic acids and have a high alkali resistance at the time of copolymer hydrolysis to form the vinyl alcohol copolymer. Examples of the pyrrolidone comonomers may include N-vinyl-2-pyrrolidone, N-vinyl-3-propyl-2-pyrrolidone, N-vinyl-5-methyl-2-pyrrolidone, N-vinyl-5,5-dimethyl-2-pyrrolidone, N-vinyl-3,5-dimethyl-2-pyrrolidone, and N-allyl-2-pyrrolidone, among others.

As used herein, the term “a cationic group-modified polyvinyl alcohol” refers to a polyvinyl alcohol resin chemically modified by a cationic group and can include a partially or fully hydrolyzed PVOH copolymer that includes a cationic monomer unit, a vinyl alcohol monomer unit, and optionally a vinyl acetate monomer unit (i.e., when not completely hydrolyzed). Examples of cationic polyvinyl alcohols include glycidyl-trimethylammonium chloride modified polyvinyl alcohols, and those derived from cationic monomers of acrylamide and methacrylamide derivatives such as N-(1,1-dimethyl-dimethylaminopropyl) acrylamide and N-(dimethyl aminopropyl) methacrylamide and their quaternary ammonium salts.

The polyvinyl alcohol (PVOH) resin can include an anionic modified polyvinyl alcohol. As used herein, the term “anionic group-modified polyvinyl alcohol” or “anionic modified polyvinyl alcohol” refers to a polyvinyl alcohol resin chemically modified by an anionic group and can include a partially or fully hydrolyzed PVOH copolymer that includes an anionic monomer unit, a vinyl alcohol monomer unit, and optionally a vinyl acetate monomer unit (i.e., when not completely hydrolyzed). The PVOH copolymer can include two or more types of anionic monomer units. General classes of anionic monomer units which can be used for the PVOH copolymer include the vinyl polymerization units corresponding to sulfonic acid vinyl monomers and their esters, monocarboxylic acid vinyl monomers, their esters and anhydrides, dicarboxylic monomers having a polymerizable double bond, their esters and anhydrides, and alkali metal salts of any of the foregoing. Examples of suitable anionic monomer units include the vinyl polymerization units corresponding to vinyl anionic monomers including vinyl acetic acid, maleic acid, monoalkyl maleate, dialkyl maleate, monomethyl maleate (MMM), maleic anhydride, dimethyl maleate, methyl acrylate (MA), fumaric acid, monoalkyl fumarate, dialkyl fumarate, monomethyl fumarate, dimethyl fumarate, itaconic acid, monoalkyl itaconate, dialkyl itaconate, monomethyl itaconate, dimethyl itaconate, itaconic anhydride, carboxylic acid, aminopropyl sulfonate, n-vinylpyrrolidone, n-vinyl-caprolactam, citraconic acid, monoalkyl citraconate, dialkyl citraconate, citraconic anhydride, mesaconic acid, monoalkyl mesaconate, dialkyl mesaconate, glutaconic acid, monoalkyl glutaconate, dialkyl glutaconate, glutaconic anhydride, alkyl acrylates, (alkyl)acrylates, vinyl sulfonic acid, allyl sulfonic acid, ethylene sulfonic acid, 2-acrylamido-1-methyl propane sulfonic acid, 2-acrylamide-2-methylpropanesulfonic acid, 2-methylacrylamido-2-methylpropanesulfonic acid, 2-sulfoethyl acrylate, alkali metal salts of the foregoing (e.g., sodium, potassium, or other alkali metal salts), esters of the foregoing (e.g., methyl, ethyl, or other C₁-C₄ or C₆ alkyl esters), and combinations of the foregoing (e.g., multiple types of anionic monomers or equivalent forms of the same anionic monomer).

The polyvinyl alcohol (PVOH) can be modified with an anionic group selected from one or more of maleic acid, monoalkyl maleate, dialkyl maleate, monomethyl maleate (MMM), maleic anhydride, dimethyl maleate, methyl acrylate (MA), an alkali metal salt of any of the foregoing, an ester of any of the foregoing, and a combination of any of the foregoing. The polyvinyl alcohol can be modified with an anionic group consisting of maleic acid, monomethyl maleate, dimethyl maleate, maleic anhydride, an alkali metal salt of any of the foregoing, an ester of any of the foregoing, and a combination of any of the foregoing. The anionic monomer can include one or more of monomethyl maleate and alkali metal salts thereof (e.g., sodium salts).

The PVOH copolymer can include two or more types of monomer units selected from neutral, anionic, and cationic monomer units.

The level of incorporation of the one or more anionic monomer units in the PVOH copolymers can be in a range of about 0.1 mol. % to about 10 mol. %, or about 1 mol. % to about 5 mol. % (e.g., at least about 0.1, 0.5, 1.0, 1.5, 2.0, 2.5, 3.0, 3.5, or 4.0 mol. % and/or up to about 3.0, 4.0, 4.5, 5.0, 5.5, 6.0, 6.5, 7.0, 7.5, 8.0, 8.5, 9.0, 9.5 or 10 mol. %, for example).

The anionic group-modified polyvinyl alcohol can include at least about 0.5 mol. % modification. The anionic group-modified polyvinyl alcohol can include about 1.0 mol. % to about 5.0 mol. % modification. The anionic group-modified polyvinyl alcohol can include about 1.0 mol. % to about 3.5 mol. % modification.

The amount of the anionic group-modified PVOH resin present in the water-soluble film can be in a range of at least about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, or about 90 wt. % and/or up to about 60 wt. %, about 70 wt. %, about 80 wt. %, about 90 wt. %, about 95 wt. %, or about 99 wt. %, by weight of the water-soluble film. The amount of the anionic group-modified PVOH resin can be present in the water-soluble film in a range of about 10-80 wt. %, about 15-75 wt. %, about 20-70 wt. %, about 25-65 wt. %, about 30-55 wt. %, about 30-50 wt. %, or about 30-45 wt. %, based on the weight of the water-soluble film.

The total PVOH resin content of the water-soluble film, when present as either an unmodified PVOH or an anionic group-modified PVOH, can have a degree of hydrolysis (D.H. or DH) of about 60 mol. %, least about 70 mol. %, about 74 mol. %, about 80 mol. %, about 84 mol. %, about 85 mol. %, about 88 mol. %, about 90 mol. %, about 91 mol. %, or about 94 mol. % and at most about 99 mol. %, about 98 mol. %, about 96 mol. %, about 95 mol. %, about 94 mol. %, about 93 mol. %, about 92 mol. %, or about 91 mol. %, for example in a range of about 74 mol. % to about 99 mol. %, or about 74 mol. % to about 91 mol. %. As used herein, the degree of hydrolysis is expressed as a mole percentage of vinyl acetate units converted to vinyl alcohol units. The PVOH can have a degree of hydrolysis of at least about 74 mol. %. The PVOH can have a degree of hydrolysis of at most 99 mol. %. The PVOH can have a degree of hydrolysis of at most about 91 mol. %. The PVOH can have a degree of hydrolysis in a range of about 74-99 mol. %, or about 74-91 mol. %.

Polyvinyl alcohols can be subject to changes in solubility characteristics. The acetate group in the co-poly(vinyl acetate vinyl alcohol) polymer (PVOH homopolymer) is known by those skilled in the art to be hydrolyzable by either acid or alkaline hydrolysis. As the degree of hydrolysis increases, a polymer composition made from the PVOH homopolymer will have increased mechanical strength and reduced solubility at lower temperatures (e.g., requiring hot water temperatures for complete dissolution). Accordingly, exposure of a PVOH homopolymer to an alkaline environment (e.g., resulting from a laundry bleaching additive) can transform the polymer from one which dissolves rapidly and entirely in a given aqueous environment (e.g., a cold-water medium) to one which dissolves slowly and/or incompletely in the aqueous environment, potentially resulting in undissolved polymeric residue at the end of a wash cycle.

PVOH copolymers with pendant carboxyl groups, such as, for example, vinyl alcohol/hydrolyzed methyl acrylate (MA) sodium salt polymers, can form lactone rings between neighboring pendant carboxyl and alcohol groups, thus reducing the water solubility of the PVOH copolymer. In the presence of a strong base, the lactone rings can open over the course of several weeks at relatively warm (ambient) and high humidity conditions (e.g., via lactone ring-opening reactions to form the corresponding pendant carboxyl and alcohol groups with increased water solubility). Thus, contrary to the effect observed with PVOH homopolymers, it is believed that such a PVOH copolymer can become more soluble due to chemical interactions between the polymer and an alkaline composition inside the pouch during storage. Consequently, as they age, the packets may become increasingly prone to premature dissolution during a hot wash cycle (nominally 40° C.), and may in turn decrease the efficacy of certain laundry actives due to the presence of the bleaching agent and the resulting decrease in pH.

Specific sulfonic acids and derivatives thereof having polymerizable vinyl bonds can be copolymerized with vinyl acetate to provide cold-water soluble PVOH polymers which are stable in the presence of strong bases. The base-catalyzed alcoholysis products of these copolymers, which are used in the formulation of water-soluble films, are vinyl alcohol-sulfonate salt copolymers which are rapidly soluble. The sulfonate group in the PVOH copolymer can revert to a sulfonic acid group in the presence of hydrogen ions, but the sulfonic acid group still provides excellent cold-water solubility of the polymer. Optionally, vinyl alcohol-sulfonate salt copolymers can contain no residual acetate groups (i.e., are fully hydrolyzed) and therefore are not further hydrolysable by either acid or alkaline hydrolysis.

Generally, as the amount of modification increases, the water solubility increases, thus sufficient modification via sulfonate or sulfonic acid groups inhibits hydrogen bonding and crystallinity, enabling solubility in cold water. In the presence of acidic or basic species, the copolymer is generally unaffected, with the exception of the sulfonate or sulfonic acid groups, which maintain excellent cold water solubility even in the presence of acidic or basic species. Examples of suitable sulfonic acid comonomers (and/or their alkali metal salt derivatives) include vinyl sulfonic acid, allyl sulfonic acid, ethylene sulfonic acid, 2-acrylamido-1-methylpropanesulfonic acid, 2-acrylamido-2-methylpropanesufonic acid, 2-methacrylamido-2-methylpropancsulfonic acid and 2-sulfoethyl acrylate, with the sodium salt of 2-acrylamido-2-methylpropanesulfonic acid (AMPS) being a preferred comonomer.

The water-soluble polymers, whether polyvinyl alcohol polymers or otherwise, can be blended. When the polymer blend includes a blend of polyvinyl alcohol polymers, the PVOH polymer blend can include a first PVOH polymer (“first PVOH polymer”) which can include a PVOH homopolymer or a PVOH copolymer including one or more types of anionic monomer units (e.g., a PVOH ter- (or higher co-) polymer) and a second PVOH polymer (“second PVOH polymer”) which can include a PVOH homopolymer or a PVOH copolymer including one or more types of anionic monomer units (e.g., a PVOH ter- (or higher co-) polymer). In some aspects, the PVOH polymer blend includes only the first PVOH polymer and the second PVOH polymer (e.g., a binary blend of the two polymers). Alternatively or additionally, the PVOH polymer blend or a water-soluble film made therefrom can be characterized as being free or substantially free from other polymers (e.g., other water-soluble polymers generally, other PVOH-based polymers specifically, or both). As used herein, “substantially free” means that the first and second PVOH polymers make up at least 95 wt. %, at least 97 wt. %, or at least 99 wt. % of the total amount of water-soluble polymers in the water-soluble fiber or film.

In other aspects, the water-soluble film can include one or more additional water-soluble polymers. For example, the PVOH polymer blend can include a third PVOH polymer, a fourth PVOH polymer, a fifth PVOH polymer, etc. (e.g., one or more additional PVOH homopolymers or PVOH copolymers, with or without anionic monomer units). For example, the water-soluble film can include at least a third (or fourth, fifth, etc.) water-soluble polymer which is other than a PVOH polymer (e.g., other than PVOH homopolymers or PVOH copolymers, with or without anionic monomer units).

The degree of hydrolysis (DH) of the PVOH homopolymers and modified PVOH copolymers included in the water-soluble films of the present disclosure can be in a range of about 60% to about 99%, or about 74% to about 99% (e.g., about 74% to about 91%, about 79% to about 92%, about 80% to about 90%, about 88% to 92%, about 86.5% to about 89%, or about 88%, 90% or 92% such as for cold-water soluble compositions; about 90% to about 99%, about 92% to about 99%, about 95% to about 99%, about 98% to about 99%, about 98% to about 99.9%, about 96%, about 98%, about 99%, or greater than 99% such as for hot-water soluble compositions. As the degree of hydrolysis is reduced, a water-soluble film made from the polymer will have reduced mechanical strength but faster solubility at temperatures below about 20° C. As the degree of hydrolysis increases, a water-soluble film made from the polymer will tend to be mechanically stronger but slower solubility at temperatures below about 20° C. The degree of hydrolysis of the PVOH can be chosen such that the water-solubility of the polymer is temperature dependent, and thus the solubility of a film made from the polymer and additional ingredients is also influenced. In one option the film is cold water-soluble. For a co-poly(vinyl acetate vinyl alcohol) polymer that does not include any other monomers (e.g., a homopolymer not copolymerized with an anionic monomer) a cold water-soluble film, soluble in water at a temperature of less than 10° C., can include PVOH with a degree of hydrolysis in a range of about 74% to about 91%, or in a range of about 80% to about 90%, or in a range of about 85% to about 90%. In another option the film is hot water-soluble. For a co-poly(vinyl acetate vinyl alcohol) polymer that does not include any other monomers (e.g., a homopolymer not copolymerized with an anionic monomer) a hot water-soluble film, soluble in water at a temperature of at least about 60° C., can include PVOH with a degree of hydrolysis of at least about 98%.

When a PVOH polymer is referred to as having a specific degree of hydrolysis, the PVOH polymer will be understood to be a single polyvinyl alcohol polymer having the specified degree of hydrolysis and a blend of polyvinyl alcohol polymers having an average degree of hydrolysis as specified will generally be referred to by an average (e.g., weight average) degree of hydrolysis.

The viscosity of a PVOH polymer (u) is determined by measuring a freshly made solution using a Brookfield LV type viscometer with UL adapter as described in BS EN ISO 15023-2:2006 Annex E Brookfield Test method. It is international practice to state the viscosity of 4% aqueous polyvinyl alcohol solutions at 20° C. All viscosities specified herein in Centipoise (cP) should be understood to refer to the viscosity of 4% aqueous polyvinyl alcohol solution at 20° C., unless specified otherwise. Similarly, when a polymer is described as having (or not having) a particular viscosity, unless specified otherwise, it is intended that the specified viscosity is the average viscosity for the polymer, which inherently has a corresponding molecular weight distribution. Additionally, when a resin includes a blend of one or more PVOH polymers and the resin/blend is described as having (or not having) a particular viscosity, unless specified otherwise, it is intended that the specified viscosity is the weighted average viscosity for the resin/blend, which inherently has a corresponding weighted average molecular weight distribution.

In embodiments wherein the water-soluble film includes PVOH, the PVOH can have a viscosity average of at least about 4 cP, about 5 cP, about 6 cP, about 8 cP, about 10 cP, about 12 cP, about 13 cP, about 13.5 cP, about 14 cP, about 15 cP, about 16 cP, about 17 cP, about 18 cP, about 19 cP, or about 20 cP and at most about 30 cP, about 28 cP, about 27 cP, about 26 cP, about 24 cP, about 22 cP, about 20 cP, about 19 cP, about 18 cP, or about 17.5 cP, for example in a range of about 10 cP to about 30 cP, or about 13 cP to about 27 cP, or about 13.5 cP to about 20 cP, or about 18 cP to about 22 cP, or about 14 cP to about 19 cP, or about 16 cP to about 18 cP, or about 17 cP to about 16 cP, for example 23 cP, or 20 cP, or 16.5 cP. It is well known in the art that the viscosity of PVOH polymers is correlated with the weight average molecular weight of the PVOH polymer, and often the viscosity is used as a proxy for the weight average molecular weight.

Other water-soluble polymers that can be used in the water-soluble film can include, but are not limited to polyvinyl acetates, ethylene vinyl alcohols, polyacrylates, poly(meth)acrylates, water-dispersible acrylate copolymers, polyvinylpyrrolidone, polyethyleneimine, polyalkylene oxides, polyacrylamides, polyacrylic acids and salts thereof, polymethacrylic acids, polycarboxylic acids and salts thereof, polyaminoacids, polyamides, gelatins, quaternary ammonium polymers, polymethacrylates, and combinations of any of the foregoing. Water-soluble polymers, whether PVOH or otherwise are commercially available from a variety of sources.

### Water-Soluble Starch

The water-soluble starch of the disclosure can include a modified starch and/or an unmodified starch. Starches have a variety of molecular weights and amylose/amylopectin content based on its source. These starches can be further processed to reduce molecular weight (e.g., via acid hydrolysis) and by chemical modifications. These factors affect the case of gelatinization (the process of starch granules dissolving in water during mixing) and the maximum solubility of starch in water after gelatinization (cook %). For example, low molecular weight starches are needed which dissolve at a high weight percent in water with high weight percentages of PVOH present.

Examples of unmodified starch include, for instance, a raw starch such as corn starch, potato starch, sweet potato starch, wheat starch, cassava starch, sago starch, tapioca starch, rice starch, bean starch, kudzu starch, bracken starch, lotus starch, water chestnut starch, or the like. The unmodified starches are naturally derived polysaccharides consisting of anhydroglucose units with 1-4a and 1-6a glycoside bonds resulting in linear or branched chains. Linear chains are known as amylose and branched chains are known as amylopectin. Branching in amylopectin usually occurs in ˜1/25 repeat units. Unmodified starches may also include starches having no chemical moieties added to the polysaccharide. For example, unmodified starches may include starches that has had its molecular weight reduced by techniques such as acid hydrolysis.

The water-soluble starch can have an amylose content of about 0-50 wt. %, about 0-30 wt. %, or about 0-25 wt. % by weight of the water-soluble starch, or about 1% to about 30%, or about 5% to about 30%.

The water-soluble starch can comprise substantially gelatinized starch in the water-soluble films and also in the aqueous solutions for forming the water-soluble films. The water-soluble starch can be substantially or completely amorphous substantially without starch crystalline or semicrystalline region in the water-soluble film and the aqueous solutions.

The water-soluble starch can have low molecular weight, for example, an average molecular weight in a range of about 10³-10⁶ g/mol, 10³-5×10⁵ g/mol, 10³-10⁵ g/mol, about 10³-5×10⁴ g/mol, or about 10³-10⁴ g/mol. The water-soluble starch can have a 5 wt. % aqueous solution Brookfield viscosity in a range of about 1-2000 cP, about 1-1000 cP, about 1-500 cP, about 1-400 cP, about 1-300 cP, about 1-200 cP, or 1-200 cP at about 20 rpm and about 87.8° C. It is well known in the art that the viscosity of the water-soluble starch is correlated with the weight average molecular weight of the water-soluble starch, and often the viscosity is used as a proxy for the weight average molecular weight of the water-soluble starch. One example of the Brookfield viscosity of two example water-soluble cationic group-modified starches (Starch A and Starch B) at different weight percentage of the starch at 150° F. and 190° F. (87.8° C.) are shown in Table 1 below. Starch A is a cationic group-modified starch having about 25 wt. % of amylose and a degree of modification of about 0.18 mol. %.

TABLE 1
Brookfield viscosity of Starch A and Starch B at 150° F. (65.5 C.)
and 190° F. (87.8° C.) at a shear rate of 20 rpm.

| Brookfield | | | | | | | | |
|---|---|---|---|---|---|---|---|---|
| Viscosity (cP) | 3 wt. % | 6 wt. % | 9 wt. % | 12 wt. % | 15 wt. % | 18 wt. % | 21 wt. % | 24 wt. % |
| Starch A @150° F. | 4 | 8 | 18 | 30 | 60 | 108 | | |
| Starch A @190° F. | 3 | 5 | 12 | 22 | 36 | 60 | | |
| Starch B @150° F. | 8 | 11 | 14.5 | 25 | 36 | 50 | 75 | 119 |
| Starch B @190° F. | 4 | 7 | 12 | 14 | 22 | 32 | 48 | 71 |

The modified starch can comprise ionic group-modified starch including cationic group-modified starch or anionic group-modified starch. The cationic group-modified starch can comprise cationic ammonium group-modified starch including quaternary ammonium or amine group-modified starch, e.g., a trimethyl ammonium group-modified starch (a reaction product of starch and trimethyl ammonium salt), a reaction product of starch and 2-diethylaminoethyl chloride, a reaction product of starch and 2,3-epoxypropyltrimethylammonium chloride, a reaction product of starch and trimethyl ammonium.

The water-soluble film can comprise an unmodified starch which can have a low molecular weight. The water-soluble film can comprise a neutrally modified starch (a non-ionic group-modified starch), such as hydroxyethyl starch or hydroxypropyl starch. The water-soluble film can comprise one or more of an unmodified starch, a neutrally modified starch, an anionic group-modified starch, a cationic group-modified starch, or a combination thereof. The unmodified starch or neutrally modified starch can have a low average molecular weight in a range of about 10³-10⁶ g/mol, about 10³-10⁵ g/mol, about 10⁴-10⁵ g/mol, or about 10³-10⁴ g/mol. The unmodified starch or neutrally modified starch can have amylose in an amount of about 0-50 wt. %, about 0-40 wt. %, about 0-30 wt. %, or about 0-25 wt. %, or about 1% to about 40%, or about 5% to about 40%.

A starch aqueous solution is intended to mean a starch solution in which the solvent comprises water as a majority component, or is present at least 90% of the starch solvent, or at least 95%, or entirely. As is known in the art, starch is a carbohydrate composed of a large number of glucose units joined by glycosidic bonds. The starch of the present disclosure can be obtained from seeds, roots or tubers, by wet grinding, washing, sieving and drying. Starches are predominantly obtained from corn, wheat and potato, and to a lesser extent, sources such as rice, sweet potato, sago and mung bean. The starch can be unmodified or chemically modified to allow the starch to function under conditions encountered during processing of the present disclosure, such as interaction with the PVOH polymers through ionic and/or hydrogen bonding interactions. Such modifications include, but are not limited to acid treatment, alkaline treatment, bleaching, oxidation, enzyme treatment, acetylation, phosphorylation, or a combination thereof. The modified starches can include cationic starches, hydroxyethyl starch, hydroxypropyl starch, and carboxymethylated starches. The starch can comprise a modified starch. The starch can be or can comprise a cationic group-modified starch.

The present inventors have tested various starches and polysaccharides and found that many combinations of starch and PVOH were not miscible, having phase segregation issues in the film-forming solutions. However, a cationic group-modified starch, Starch A, has very high miscibility with anionic group-modified PVOH resins (e.g., monomethyl malate modified PVOH and methyl acrylate modified PVOH). Starch A is a low molecular weight cationic quaternary ammonium group-modified starch which has about 25 wt. % amylose and about 0.18 mol. % modification. The following polyvinyl alcohol (PVOH) resins were used in various examples. Resin A is an anionic group-modified polyvinyl alcohol (PVOH) which is a polyvinyl alcohol modified by monomethyl maleate (MMM) and has a degree of modification of about 1.5-2.0 mol. % and 89-91 mol. % hydrolysis. Resin B is an anionic group-modified polyvinyl alcohol (PVOH) which is a polyvinyl alcohol modified by methyl acrylate (MA) and has a degree of modification of about 1-10 mol. % and 80-99 mol. % hydrolysis. Without intending to be bound by any particular theory, it is believed that the high miscibility observed was the result of ionic attraction between the anionic group-modified PVOH and the cationic group-modified starch; the high miscibility allowed for film-forming aqueous solutions to be made with high solid contents which can be higher than 32 wt. % total solids by weight of the film-forming solutions at high loading levels of the starch in a range of about 5-65 wt. % or about 25-60 wt. % by weight of the total solid content in the aqueous solution, and also to achieve a RCI higher than 50%. Previous mixtures of starch and PVOH have been aqueous dispersions or suspensions, or mixtures of modified starches at very low loading levels with homopolymer PVOH, or the starch and PVOH were phase separated in the mixture. Furthermore, high molecular weight starches, which do not dissolve at all or only in small quantities, are often used in polyvinyl alcohol films to reduce film blocking and to modify the coefficient of friction of such films; likewise higher particle sizes of such starches are preferred for such purposes.

The starch can comprise a neutrally charged modified starch, such as Starch C which is a hydroxyethyl modified starch having a low molecular weight, about 25 wt. % amylose and a degree of modification lower than about 3 mol. %. Starch C has high miscibility with the anionic PVOH. A water-soluble film has been successfully prepared using Starch C as the primary starch in formulations with RCI higher than 50%. However, the miscibility between the PVOH and Starch C, while good, has been shown to be not as good as cationic group-modified starch (such as Starch A) at very high starch loading levels. The PVOH and the neutral group-modified starch, Starch C, are phase separated in the film-forming solutions when the weight ratio of the Starch C to PVOH is higher than about 45:55 at the total solid content of about 10 wt. % or higher.

The modified starch can include an anionic group-modified starch or a cationic group-modified starch. The modified starch includes a cationic group-modified starch. The cationic group-modified starch can comprise a starch modified with an amino or ammonium group(s) such as a quaternary amine or ammonium group, a primary amino group, a secondary amino group, or a tertiary amino group. The cationic group-modified starch can comprise a starch modified with a quaternary ammonium group. The cationic group-modified starch, such as those described herein, can have a degree of modification in a range of about 0.05-10 mol. %, about 0.1-8 mol. %, 0.1-5 mol. %, 0.1-4 mol. %, 0.1-3.5 mol. %, 0.1-2 mol. %, 0.1-1 mol. %, 0.2-5 mol. %, 0.2-0.5 mol. %, about 0.1-0.3%, about 0.18 mol. %, or about 0.21 mol. %.

Non-limiting examples of cationic group-modified starches can have a structure of Formula A as discussed herein above.

Non-limiting examples of the cationic group-modified starch may have a structure according to Formulas B to I as shown below, wherein R₁, R₂, R₃, R₅, and R₆ each independently are a hydrogen (H), C₁-C₆ alkyl or a C₁-C₆ hydroxyalkyl group, wherein R₄ and R₇ independently are a linear or branched C₁-C₁₀ alkylene or C₁-C₁₀ hydroxyalkylene group, or a linear or branched C₁-C₆ alkylene or C₁-C₆ hydroxyalkylene group, optionally substituted with one or more heteroatom-containing groups, and wherein A is a C₁-C₆ alkylene or C₁-C₆ hydroxyalkylene group, or an oxygen-, nitrogen-, or sulphur-containing hydrocarbon group.

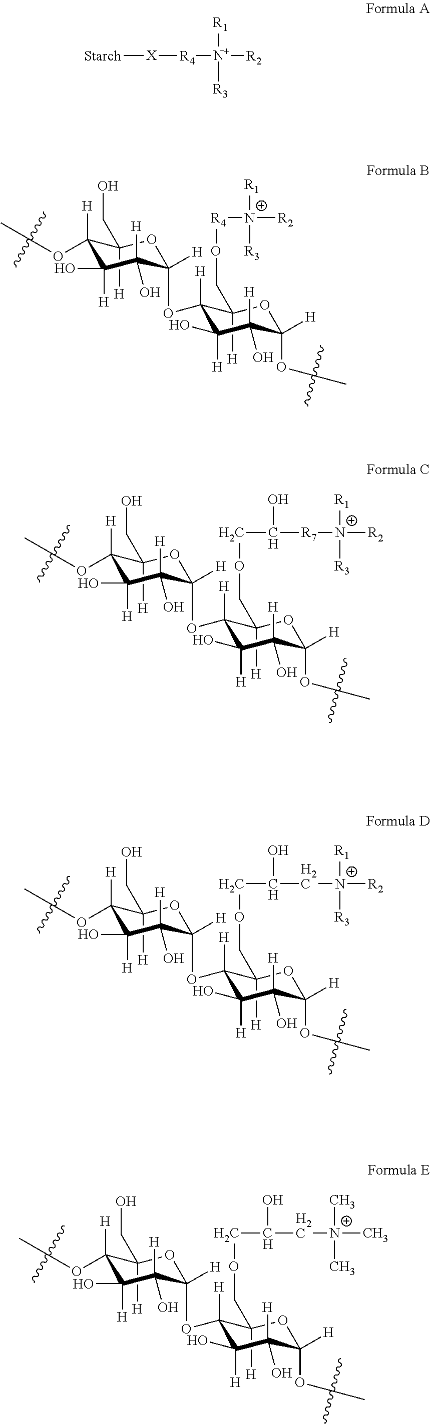

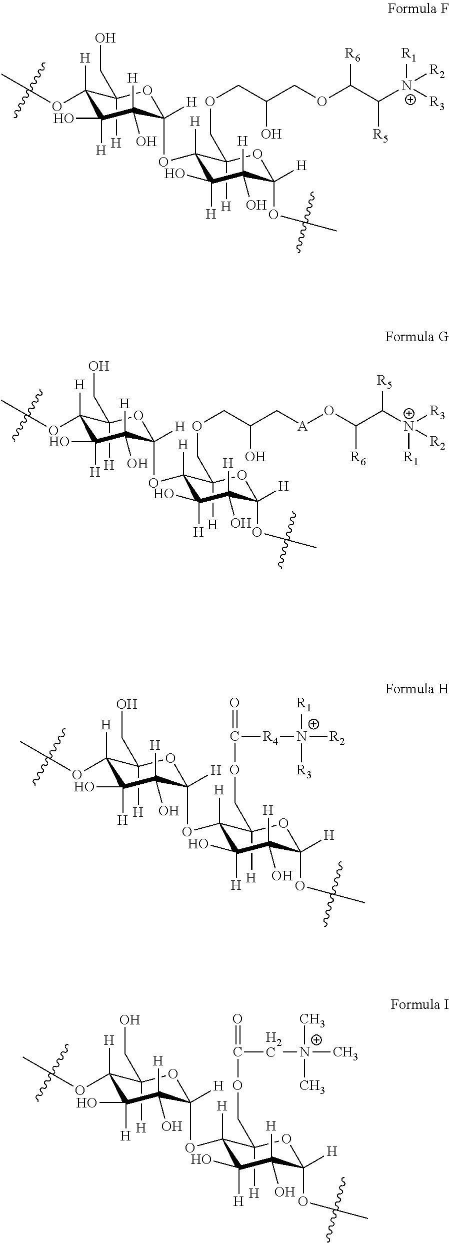

A can be a hydrocarbon group containing one or more heteroatoms, selected from the group consisting of oxygen, nitrogen, and sulfur. The oxygen-, nitrogen-, or sulphur containing hydrocarbon group can have one of the following formulae:

—(CR₈R₉)ₙ,—O—, where n is 1, 2, 3, 4, 5, 6, 7, 8, 9, or 10; (i)

—[(CR₈R₉)ₙO]ₘ—, where n and m are independently 1, 2, 3, 4, 5, 6, 7, 8, 9, or 10; (ii)

(CR₈R₉)ₙ—S—, where n is 1, 2, 3, 4, 5, 6, 7, 8, 9, or 10; (iii)

—[(CR₈R₉)ₙS]ₘ—, where n and m are independently 1, 2, 3, 4, 5, 6, 7, 8, 9, or 10; (iv)

—(CR₈R₉)ₙNR₁₀—, where n is 1, 2, 3, 4, 5, 6, 7, 8, 9, or 10; (v)

—[(CR₈R₉)ₙNR₁₀]ₘ—, where n and m are independently 1, 2, 3, 4, 5, 6, 7, 8, 9, or 10, (vi)

wherein R₈, R₉, and R₁₀ are each independently a hydrogen, C₁-C₆ alkyl, C₁-C₆ cycloalkyl or aryl group.

As used herein, the terms “cationic group-modified starch” and “cationic starch” are used herein in the broadest sense. In one aspect of the invention, cationic starch refers to starch that has been chemically modified to provide the starch with a net positive charge in aqueous solution at acidic conditions (pH lower than 7, for example at pH 3). This chemical modification can include, but is not limited to, the addition of amino and/or ammonium group(s) into the starch molecules. Non-limiting examples of these ammonium groups may include the groups discussed herein above, or substituents such as trimethylhydroxypropyl ammonium salt (such as halide salt or chloride salt), dimethylstearylhydroxypropyl ammonium salt (such as halide salt or chloride salt), dimethyldodecylhydroxypropyl ammonium salt (such as halide salt or chloride salt), 2-dictbylaminoethyl salt (such as halide or salt chloride salt), or 2,3-cpoxypropyltrimethylammonium salt (such as halide salt or chloride salt). Non-limiting examples of these ammonium groups can include the groups discussed herein above, or substituents such as trimethylhydroxypropyl ammonium chloride, dimethylstearylhydroxypropyl ammonium chloride, dimethyldodecylhydroxypropyl ammonium chloride, 2-diethylaminoctbyl chloride, or 2,3-cpoxypropyltrimethylammonium chloride.

Non-limiting examples of the quaternary ammonium group-modified starches can include a reaction product of a starch with one or more of the trimethylhydroxypropyl ammonium salt, dimethylstearylhydroxypropyl ammonium salt, dimethyldodecylhydroxypropyl ammonium salt, 2-dictbylaminoethyl salt, or 2,3-epoxypropyltrimethylammonium salt.

The water-soluble starch can be present in the water-soluble film in an amount ranging from about 5-75 wt. %, about 5-70 wt. %, about 10-65 wt. %, about 10-60 wt. %, about 10-55 wt. %, about 10-50 wt. %, about 15-50 wt. %, about 20-50 wt. %, about 20-45 wt. %, about 25-45 wt. %, about 30-55 wt. %, about 35-55 wt. %, or about 30-50 wt. % by weight of the water-soluble film. The weight ratio of the water-soluble starch to the polyvinyl alcohol (PVOH) can be about 5:95 to about 95:5, about 10:90 to about 90:10, about 15:85 to about 85:15, about 20:80 to about 80:20, about 30:70 to about 70:30, about 35:65 to about 65:35, about 40:60 to about 60:40, about 45:55 to about 55:45, or about 30:70 to about 80:20; or about 50:50.

The starch can have amylose in a range of about 0-50 wt. %, about 0-40 wt. %, about 0-30 wt. %, or about 0-25 wt. %, by weight of the starch.

The film can be free of or substantially free of octenyl succinic anhydride modified starch.

### Plasticizers

The water-soluble films can further comprise one or more plasticizers.

A plasticizer is a liquid, solid, or semi-solid that is added to a material (usually a resin or elastomer) making that material softer, more flexible (by decreasing the glass-transition temperature and crystallinity of the polymer), and easier to process. A polymer can alternatively be internally plasticized by chemically modifying the polymer or monomer. In addition, or in the alternative, a polymer can be externally plasticized by the addition of a suitable plasticizing agent. Water is recognized as a very efficient plasticizer for PVOH and other polymers; including but not limited to water soluble polymers, however, the volatility of water makes its utility limited since polymer films need to have at least some resistance (robustness) to a variety of ambient conditions including low and high relative humidity.

Suitable non-water plasticizers include, but are not limited to, glycerine (also called glycerol, or glycerin), diglycerin (also called diglycerol), sorbitol, ethylene glycol, diethylene glycol, triethylene glycol, dipropylene glycol, tetraethylene glycol, propylene glycol, polyethylene glycols up to 400 MW, neopentyl glycol, trimethylolpropane (TMP), polyether polyols, 2-methyl-1,3-propanediol (e.g. MP Diol®), ethanolamines, isomalt, maltitol, xylitol, erythritol, adonitol, dulcitol, pentaerythritol, mannitol, and combinations of the foregoing.

The non-water plasticizers can comprise bio-based or plant-derived plasticizers. The plasticizers can comprise bio-based, water-soluble plasticizers. The plasticizers comprise one or more bio-based, water soluble plasticizers selected from the group of sorbitol, glycerine, ethylene glycol, xylitol, ethanolamine, mannitol, polyethylene glycols up to 400 MW, propylene glycol. The plasticizers can comprise a mixture of sorbitol and glycerine.

When present, the total amount of the plasticizers present in the water-soluble film can be in a range of up to about 50 wt. %, by weight of the water-soluble film, for example from about 0.01% to about 50 wt. %, about 0.1 wt. % to about 45 wt. %, about 1 wt. % to about 40 wt. %, about 2 wt. % to about 30 wt. %, about 3 wt. % to about 20 wt. %, or about 3 wt. % to about 15 wt. %, for example about 5 wt. %, by weight of the water-soluble film. The total amount of plasticizer can also be expressed in parts per 100 parts of polymers of both the polyvinyl alcohol (PVOH) and the water-soluble starch. Thus, the total amount of plasticizer can be in a range of about 2 phr to about 70 phr, about 5 phr to about 65 phr, about 10 phr to about 60 phr, about 15 phr to about 50 phr, about 20 phr to about 55 phr, about 25 phr to about 50 phr, about 30 phr to about 45 phr, or about 30 phr to about 40 phr.

Glycerine can be used in an amount of about 1 wt. % to about 40 wt. %, about 5 wt. % to about 30 wt. %, 10 wt. % to about 25 wt. %, 15 wt. % to about 25 wt. %, or 16 wt. % to about 20 wt. %, e.g., about 18 wt. %, by weight of the water-soluble film. Sorbitol can be used in an amount of about 1 wt. % to about 30 wt. %, about 1 wt. % to about 20 wt. %, about 2 wt. % to about 15 wt. %, about 3 wt. % to about 13 wt. %, or about 4 wt. % to about 10 wt. %, e.g., about 5 wt. %, by weight of the water-soluble film. The plasticizers can comprise a mixture of sorbitol and glycerine in a weight ratio in a range of about 1:10 to about 3:1, from about 1:8 to about 2:1, from about 1:6 to about 1:1, from about 1:5 to about 1:2, or from about 1:4 to about 1:2. Plasticizer levels consistent with those of the examples described herein are specifically contemplated both as representative levels for the water-soluble film formulations with various other ingredients described herein, and as various upper and lower bounds for ranges. The specific types and amounts of plasticizers can be selected in a particular embodiment based on desired film flexibility and processability features of the water-soluble film. At low plasticizer levels, films may become brittle, difficult to process, or prone to breaking. At elevated plasticizer levels, films may be too soft, weak, or difficult to process for a desired use.

### Surfactants

Surfactants for use in water-soluble films are well known in the art. Surfactants can be included to aid in the dispersion of the resin solution upon casting. Suitable surfactants for water-soluble films of the present disclosure include, but are not limited to, linear aliphatic ethoxylated surfactants, Laureth-6 carboxylic acid, C₉-C₁₅ ethylene oxides, C10-Guerbet alcohol, C10-Guerbet alcohol ethoxylate POE (8), Laureth-3, Laureth-5, Laureth-7, oleth-10 carboxylic acid, dialkyl sulfosuccinates, lactylated fatty acid esters of glycerin and propylene glycol, lactylic esters of fatty acids, sodium alkyl sulfates, polysorbate 20, polysorbate 60, polysorbate 65, polysorbate 80, alkyl polyethylene glycol ethers, lecithin, acetylated fatty acid esters of glycerin and propylene glycol, sodium lauryl sulfate, acetylated esters of fatty acids, myristyl dimethylamine oxide, trimethyl tallow alkyl ammonium chloride, quaternary ammonium compounds, alkali metal salts of higher fatty acids containing about 8 to 24 carbon atoms, alkyl sulfates, alkyl polyethoxylate sulfates, alkylbenzene sulfonates, monoethanolamine, lauryl alcohol ethoxylate, propylene glycol, diethylene glycol, salts thereof and combinations of any of the forgoing. The linear aliphatic ethoxylated surfactant can comprise laureth-6 carboxylic acid, C₉-C₁₅ ethylene oxides, or a combination thereof.

Suitable surfactants can include the nonionic, cationic, anionic and zwitterionic classes. Suitable surfactants include, but are not limited to, propylene glycols, diethylene glycols, monoethanolamine, polyoxyethylenated polyoxypropylene glycols, alcohol ethoxylates, alkylphenol ethoxylates, tertiary acetylenic glycols and alkanolamides (nonionics), polyoxyethylenated amines, quaternary ammonium salts and quaternized polyoxyethylenated amines (cationics), alkali metal salts of higher fatty acids containing about 8 to 24 carbon atoms, alkyl sulfates, alkyl polyethoxylate sulfates and alkylbenzene sulfonates (anionics), and amine oxides, N-alkylbetaines and sulfobetaines (zwitterionics). Other suitable surfactants include dioctyl sodium sulfosuccinate, lactylated fatty acid esters of glycerin and propylene glycol, lactylic esters of fatty acids, sodium alkyl sulfates, polysorbate 20, polysorbate 60, polysorbate 65, polysorbate 80, lecithin, acetylated fatty acid esters of glycerin and propylene glycol, and acetylated esters of fatty acids, and combinations thereof.

The amount of surfactant in the water-soluble film can be in a range of about 0.05 wt. % to about 10.0 wt. %, about 0.05 wt. % to about 5.0 wt. %, about 0.1 wt. % to about 2.5 wt. %, about 0.1 wt. % to about 2.0 wt. %, about 0.1 wt. % to about 1.5 wt. %, about 0.1 wt. % to about 1.0 wt. %, about 0.1 wt. % to about 0.8 wt. %, about 0.2 wt. % to about 0.8 wt. %, or about 0.2 wt. % to about 0.4 wt. % by weight of the water-soluble film. The amount of surfactant in the water-soluble film can be expressed in parts per 100 parts total polymers of the polyvinyl alcohol (PVOH) and water-soluble starch (phr) in the water-soluble film and can be present in a range of about 0.1 phr to about 5 phr, about 0.1 phr to about 4 phr, about 0.2 phr to about 3.0 phr, about 0.3 phr to about 2.0 phr, about 0.4 phr to about 1.5 phr, about 0.4 phr to about 1.0 phr, about 0.4 phr to about 0.8 phr, about 0.5 to about 0.7 phr, or about 0.3 phr to about 1.0 phr.

Blends of surfactants have been found to be advantageous for water-soluble films comprising anionic monomers selected from the group consisting of maleic acid, maleic anhydride, monoalkyl maleates, dialkyl maleates and combinations thereof. Thus, in an aspect of the disclosure, the PVOH can comprise an anionic monomer selected from the group consisting of maleic acid, maleic anhydride, monoalkyl maleates, monomethyl maleates (MMM), dialkyl maleates, methyl acrylate (MA), and combinations thereof, wherein the total level of anionic pendant groups from the PVOH can be at least about 1 mol. %, about 2 mol. %, about 3 mol. %, at least about 3.5 mol. %, at least about 4.0 mol. %, at least about 6 mol. %, or at least about 8 mol. %, or in a range of about 1-10 mol. %, about 2-8 mo. %, or about 3-5 mol. %, and the water-soluble film further can comprise a non-ionic surfactant, an amine oxide surfactant, an anionic surfactant, a cationic surfactant, or a combinations thereof.

The non-ionic surfactant can be selected from the group consisting of polyoxyethylenated polyoxypropylene glycols, alcohol ethoxylates, alkylphenol ethoxylates, tertiary acetylenic glycols, alkanolamides, C10-Guerbet alcohol, and combinations thereof. The amine oxide surfactant can be selected from the group consisting of dimethyloctylamine oxide, dimethyldecylamine oxide, dimethyldodecylamine oxide, dimethyltetradecylamine oxide, dimethylhexadecylamine oxide, dimethyloctadecylamine oxide and combinations of the foregoing. It will be appreciated that commercially available amine oxide surfactants may be blends of the foregoing as the source of the amines can include a distribution of amines of various chain length. Accordingly, as an example, a “dimethyldodecylamine oxide,” can include a distribution of amine oxides wherein the average amine oxide and/or the major fraction of amine oxide can comprise a dodecyl chain. The anionic surfactant can comprise dioctyl sodium sulfosuccinate. The cationic surfactant can be selected from the group of polyoxyethylenated amines, quaternary ammonium salts, quaternized polyoxyethylenated amines, and combinations thereof.

Each of the surfactants present in the water-soluble film can be present in an amount in a range of about 1 wt. % to about 98 wt. % of the total amount of surfactants, or about 10 wt. % to about 80 wt. %, or about 15 wt. % to about 70 wt. %, or about 16 wt. % to about 68 wt. %, or about 17 wt. % to about 42 wt. %, or about 30 wt. % to about 40 wt. %.

### Other Additives

Suitable lubricants/release agents can include, but are not limited to, fatty acids and their salts, fatty alcohols, fatty esters, fatty amines, fatty amine acetates and fatty amides. Preferred lubricants/release agents are fatty acids, fatty acid salts, and fatty amine acetates. The amount of lubricant/release agent in the water-soluble film can be in a range of about 0.02 wt. % to about 1.5 wt. %, optionally about 0.1 wt. % to about 1 wt. % by weight of the water-soluble film, for example.

Fillers can be included in the water-soluble films and can include bulking agents, extenders, antiblocking agents, detackifying agents and combinations thereof. Suitable fillers/bulking agents/extenders/antiblocking agents/detackifying agents include, but are not limited to, water-insoluble starches, water-insoluble modified starches, crosslinked polyvinylpyrrolidone, crosslinked cellulose, microcrystalline cellulose, silica, metallic oxides, calcium carbonate, talc, mica, stearic acid and metal salts thereof, for example, magnesium stearate. Preferred materials are water-insoluble starches, water-insoluble modified starches, silica and talc. The starches and modified starches used as fillers are starches in particles and are not water-soluble starches as defined in the disclosure. In one type of embodiment, the amount of filler/extender/antiblocking agent/detackifying agent in the water-soluble film can be in a range of about 0.5 wt. % to about 6 wt. %, about 0.6 wt. % to about 5 wt. %, about 0.7 wt. % to about 4 wt. %, about 0.8 wt. % to about 3 wt. %, about 0.9 wt. % to about 2 wt. %, about 1 wt. % to about 1.8 wt. %, or about 1 wt. % to about 1.5 wt. % by weight of the water-soluble film, or about 1 phr to about 6 phr, or about 1 phr to about 5 phr, or about 1 phr to about 4 phr, or about 2 phr to about 4 phr per 100 parts in total of PVOH and water-soluble starch, for example.

In some embodiments, the water-soluble film can include 1 or more phr (e.g., 2 phr to 6 phr or 2 phr to 4 phr) of a filler. In some embodiments, the film includes 2 or more phr (e.g., 2 phr to 6 phr or 2 phr to 4 phr) of a filler and the filler can comprise a bulking agent, an antiblocking agent, or a combination thereof. Without intending to be bound by theory, it is believed that the inclusion of 2 or more phr (e.g., 2 phr to 6 phr or 2 phr to 4 phr) of a filler can be useful to prevent weeping or migration of plasticizer out of the film, when the plasticizer is included in an amount of greater than or equal to 30 phr, for example, in a range of 30 phr to 50 phr.

An anti-block agent (e.g. SiO₂ and/or stearic acid)) can be present in the film in an amount of at least 0.1 PHR, at least 0.5 PHR, or at least 1 PHR, or in a range of about 0.1 to 5.0 PHR, about 0.5 to about 5.0 PHR, about 1.0 to 4.0 PHR, about 1.5 to about 4.0 PHR, about 2.0 to about 4.0 PHR, about 2.5 to about 4.0 PHR, about 3.0 to about 4.0 PHR, or about 3.0 to 3.5 PHR per 100 parts in total of the PVOH and water-soluble starch.

A suitable median particle size for the anti-block agent includes a median size in a range of about 3 to about 11 microns, or about 4 microns to about 11 microns, or about 4 to about 8 microns, or about 5 to about 6 microns, for example 5, 6, 7, 8, or 9 microns. A suitable SiO₂ is an untreated synthetic amorphous silica designed for use in aqueous systems.

The water-soluble film can further have a residual moisture content of at least 4 wt. %, for example in a range of about 4 wt. % to about 10 wt. %, as measured by Karl Fischer titration.

The water-soluble film of the present disclosure may have a renewable carbon index (RCI) higher than about 30%, about 40%, about 50%, about 55%, about 60%, about 70%, about 80%, or about 90%, or in a range of about 30-90%, about 40-80%, about 40-70%, about 45-70%, about 45-65%, or about 50-60%.

### Method of Preparing Aqueous Solutions for Forming the Water-Soluble Film

The disclosure provides a method of preparing an aqueous solution suitable for forming the water-soluble film as discussed above. The method for preparing the aqueous solution can comprise the following steps: 1) heating water in a container to a temperature in a range of about 60-95° C., for example about 85° C.; 2) adding a water-soluble starch to the water; 3) continuing heating and mixing for about 0.5-20 hours, for example, about 0.5-3 hours or about 1 hour, at a temperature in a range of about 60-95° C., for example about 85° C. to form a gelatinized starch liquid solution; 4) adding a water-soluble polyvinyl alcohol (PVOH) into the starch liquid solution; and 5) heating and mixing for about 0.5-20 hours at a temperature in a range of about 60-95° C., for example about 85° C., to form an aqueous starch and PVOH solution, wherein the water-soluble starch has a cook % of at least about 5 wt. %, at least about 10 wt. %, or at least about 15 wt. % under batch cooking conditions (heating and mixing in water at about 95° C. for about 30 minutes), wherein the aqueous solution has a total solid content of at least 15 wt. % by weight of the aqueous solution, wherein the water-soluble starch is present in an amount of about 5-65 wt. % by weight of the total solid content, and wherein the water-soluble polyvinyl alcohol (PVOH) and the water-soluble starch are miscible and have no phase separation in the aqueous solution for at least 24 hours by visual inspection at about room temperature.

In preparing the aqueous solution of the PVOH and the water-soluble starch, it is desirable to allow enough time, heat, and shear force for the starch to gelatinize and completely dissolve in the hot water, and further to mix with the PVOH uniformly to form miscible solution and thus to prevent the phase separation between the PVOH and the water-soluble starch.

In general, the aqueous solutions can be prepared by either adding the polyvinyl alcohol (PVOH) first to the hot water before adding the water-soluble starch; or alternatively by adding the water-soluble starch to the hot water first before adding the polyvinyl alcohol. The sequence of adding the polyvinyl alcohol and the water-soluble starch to the hot water are not particularly limited.

In certain circumstances, there may be an issue with starch clumping when adding starch to the hopper of the hot water container due to the steam coming from the hot water. To avoid starch clumping, starch can be added to cold water at about ambient conditions to form a cold slurry first, which is then mixed and heat treated to gelatinize and completely dissolve the water-soluble starch. Therefore, the method can comprise adding the water-soluble starch to water at ambient conditions or cold water at about 5° C. to about 30° C. to form a cold slurry first, and then mixing and heat treating the water-soluble starch to a temperature of about 60-95° C., for example about 85° C., to gelatinize and completely dissolve the starch before adding the PVOH.

Alternatively, a starch slurry can be gelatinized with the aid of steam injection or jet-cooked, i.e., the slurry can be passed through a jet cooker to heat and apply high shear to the starch. Jet cooking can increase gelatinization of the starch, which can improve solvation of the starch and reduce retrogradation. In a jet cooker, steam is continuously injected into a flowing starch slurry through an injector coaxial to the flow of a starch stream.

The water-soluble starch after the heat treatment and mixing in hot water at a temperature in a range of about 60-95° C., for example about 85° C., for about 0.5-20 hours or about 0.5-5 hours, are gelatinized and completely dissolved in the water.

The PVOH and the water-soluble starch each can be completely dissolved in the aqueous solution and can be miscible or have no phase separation or no bulk phase separation in the aqueous solution. The phase miscibility between the PVOH and the water-soluble starch in the aqueous solution of the disclosure is advantageous in improving the processability in forming or casting the water-soluble films. Further, the resulting aqueous solution can be stable for a longer time which allows longer holding time of the aqueous solution before forming the films. Generally, if the PVOH and the starch are not miscible in a liquid mixture, once the PVOH and the water-soluble starch are phase separated (for example, liquid to liquid phase separation), then it is impractical to remix into miscible solutions.

The PVOH can comprise an anionic group-modified PVOH modified by monomethyl maleate (MMM) having a degree of modification of about 1-5 mol. %, and wherein the water-soluble starch is added to the water before the PVOH. When the MMM-modified starch is used to prepare the aqueous solution, the starch can be added and dissolved into the hot water at a temperature in a range of about 60-95° C. before the addition of the PVOH.

The method can further comprise: adding a plasticizer and anti-foaming agent to the water while mixing before adding the water-soluble starch; adding an anti-blocking agent together with the water-soluble starch to the water; adding additives (anti-oxidant) to the gelatinized starch liquid solution after adding the water-soluble starch and before adding the PVOH; and adding a surfactant to the aqueous solution and mixing for about 5-60 minutes. In the alternative, any one or more of plasticizer, anti-foaming agent, an anti-blocking agent, and other additives can be added to the solution after dissolution of the PVOH.

A method for preparing the aqueous solution can comprise the following steps: 1) heating water in a container to a temperature in a range of about 60-95° C., for example about 85° C.; 2) adding a water-soluble polyvinyl alcohol (PVOH) to the water; 3) continuing heating and mixing for about 0.5-20 hours, for example, about 0.5-3 hours or about 1 hour, at the temperature of about 60-95° C., for example about 85° C. to form a liquid solution; 4) adding a water-soluble starch into the liquid solution; and 5) heating and mixing for about 0.5-20 hours at a temperature in a range of about 60-95° C. to form the aqueous solution, wherein the water-soluble starch has a cook % of at least about 10 wt. % under batch cooking conditions (heating such as using direct steam injection and mixing in water at about 95° C. for about 30 minutes), wherein the aqueous solution has a total solid content of at least 15 wt. % by weight of the aqueous solution, wherein the water-soluble starch is present in an amount of about 5-65 wt. % by weight of the total solid content, and wherein the water-soluble polyvinyl alcohol (PVOH) and the water-soluble starch are miscible and have no phase separation in the aqueous solution after storage at about room temperature to about 90° C. for at least about 24 hours, about 36 hours, about 48 hours, about 60 hours, about 1 week, or about 2 weeks, or even more than 2 weeks by visual inspection.

The viscosity of the aqueous solution can be, for example, at least about 2,000 or 3,000 cps at 185° F. (85° C.), and at most about 20,000 cps, about 15,000 cps or about 10,000 cps at 185° F., for example about 3,000 cps to about 10,000 cps at 185° F. (85° C.).

The PVOH can comprise an anionic group-modified PVOH modified by methyl acrylate (MA) having a degree of modification of about 1-5 mol. %, and optionally wherein the PVOH is added to the water before the water-soluble starch.

The PVOH and the water-soluble starch are completely dissolved in the aqueous solution and are miscible, and further have no phase separation in the aqueous solution.

The method can further comprise: adding a plasticizer and anti-foaming agent to the water while mixing before adding the PVOH; adding additives (anti-oxidant and caustic soda) to the water before adding the PVOH; adding an anti-blocking agent together with the water-soluble starch to the liquid solution; and adding a surfactant to the aqueous solution and mixing for about 5-60 minutes.

The aqueous solution formulations are mixed and cast. Mixing is carried out in a container while heating. Order of ingredient addition can be plasticizers, antifoam, water-soluble starch, additives, PVOH, and finally surfactants. It is desirable to have enough time, heat, and shear for water-soluble starch to gelatinize and completely dissolve in the hot water, and to mix with the PVOH resins uniformly. After mixing, the resulting aqueous solutions may be stored in a 90° C. oven overnight to degas, optionally under reduced pressure. For the control PVOH/starch solutions described below, the PVOH and the starch will phase separate during this storage time if the formulations are not phase stable or miscible. The phase separated solutions are either not castable or ever castable, it would result in large PVOH rich domains and large starch rich domains which would lead to poor mechanical properties in the starch rich regions. Therefore, the miscible and phase stable PVOH and water-soluble starch aqueous solutions of the present disclosure have the advantages of good processability to form the film and excellent physical properties of the resulting films.

In a non-limiting example, an aqueous solution comprising the cationic group-modified starch (Starch A) and the PVOH modified by monomethyl maleate (MMM) (Resin A) of the present disclosure is prepared according to the forming steps: water is heated to about 85° C.; while water is heating plasticizers (e.g. glycerin and sorbitol) and anti-foam are added; water-soluble starches are added to gelatinize and mixed for about 1 hour (and any non-water soluble starch particles as an antiblock, can be added together with the water-soluble starch); other additives are added and allowed to mix for about 20 min (Sodium Metabisulfite); the Resin A is added and mixed for about 1 hour; and surfactants are added and mixed for about 10 min to form the aqueous solution. After mixing, the resulting aqueous solutions may be stored in a 90° C. oven overnight to degas, optionally under reduced pressure.

### Method of Preparing the Water-Soluble Film

The disclosure provides a method of forming the water-soluble film discussed herein above. The method can comprise casting the aqueous solution discussed herein above onto a substrate at a specified thickness; and drying water from the cast aqueous solution to form the water-soluble film. The viscosity of the casting solution can be, for example, at least about 2,000 or about 3,000 cps at 185° F. (85° C.), and at most about 20,000, about 15,000, or about 10,000 cps at 185° F. (85° C.), for example about 3,000 cps to about 10,000 cps at 185° F. (85° C.).

One contemplated class of embodiments is characterized by the water-soluble film being formed by solvent casting of the aqueous solution as discussed herein above. Processes for solvent casting of aqueous film-forming solutions are known in the art and are detailed below. For example, in the film-forming process, the water-soluble polyvinyl alcohol, the water-soluble starch and secondary additives are dissolved in a solvent, typically water, to form the aqueous solution as discussed herein above, metered onto a surface, spread over the surface, allowed to substantially dry (or force-dried) to form a cast film, and then the resulting cast film is removed from the casting surface. The process can be performed batchwise and is more efficiently performed in a continuous process.

In the formation of continuous water-soluble films discussed herein above, it is the conventional practice to meter the aqueous solution onto a moving casting surface, for example, a continuously moving metal drum or belt, causing the solvent to be substantially removed from the liquid, whereby a self-supporting cast film is formed, and then stripping the resulting cast film from the casting surface.

Optionally, the water-soluble film can be a free-standing film consisting of one layer or a plurality of like layers.

In a non-limiting example, the water-soluble film is prepared with the following steps: casting the phase stable aqueous solution of the present disclosure on a heated steel substrate, and drying the water from the cast aqueous solution to form the water-soluble film, wherein the temperature of the substrate can be heated, and a target thickness of the dried film can be any desired thickness, e.g. in a range of 5 μm to 200 μm, or 20 μm to 100 μm, or 40 μm to 90 μm, or 50 μm to 80 μm, for example 76 μm.

### Pouches

The disclosure provides an article comprising a pouch made of the water-soluble film discussed herein above, the pouch defining an interior pouch volume. The article further can comprise a chemical composition contained in the interior pouch volume. The chemical composition can be a household care composition. The household care composition can be a liquid laundry detergent. The pouch of the present disclosure can have the advantages of improved pouch compression strength of at least about 300 N, at least about 600 N, or at least about 800 N, or at least about 1000 N, or at least about 1200 N.

The article including the pouch and the chemical composition can have a residue no more than about 10 wt. %, no more than about 5 wt. %, or no more than about 2.5 wt. %, after mixing in water for about 8.5 minutes at a temperature of about 15° C. The article can have a residue no more than about 10 wt. %, no more than about 5 wt. %, or no more than about 2.5 wt. % by weight of the pouch after mixing in water for about 8.5 minutes at a temperature of about 15° C. The article can have a residue no more than about 10 wt. %, no more than about 5 wt. %, or no more than about 2.5 wt. %, after mixing in water for about 8.5 minutes at a temperature of about 10° C. The article can have a residue no more than about 10 wt. %, no more than about 5 wt. %, or no more than about 2.5 wt. %, after mixing in water for about 8.5 minutes at a temperature of about 5° C.

The pouches of the present disclosure can include at least one sealed compartment. Thus, the pouches can comprise a single compartment or multiple compartments. A water-soluble pouch can be formed from two layers of water-soluble film sealed at an interface, or by a single film that is folded upon itself and sealed. The films define an interior pouch container volume which contains any desired composition for release into an aqueous environment. The composition is not particularly limited, for example including any of the variety of compositions described below.

The pouch can have a matte to matte seal type. The water-soluble film prepared by the film casting method can have two surfaces. One surface touches the casting substrate and generally is matte. The other surface not touching the casting substrate is smoother, glossier and can have a more appealing appearance to a customer. Therefore, a seal of the pouch can mate the matte surfaces, so both exposed film surfaces of the pouch are smooth and glossy. The pouch made from the water-soluble films, optionally having the matte to matte scaling type, exhibits good sealing and the article can have a compression strength higher than about 300 N, about 600 N, about 800N, about 1000 N, or about 1200 N.

A water-soluble film disclosed herein can be useful for creating pouches to contain a chemical composition therein. The chemical composition may be a household care composition, such as a detergent, or a liquid laundry detergent. The pouch composition may take any form such as powders, gels, pastes, liquids, tablets or any combination thereof. A film according to the disclosure also can be useful for any other application in which improved wet handling and low cold-water residues are desired. The film forms at least one side wall of the pouch, optionally the entire pouch, and preferably an outer surface of the at least one sidewall.

The water-soluble film described herein can also be used to make a packet with two or more compartments made of the same film or in combination with films of other polymeric materials. Additional films can, for example, be obtained by casting, blow-molding, extrusion or blown extrusion of the same or a different polymeric material, as known in the art.

In embodiments comprising multiple compartments, each compartment may contain identical and/or different compositions. In turn, the compositions may take any suitable form including, but not limited to liquid, solid and combinations thereof (e.g. a solid suspended in a liquid). The pouches can comprise a first, second and third compartment, each of which respectively contains a different first, second, and third composition.

Pouches and packets may be made using any suitable equipment and method. For example, single compartment pouches may be made using vertical form filling, horizontal form filling, or rotary drum filling techniques commonly known in the art. Such processes may be either continuous or intermittent. The film may be dampened, and/or heated to increase the malleability thereof. The method may also involve the use of a vacuum to draw the film into a suitable mold. The vacuum drawing the film into the mold can be applied for about 0.2 to about 5 seconds, or about 0.3 to about 3, or about 0.5 to about 1.5 seconds, once the film is on the horizontal portion of the surface. This vacuum can be such that it provides an under-pressure in a range of 10 mbar to 1000 mbar, or in a range of 100 mbar to 600 mbar, for example.

The molds, in which packets may be made, can have any shape, length, width and depth, depending on the required dimensions of the pouches. The molds may also vary in size and shape from one to another, if desirable. For example, the volume of the final pouches may be about 5 ml to about 300 ml, or about 10 to 150 ml, or about 20 to about 100 ml, and that the mold sizes are adjusted accordingly.

The composition can be selected from the group of liquid light duty and liquid heavy duty liquid detergent compositions, powdered detergent compositions, dish detergent for hand washing and/or machine washing; hard surface cleaning compositions, fabric enhancers, detergent gels commonly used for laundry, and bleach and laundry additives, shampoos, and body washes, agricultural compositions, automotive compositions, aviation compositions, food and nutritive compositions, industrial compositions, livestock compositions, marine compositions, medical compositions, mercantile compositions, military and quasi-military compositions, office compositions, and recreational and park compositions, pet compositions, water-treatment compositions, including cleaning and detergent compositions applicable to any such use.

Any suitable method of sealing the packet and/or the individual compartments thereof may be utilized. Non-limiting examples of such means include heat sealing, solvent welding, solvent or wet sealing, and combinations thereof. Optionally, only the area which is to form the seal is treated with heat or solvent. The heat or solvent can be applied by any method, typically on the closing material, and optionally only on the areas which are to form the seal. If solvent or wet sealing or welding is used, it may be preferred that heat is also applied. Wet or solvent scaling/welding methods can include selectively applying solvent onto the area between the molds, or on the closing material, by for example, spraying or printing this onto these areas, and then applying pressure onto these areas, to form the seal. Sealing rolls and belts as described above (optionally also providing heat) can be used, for example.

The formed pouches may then be cut by a cutting device. Cutting can be accomplished using any suitable method. The cutting also can be done in continuous manner, and optionally with constant speed and optionally while in horizontal position. The cutting device can, for example, be a sharp item, or a hot item, or a laser, whereby in the latter cases, the hot item or laser ‘burns’ through the film/sealing area.

### Dissolution and Disintegration Test (MSTM-205)

A film can be characterized by or tested for Dissolution Time and Disintegration Time according to the MonoSol Test Method 205 (MSTM 205), a method known in the art. Sec, for example, U.S. Pat. No. 7,022,656. Apparatus and Materials:
600 ml Beaker
Magnetic Stirrer (Labline Model No. 1250 or equivalent)
Magnetic Stirring Rod (5 cm)
Thermometer (0 to 100° C.±1° C.)
Template, Stainless Steel (3.8 cm×3.2 cm)
Timer (0-300 seconds, accurate to the nearest second)
Polaroid 35 mm slide Mount (or equivalent)
MonoSol 35 mm Slide Mount Holder (or equivalent)
Distilled water

All films to be tested were conditioned for a minimum of 24 hours in a 23° C./35% relative humidity environment. For each film to be tested, three test specimens are cut from a film sample that is a 3.8 cm×3.2 cm specimen. If cut from a film web, specimens should be cut from areas of web evenly spaced along the traverse direction of the web. Each test specimen is then analyzed using the following procedure.

Lock each specimen in a separate 35 mm slide mount.

Fill beaker with 500 mL of distilled water. Measure water temperature with thermometer and, if necessary, heat or cool water to maintain temperature at about 5° C. (about 41° F.). Mark height of column of water. Place magnetic stirrer on base of holder. Place beaker on magnetic stirrer, add magnetic stirring rod to beaker, turn on stirrer, and adjust stir speed until a vortex develops which is approximately one-fifth the height of the water column. Mark depth of vortex.

Secure the 35 mm slide mount in the alligator clamp of the 35 mm slide mount holder such that the long end of the slide mount is parallel to the water surface. The depth adjuster of the holder should be set so that when dropped, the end of the clamp will be 0.6 cm below the surface of the water. One of the short sides of the slide mount should be next to the side of the beaker with the other positioned directly over the center of the stirring rod such that the film surface is perpendicular to the flow of the water.

In one motion, drop the secured slide and clamp into the water and start the timer. Disintegration occurs when the film breaks apart. When all visible film is released from the slide mount, raise the slide out of the water while continuing to monitor the solution for undissolved film fragments. Dissolution occurs when all film fragments are no longer visible and the solution becomes clear.

The results should include the following: complete sample identification; individual and average disintegration and dissolution times; and water temperature at which the samples were tested.

Film disintegration times (I) and film dissolution times (S) can be corrected to a standard or reference film thickness using the exponential algorithms shown below in Equation 1 and Equation 2, respectively.

$${I}_{corrected} = {I}_{measured} \times {( reference thickness / measured thickness )}^{1.93} \qquad [ 1 ]$$

$${S}_{corrected} = {S}_{measured} \times {( reference thickness / measured thickness )}^{1.83} \qquad [ 2 ]$$

### Tensile Strength Test

A water-soluble film characterized by or to be tested for tensile strength (i.e., max stress, the stress required to break the film) is analyzed as follows. The procedure includes the determination of tensile strength according to ASTM D 882 (“Standard Test Method for Tensile Properties of Thin Plastic Sheeting”) or equivalent. An INSTRON tensile testing apparatus (Model 5544 Tensile Tester or equivalent) is used for the collection of film data. A minimum of three test specimens, each cut with reliable cutting tools to ensure dimensional stability and reproducibility, are tested in the machine direction (MD) (where applicable) for each measurement. Films to be tested are conditioned for a minimum of 24 hours in a 23±2.0° C. and 35±5% relative humidity environment; tensile strength tests are also conducted in a 23±2.0° C. and 35±5% relative humidity environment. For tensile strength, 1″-wide (2.54 cm) samples of a single film sheet having a thickness of 76 μm are prepared. The sample is then transferred to the INSTRON tensile testing machine to proceed with testing while minimizing exposure in the 35% relative humidity environment. The tensile testing machine is prepared according to manufacturer instructions, equipped with a 500 N load cell, and calibrated. The correct grips and faces are fitted (INSTRON grips having model number 2702-032 faces, which are rubber coated and 25 mm wide, or equivalent). The samples are mounted into the tensile testing machine and analyzed to determine tensile strength (i.e., stress required to break film).

Young's modulus was determined as the slope of a linear fit of stress-strain data over the range of 1-10% strain.

### Strain at Break Test

Determination of strain at break (i.e., max strain, or elongation at break) is based on ASTM D 882 (“Standard Test Method for Tensile Properties of Thin Plastic Sheeting”) or equivalent. An INSTRON® tensile testing apparatus (Model 5544 Tensile Tester or equivalent) is used for the collection of film data. A minimum of three test specimens, each cut with reliable cutting tools to ensure dimensional stability and reproducibility, are tested in the machine direction (MD) (where applicable) for each measurement. Films to be tested are conditioned for a minimum of 24 hours in a 23±2.0° C. and 35±5% relative humidity environment; elongation at break tests are also conducted in a 23±2.0° C. and 35±5% relative humidity environment. For elongation at break determination, 1″-wide (2.54 cm) samples of a single film sheet having a thickness of 1.4±0.15 mil (about 35.6±3.8 μm) are prepared. The sample is then transferred to the INSTRON® tensile testing machine to proceed with testing while minimizing exposure in the 35% relative humidity environment. The tensile testing machine is prepared according to manufacturer instructions, equipped with a 500 N load cell, and calibrated. The correct grips and faces are fitted (INSTRON® grips having model number 2702-032 faces, which are rubber coated and 25 mm wide, or equivalent). The samples are mounted into the tensile testing machine and analyzed to determine the strain at break (i.e., where Young's Modulus applies).

### Differential Scanning Calorimetry (DSC)

Tests were performed using a TA Instruments Q2000 differential scanning calorimeter (DSC) or equivalent with a 50 mL/min nitrogen purge and TZERO aluminum hermetic pans (available from TA Instruments) to avoid weight losses during temperature ramping. Film specimens to be tested are cut in small pieces to provide about 3-5 mg total sample that fits into the pans (e.g., about 3 stacked, cut film pieces). The DSC test is performed by equilibrating the sample at −80° C., followed by (1) heating the sample to 75° C. at a rate of 10° C./min to begin generating a first DSC heating curve, (2) maintaining the sample at 75° C. for 15 minutes, (3) heating the sample from 75° C. to 200° C. at a rate of 10° C./min and maintaining the sample at 200° C. for 1 minute to complete the first DSC heating curve, (4) cooling the sample to −80° C. at a rate of −5° C./min to generate a DSC cooling curve, and optionally (5) re-heating the sample to 200° C. at a rate of 10° C./min to generate a second DSC heating curve. Upon generating the curves, transitions attributable to glass transition, melting, and crystallization are assigned; glass transition temperature, melting temperature, and crystallization temperature (Tg, Tm, and Tc, respectively) are determined; and enthalpies of melting or crystallization are determined according to standard calorimetry analysis.

### Water Uptake

Water uptake was measured with a DVS (Dynamic Vapor Sorption) Instrument. The instrument used was a SPS-DVS (model SPSx-1μ-High load with permeability kit) from ProUmid. The DVS uses gravimetry for determination of moisture uptake/desorption and is fully automated.

The accuracy of the system is ±0.6% for the RH (relative humidity) over a range of 0-98% and ±0.3° C. at a temperature of 25° C. The temperature can range from ±5 to ±60° C. The microbalance in the instrument is capable of resolving 0.1 m in mass change. 2 replicates of each film are measured and the average water capacity value is reported.

For the specific conditions of the test, a 6 pan carousel which allows to test 5 films simultaneously (1 pan is used as a reference for the microbalance and needs to remain empty) was used.

Each pan has an aluminum ring with screws, designed to fix the films. A piece of film was placed onto a pan and after gentle stretching, the ring was placed on top and the film was tightly fixed with the screws and excess film removed. The film covering the pan surface had an 80 mm diameter.

The temperature was fixed at 20° C. Relative humidity (RH) was set at 35% for 6 hours, and then gradually raised onto 50% in 5 min. The RH remained at 50% for 12 hours. The total duration of the measurement was 18 hours.

The cycle time (=time between measuring each pan) was set to 10 min and the DVS records each weight result vs. time and calculates automatically the % moisture in the film as a relative mass variation versus starting weight of the film, i.e. 10% reflects a 10% film weight increase versus starting film weight.

### Capsule Compression Test

A water-soluble film and/or pouch characterized by or to be tested for the ability of a water soluble capsule to resist a mechanical compression strength of a minimum of 300 N according to the Compression Test Measurement is analyzed as follows using the following materials:
Instron Model 5544 (or equivalent);
At least 5 water-soluble pouches or capsules to be tested; the film having a thickness of 76 μm; the pouches are pre-conditioned for at least 24 hours at 23±1° C. ad 50±4% Relative Humidity;
Zipper type bags;
Two flat plates (Top plate: 10 kN Max load T1223-1022/Bottom plate: 100 KN Max load T489-74);
Load cell (Static load±2 kN, Max spindle torque 20 Nm, bolt torque 25 Nm, and weight 1.2 kg);
Marker
Allen wrench (6 mm)

A pouch is inspected for leaks and then placed into a zippered bag (approximately 57 micron thick on each side). Seal the bag with minimal air inside. Label the bag with the sample name and number.

Open the method for compression test. Ramp speed should be 4 mm/s.

Carefully place the sample, thermoformed side down, between the two plates making sure the pouch is on the center of the bottom plate. Move capsule inside the bag away from any edges.

Press start to run the test. As the two plates come together, the pouch will burst. Record the compression strength and the location on the pouch where the rupture occurred. Repeat this process for all samples.

Suitable behavior of water-soluble films according to the disclosure is marked by pouches that have compression strength values of at least about 300N and less than about 2000N.

### Liquid Release Time Test MSTM-126

A water-soluble film and/or pouch characterized by or to be tested for delayed solubility according to the Liquid Release Test is analyzed as follows using the following materials:
2 L beaker and 1.2 liters of deionized (DI) water;
Water soluble pouch to be tested; the film has a thickness of 76 μm; the pouch is pre-conditioned for two weeks at 38° C.;
Thermometer;
Wire cage;
Timer.

Before running the experiment, ensure that enough DI water is available to repeat the experiment five times, and ensure that the wire cage and beaker are clean and dry.

The wire frame cage is a plastic coated wire cage (4″×3.5″×2.5″, or about 10 cm×9 cm×6 cm) with no sharp edges, or equivalent. The gauge of the wire should be about 1.25 mm and the wire should have openings the size of 0.5 inch (1.27 cm) squares.

To set up for the test, carefully place the water soluble pouch in the cage while not scratching the pouch on the cage and allowing free space for the pouch to move. Do not bind the pouch tightly with the wire cage, while still ensuring it is secure and will not come out of the cage. The orientation of the pouch in the cage should be such that the natural buoyancy of the pouch, if any, is allowed (i.e., the side of the pouch that will float to the top should be placed towards the top). If the pouch is symmetrical, the orientation of the pouch generally would not matter.

Next, fill the 2 L beaker with 1200 milliliters of 20° C. DI water. Other temperatures of water can be used in alternative methods.

Next, lower the wire frame cage with the enclosed pouch into the water. Ensure that the cage is 1 inch (2.54 cm) from the bottom of the beaker. Be sure to fully submerge the pouch on all sides. Ensure that the cage is stable and will not move and start a timer as soon as the pouch is lowered into the water. The position of the cage with respect to the water in the beaker can be adjusted and maintained by any suitable means, for example by using a clamp fixed above the beaker, and a rod attached to the top of the cage. The clamp can engage the rod to fix the position of the cage, and tension on the clamp can be lowered in order to lower the cage into the water. Other means of frictional engagement can be used in the alternative to a clamp, for example a collar with a set screw.

Liquid content release is defined as the first visual evidence of the liquid leaving the submerged pouch.

Use the timer to record when the liquid content is released into the surrounding water (Release Time) with a stopping point of pouch failure (liquid release).

Repeat this process with new DI water and a new water soluble pouch five times for each film being tested.

A total of at least 3 pouches are tested for each film sample type unless reported otherwise.

### Accelerated Quantitative Residue Assessment

This test method is for assessing film residue quantitatively. The test includes the steps detailed below.

### Cleaning and Weighing the Samples

Cut film samples into 2″×2″ pieces and immerse directly in a glass jar containing liquid laundry detergent (LLD) of interest. Confirm that the LLD completely covers the film samples. Multiple film samples of the same type can co-condition in the same LLD container. Cover jar and add to conditioning environment for desired amount of time. n=3 for each film type to be studied, and each n should contain two film squares.

Remove film/LLD from conditioning environment. Wash film sample by first removing from LLD with tweezers and letting LLD drain, then briefly washing in methanol. Immediately dab film with Kimwipe™ to remove residual LLD and methanol (film should not have a greasy appearance).

The test requires a 9 cm diameter 100% cotton fabric same in Espresso Color. Assign sample identifier (A B C) for a fabric circle and film combination.

Label and use weigh boats to both weigh and transport between testing steps. Use address labels to label the film, detergent used, how old the sample is (7, 14 . . . 70 days, etc.), what condition it was collected from (38° C., 80% RH), and the sample identifier. Create duplicate labels for each sample and label one “front” and the other “back” for the purposes of taking pictures after the samples dry.

Weigh and record weigh boat weight. Weigh and record cleaned film weight. Weigh and record fabric circles dry weight. Be sure to keep the fabric and the film separate while in the weigh boat

### Testing the Samples

Fill 4 1000 ml beakers with 800 mL 15° C. tap water.

Place stir bar in beakers and place on top of hot plates and set timers nearby.

Set stirring to 300 RPM on hot plate.

Cut each of 2 pieces of 2″×2″ films into 4 approximately equal pieces by cutting in half, stacking two pieces on top of each other and in half again,

Drop the 8 film pieces (1″×1) into the water and simultaneously start the count-up timer.

Prepare a Büchner funnel rubber collar (9 cm inner diameter), vacuum flask, and vacuum pump.

Place the fabric circle inside of the Buchner funnel and be sure that all the holes are covered. Water may be used to wet and stabilize the edges of the fabric.

As the count-up timer approaches 8 min, around 7:50, start the vacuum pump. As the timer approaches 8 minutes, stop the stirring function, begin slowly pouring the liquor into the Büchner funnel.

Pour the dissolved film solution from the 1000 ml beaker directly in the center of the fabric and funnel, do not pour so much such that the fabric filter in the bottom becomes displaced or that the liquor will not be filtered by the fabric.

After all the liquor is filtered, inspect the beaker, and stir bar for any visible residue. Use water in a squirt bottle and spray down the sides of the beaker and stir bar, swirl the beaker several times, and pour into the Büchner funnel again.

Let the vacuum pump run longer if there is a lot of visible residue, to pull as much water out as possible.

Once the vacuum pump is switched off, use tweezers to pull up one edge of the fabric, and then another edge. Pinch both edges together in the tweezers and transfer to the weigh boat it was weighed and transported originally.

Detach the hose on the vacuum flask, empty the filtered liquor from the vacuum flask into the sink. Reattach the hose.

Allow the samples to dry overnight in 38° C., 25% RH oven. (6 hours minimum)

### Preparation and Testing of Samples

After the samples have dried, weigh and record the weight of the weigh boat and film. Subtract the original weigh boat weight and the fabric weight to get the residue weight.

### Reporting of Test Results

After the samples have dried, weigh and record the weight of the weigh boat and film. Subtract the original weigh boat weight and the fabric weigh to get the residue weight.

These calculations describe the results.

$$\begin{matrix}Residue = final - \{ fabric ( initial ) + weigh boat ( initial ) \} \\ \% Residue = ( Residue / film ( initial ) ) * 100 \\ \% Dissolved = 100 - \% Residue\end{matrix}$$

There is a correction factor of 0.03 to be added to the Residue result. This accounts for typical fabric loss during the filter process.

Various embodiments of the disclosure will now be described in more detail below.

### EXAMPLES

The examples below further illustrate the present disclosure.

### Materials

The water-soluble films and related aqueous solutions for forming the water-soluble films of the disclosure were prepared using different water-soluble polyvinyl alcohol (PVOH) resins and water-soluble starches at different weight ratios and total solids loading levels. Control films were also prepared in these studies.

The following starches were used in various examples. Starch A is a cationic quaternary ammonium group-modified starch having a low average molecular weight in a range of about 10³-10⁶ g/mol, about 25 wt. % amylose, and a level of modification of 0.18 mol. %. The characteristics of Starch A and the other starches used in this study are shown in Table 2 below. Starch B is a cationic quaternary ammonium group-modified starch having a low average molecular weight in a range of about 10³-10⁶ g/mol, no amylose (100% amylopectin), and a level of modification of 0.18 mol. %. Starch C is a hydroxyethylated corn starch (neutrally modified starch) having about 25 wt. % amylose, and a level of modification lower than about 3.0 mol. %. Starch D is an unmodified starch having about 25 wt. % amylose and no modification. Starch E is an unmodified starch having no amylose and no modification. Starch F is an octenyl succinic acid modified waxy starch. Starch G is a hydroxyethylated corn starch (neutrally modified starch) having about 25 wt. % amylose and a level of modification lower than about 3.0 mol. %; the average molecular weight of Starch G is higher than that of hydroxyethylated Starch C. Starch H is a cationic group-modified starch having about 25 wt. % amylose. Starch J is a cationic group-modified starch having no amylose (100% amylopectin) and a level of modification of about 0.37 mol. %.

TABLE 2
The characteristics of different starches used in this study.

| | Percent | | |
|---|---|---|---|
| | Amylose | | Modification |
| Starch | (wt. %) | Modification | (Mol. %) |
| Starch A | 25 | Cationic | 0.18 |
| Starch B | 0 | Cationic | 0.18 |
| Starch Blend | 12.5 | Cationic | 0.18 |
| A:B (50:50) | | | |
| Starch C | 25 | Hydroxyethyl | <3.0 |
| Starch D | 25 | None | N/A |
| Starch E | 0 | None | N/A |
| Starch F | N/A | Octenyl succinic | N/A |
| | | acid modified | |
| Starch G | 25 | Hydroxyethyl | <3.0 |
| Starch H | 25 | Cationic | |
| Starch J | 0 | Cationic | 0.37 |

The following polyvinyl alcohol (PVOH) resins were used in various examples. Resin A is an anionic group-modified polyvinyl alcohol (PVOH) which is a polyvinyl alcohol modified by monomethyl maleate (MMM) and has a degree of modification of about 1.5-2.0 mol. % and 89-91 mol. % hydrolysis. Resin B is an anionic group-modified polyvinyl alcohol (PVOH) which is a polyvinyl alcohol modified by methyl acrylate (MA) and has a degree of modification of about 1-10 mol. % and 80-99 mol. % hydrolysis. Resin C is an anionic group-modified polyvinyl alcohol (PVOH) which is a polyvinyl alcohol modified by monomethyl maleate (MMM) and has a degree of modification of about 3.8-4.2 mol. % and 89-91 mol. % hydrolysis.

Two polyvinyl alcohol homopolymers, Resin D and Resin E, were also studied. Resin D is a commercially available polyvinyl alcohol homopolymer having a specification degree of hydrolysis of 86.7% to 88.7%, a pH of 4.5-7, and a specified 4% solution viscosity at 20° C. of 11.4-14.5 cP. Resin E is a commercially available polyvinyl alcohol homopolymer having a specification degree of hydrolysis of 87% to 89%, a pH of 5-7, and a specified 4% solution viscosity at 20° C. of 20.5-24.5 cP. However, the inventors found that these PVOH homopolymers had poor miscibility with, and phase separated from, all the starches tested at a total solid content in the film-forming aqueous solutions at 10 wt. % or higher and at a starch loading level higher than 15 wt. % of the total solid content. No film was able to be cast for Resin D or E with high loading levels of starch.

### Example 1

Water-Soluble Films with Anionic Polyvinyl Alcohol (Resin A)

In this study, different water-soluble films were prepared using an anionic group-modified polyvinyl alcohol, Resin A (a polyvinyl alcohol modified by monomethyl maleate (MMM)) and different types of starches, Starches A-E, shown in Table 2 respectively and at different PVOH/starch weight ratios respectively. The formulations for the different water-soluble films with different weight ratios of PVOH to starch are shown in Table 3 below and are described by their “PHR” starch. The PHR starch is based on 100 parts of the total PVOH and starch in the formulation and can also be determined according to PHR starch=100×Starch_{wt %}/(Starch_{wt %}, +PVOH_{wt %}). The polyvinyl alcohol used in each of the formulations in Table 3 was Resin A.

The methods of preparing the water-soluble films and the related aqueous solutions for forming these films were described below. The phase stability, the physical properties and the solubility of these water-soluble films were studied. The phase stability of the related aqueous solutions for forming each of the water-soluble films were also studied. The test results are shown in Table 4 below.

TABLE 3
The water-soluble film formulations comprising Resin A and various
starches at different weight ratios respectively. All percentages
are dry weight percentages of the film. The 33 PHR starch formulations
were prepared with two polyvinyl alcohol resins, 37.33 wt. % of Resin
A and 15.64 wt. % of Resin C by weight of the dry film. The rest
of the formulations (with 41, 45, 49, 55 and 80 PHR starches) were
prepared with anionic polyvinyl alcohol resin, Resin A.

| | 33 PHR | 41 PHR | 45 PHR | 49 PHR | 55 PHR | 80 PHR |
|---|---|---|---|---|---|---|
| Ingredient | Starch | Starch | Starch | Starch | Starch | Starch |
| PVOH | 53.32% | 43.51% | 40.56% | 37.61% | 33.19% | 14.75% |
| Starch | 26.26% | 30.24% | 33.19% | 36.14% | 40.56% | 59.00% |
| Sorbitol | 5.11% | 5.30% | 5.30% | 5.30% | 5.30% | 5.30% |
| Glycerin | 12.26% | 18.17% | 18.17% | 18.17% | 18.17% | 18.17% |
| Sodium | 0.80% | 0.74% | 0.74% | 0.74% | 0.74% | 0.74% |
| Metabisulfite | | | | | | |
| Anti-Foam | 0.02% | 0.02% | 0.02% | 0.02% | 0.02% | 0.02% |
| Anti-Block | 1.86% | 1.73% | 1.73% | 1.73% | 1.73% | 1.73% |
| Surfactant | 0.37% | 0.29% | 0.29% | 0.29% | 0.29% | 0.29% |

In this study, a blend of Starch A and Starch B at a weight ratio of 50:50 was also used to prepare water-soluble films. The A:B blend was evaluated in 41 PHR and 49 PHR formulations (Samples 12 and 23, respectively, in Table 4). The phase stability of the aqueous solutions and the physical properties and the water solubility time of the water-soluble films were tested, and test results are shown in Table 4 and detailed below.

### Methods of Preparing the Aqueous Solution for Forming the Water-Soluble Films

The aqueous solutions for forming the water-soluble films were prepared by the following steps: 1) heating water in a container to a temperature of about 85° C.; 2) adding the plasticizers (glycerin and sorbitol) and anti-foam agents while maintaining the water temperature at about 85° C.; 3) adding one of the starches in Table 2 to the water and mixing for about 1 hour to allow the starch to gelatinize and dissolve, adding an antiblock agent such as Hylon-V starch particles at the same time; 4) adding additives (e.g., sodium metabisulfite) and mixing for about 20 minutes; 5) adding Resin A (and Resin C, for the 33 PHR starch formulations) and mixing for about 1 hour; and 6) adding surfactant and mixing for about 10 minutes. During the preparation process, the water was maintained at a constant temperature of about 85° C.

In preparing the aqueous solutions, enough time, heat and shear force for the starch was applied to gelatinize and completely dissolve in the hot water, and further to mix with the PVOH uniformly to form miscible solutions or at least to prevent bulk phase separation between the PVOH and the water-soluble starch in the aqueous solutions and also the resulting water-soluble films.

After mixing, the aqueous solutions were stored in a 90° C. oven overnight to degas. This also gave time for aqueous solutions to phase separate if the formulation was not phase stable. The phase stability of each of the aqueous solutions were evaluated by visual inspection after 24 hours storage at 90° C. and the test results are shown in Table 4.

The aqueous solutions each had a total solid content in a range of 28-35 wt. % by weight of the aqueous solutions. The total solid contents for each of the aqueous solution formulations tested in this study are detailed in Table 4.

### Methods of Preparing the Water-Soluble Films

In this study, the samples in Table 4 that formed either single-phase aqueous solutions or gels were subsequently casted to form the films for further tests of the physical properties of the resulting films. The method of forming the water-soluble films involved casting the aqueous solutions or gels discussed herein above onto a substrate at a specified thickness; and drying water from the cast aqueous solution or gel to form the water-soluble film.

In this study, the water-soluble films were formed by the following steps: setting a casting bed at a temperature of about 205° F. (96° C.); setting a doctor blade to a desired width (which changes between each formulation as the width is heavily influenced by viscosity); using a spray bottle to distribute 1 wt. % of a release agent solution across the surface of the casting bed; metering the aqueous solution or gel into a casting trough; starting a machine arm which translates the doctor blade across the bed to cast the aqueous solution onto the surface and spread over the surface of the casting bed; drying to form a cast film; and removing the resulting cast film from the casting surface to form a standalone film. The drying time was about 7-12 minutes or about 8.5-9.5 minutes. The resulting films were further tested for their mechanical and solubility properties after standard conditioning at about 35% RH and 23° C. for 24 hours.

### Phase Stability of Aqueous Solutions Having Anionic Polyvinyl Alcohol (Resin A)

The phase stability of the liquid solution mixtures of all formulations in Table 3 was tested and the test results are shown in Table 4 below.

TABLE 4
The phase miscibility and the total solid content of the aqueous solutions,
and the mechanical properties and solubility (at 10° C.) for a
variety of formulations based off Resin A and different starches.

| | | | Total Solid | Max | Max | 10° C. | Solution |
|---|---|---|---|---|---|---|---|
| Sample | | PHR | Content | Stress | Strain | Water | Phase |
| No. | Starch | Starch | (wt. %) | (MPa) | (%) | Solubility | Miscibility |
| 1 | Starch A | 80 | 35 | 11.6 | 173.3 | >300 | Yes |
| 2 | Starch A | 55 | 32 | 21.1 | 279 | >300 | Yes |
| 3 | Starch C | 55 | 32 | N/A | N/A | N/A | No |
| 4 | Starch B | 55 | 32 | N/A | N/A | N/A | No |
| 5 | Starch D | 55 | 32/35 | 10.1 | 168 | >300 | No |
| 6 | Starch E | 55 | 32 | N/A | N/A | N/A | No |
| 7 | Starch A | 49 | 32 | 24.6 | 273 | 178 | Yes |
| 8 | Starch C | 49 | 32 | N/A | N/A | N/A | No |
| 9 | Starch B | 49 | 35 | 19.6 | 375 | 92 | No |
| 10 | Starch D | 49 | 32/35 | 13.7 | 213 | 225 | No |
| 11 | Starch E | 49 | 32 | N/A | N/A | N/A | No |
| 12 | Starch A:B | 49 | 32 | 21.9 | 350 | 116 | Yes |
| | (50:50) | | | | | | |
| 13 | Starch A | 45 | 28 | 21 | 217 | 152 | Yes |
| 14 | Starch C | 45 | 32 | 20.2 | 360 | 88 | Yes |
| 15 | Starch B | 45 | 32 | 24.4 | 343 | 104 | Yes |
| 16 | Starch D | 45 | 32 | 12 | 184 | >300 | Yes |
| 17 | Starch E | 45 | 32 | 19.8 | 324 | 125 | Yes |
| 18 | Starch A | 41 | 28 | 27 | 282 | 104 | Yes |
| 19 | Starch C | 41 | 28 | 25.9 | 325 | 108 | Yes |
| 20 | Starch B | 41 | 32 | 26.3 | 341 | 81 | Yes |
| 21 | Starch D | 41 | 32 | 17.1 | 245 | 200 | Yes |
| 22 | Starch E | 41 | 32 | 20.8 | 302 | 133 | Yes |
| 23 | Starch A:B | 41 | 32 | 25.7 | 368 | 98 | Yes |
| | (50:50) | | | | | | |

As shown in Table 4, Starch A (cationic group-modified starch) at all starch loading levels (41, 45, 49, 55 and 80 PHR) tested in this study formed single-phase aqueous solutions with no phase separation or no bulk phase separation between Starch A and Resin A (anionic group-modified PVOH) by visual inspection and further no formation of high viscosity gel. The aqueous solutions further had no phase separation or no bulk phase separation between the polyvinyl alcohol and starch by visual inspection as initially prepared and during and after storage at about 90° C. for at least 24 hours, and at least about 48 hours. The test results indicate that the Resin A and Starch A are miscible or at least have no bulk phase separation in the resulting aqueous solutions at the starch loading levels of up to about 80 PHR. Further testing by differential scanning calorimetry (DSC) showed a single Tg for the resulting water-soluble films having Starch A at 41 PHR and 45 PHR respectively.

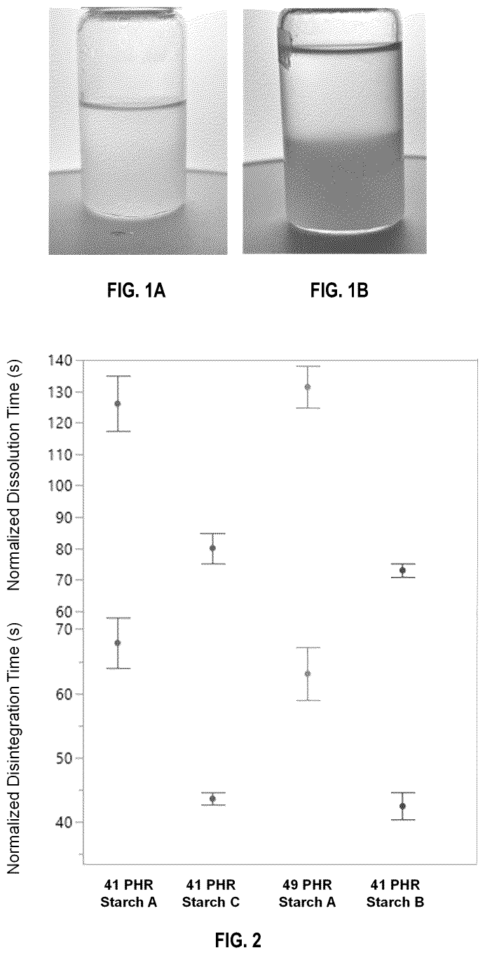

An image of the single phase solution of Sample 2 is shown in FIG. 1A which is a representative image of the single phase solution with no phase separation or no bulk phase separation for all the stable and single-phased formulations described in the disclosure. The images were taken using a hot-plate as a lightbox and using a monochrome filter on a camera. This method allowed for phase separation to be easily identified by the opacity of the solution. Solutions with varying opacity are non-homogenous and therefore have phase separation using a monochromatic color filter and a lightbox behind the sample resulted in easy to distinguish phases when taking images.

For cationic Starch B having the same type and degree of cationic quaternary ammonium group modification and similar molecular weight as that of Starch A but no amylose while Starch A has about 25 wt. % amylose, single phase aqueous solutions were formed only at somewhat lower starch loading levels of 41 PHR (Sample 20) and 45 PHR (Sample 15) respectively, which are still useful levels higher than what could be achieved with normal starches. When the starch loading level was increased to 49 PHR, slight phase separation was observed in the resulting liquid solution mixture (Sample 10). When the starch loading was further increased to 55 PHR, apparent phase separation was observed in the resulting solution (Sample 4). Therefore, the test results indicated that the amylose content of the cationic starch also affects the phase stability of formed liquid solution mixtures with anionic Resin A.

A blend of cationic Starch A and Starch B at weight ratio of 50:50 with resulting average amylose content of about 12.5 wt. % based on the total weight of the starch was used to prepare the aqueous solutions at loading levels of 41 and 49 PHR respectively. In contrast, as noted above, the liquid solution mixture having Starch B at both loading levels, the resulting aqueous solutions had a single phase, and no phase separation was observed.

For non-ionic group-modified Starch C (hydroxyethyl group-modified starch with a degree of modification lower than 3.0 mol. %), it formed stable aqueous solution with Resin A at relatively lower starch loading levels of 41 PHR (Sample 19) and 45 PHR (Sample 14) tested respectively. At higher starch loading levels of 49 PHR (Sample 8) and 55 PHR (Sample 3), these liquid solution mixtures with Starch C were not stable and phase separated into two layers. An image of the solution phase separation of Sample 8 is shown in FIG. 1B which is a representative image of the solution phase separation for all the unstable and phased separated formulations described in the disclosure.

For unmodified Starch D having 25 wt. % amylose, the formulations with Starch D formed stable aqueous solution with Resin A only at relatively lower starch loading levels of 41 and 45 PHR respectively. However, the formulations at higher loading levels of 49 and 55 PHR of Starch D respectively, were observed to form gels which had high viscosity and thus were difficult for subsequent film formation. While not wishing to be bound by theory, it is believed that the gel formation may be caused by the amount of unmodified amylose (25%) in the unmodified Starch D. Given that gel formation drastically increases viscosity of the solution, this shows that unmodified high amylose starches such as Starch D are not preferred for forming films.

For unmodified starches, Starch E having no amylose, the formulations with Starch D formed stable aqueous solution with Resin A only at relatively lower starch loading levels of 41 and 45 PHR respectively. However, the formulations at higher loading levels of 49 PHR and 55 PHR of Starch E respectively, were observed to form unstable liquid solution, and Resin A and Starch E were phase separated into two layers for these two formulations. The phase separation behavior was observed to be similar to the image of the solution phase separation shown in FIG. 1B.

The test results in this study clearly demonstrated that a combination of low molecular weight, the amylose content, and the type and degree of cationic modification of cationic Starch A enables Starch A to have good interaction with anionic Resin A in the aqueous solutions and the formation of single phase stable aqueous solutions at starch loading levels up to 80 PHR (or starch:PVOH weight ratios up to 4:1). Further, no phase separation or bulk phase separation was observed in any of the aqueous solutions and the resulting water-soluble films comprising Resin A and Starch A even at high starch loading levels up to 80 PHR. However, for the similar molecular weight and cationic modification type and level, Starch B having 0 wt. % amylose was phase separated from Resin A at high starch loading levels of 49 PHR and higher. In order to study the effect of amylose content on the phase stability of the resulting liquid solutions with the same formulation in Table 3, a blend of Starch A and Starch B at 50:50 weight ratio (resulting in a starch blend having 12.5 wt. % amylose) was also studied. The test results indicated that the formulation with 49 PHR of the starch blend formed a stable single phase aqueous solution and no phase separation or bulk phase separation was observed in the resulting aqueous solution and the water-soluble film. The test results clearly demonstrated that the higher amylose content of the cationic starch results in better interaction with the anionic PVOH and leads to more phase stable aqueous solutions at high starch loading levels.

Comparing the phase stability of the formulations of unmodified Starch D (25 wt. % amylose) to that of unmodified Starch E (0 wt. % amylose), the test results demonstrated that the unmodified starch having high amylose content tends to form high viscosity gels, while the unmodified starch with lower amylose content tends to have phase separation from the PVOH at high starch loading levels such as 49 PHR and higher. The solutions made from the formulations using non-ionic group-modified Starch C were also unstable and tended to phase separate at high starch loading levels such as 49 PHR and higher.

### Phase Stability of Aqueous Solutions Having A Blend of Two Anionic Polyvinyl Alcohol Resins (Resin A and Resin C) and 33 PHR Starch

The aqueous solutions for the formulations with a blend of two anionic polyvinyl alcohol resins (33.73 wt. % Resin A and 15.64 wt. % Resin C) and 33 PHR of different starches were prepared and further tested for phase stability. All the 33 PHR starch formulations each formed a single-phase aqueous solution with no phase separation or no bulk phase separation between the starch and the polyvinyl alcohol resins by visual inspection and no formation of high viscosity gel. Further, the aqueous solutions were phase stable and had no phase separation or bulk phase separation as initially prepared, and during and after storage in a 90° C. oven for about 24 hours and about 48 hours.

### Mechanical Properties of the Resulting Water-Soluble Films

The mechanical properties and the solubility of the resulting water-soluble films were tested and the test results are shown in Table 4 above.

As shown in Table 4, the films formed with cationic Starch A had excellent maximum stress higher than 20 MPa and high strain at break at all starch loading levels tested in this study and had the best maximum stress at high starch loading levels of 49 PHR and 55 PHR as compared to the films with other starches tested. At lower starch loading levels of 41 PHR and 45 PHR, both cationic Starch A and Starch B and non-ionic group-modified Starch C showed comparable excellent maximum stress and strain at break.

In contrast, films made from unmodified Starch D (25 wt. % amylose) showed the worst maximum stress and strain at break as compared to those of the other starches tested in this study. Films with unmodified Starch E (0 wt. % amylose) at low starch loading levels of 41 and 45 PHRs respectively exhibited acceptable maximum stress and strain at break, but worse than those of the modified Starches A, B and C.

### Solubility of the Resulting Water-Soluble Films

The water solubility of the resulting different films at 10° C. were tested and the test results are shown in Table 4. The cold-water solubility of the resulting different films at 5° C. were tested and the test results are shown in FIG. 2.

As shown in Table 4 and FIG. 2, the amylose content and the modification type and level of the starches affects the cold-water solubility of the corresponding films made from each of the starches. The water solubility at both 10° C. and 5° C. for the films made with cationic Starch A decreased (longer dissolving time) as the concentration of Starch A increased in the film. The films made with cationic Starch B at loading levels of 41 and 45 PHR showed excellent cold-water solubility at both 10° C. and 5° C. and overall best mechanical properties. The films made with non-ionic Starch C also demonstrated excellent cold-water solubility at both 10° C. and 5° C. The films made with unmodified Starch D demonstrated slower cold-water solubility at 10° C.

Amylose Effects on Solubility: For cationic starches, Starch A (25 wt. % amylose), Starch B (0 wt. % amylose) and blend of Starch A and B (average 12.5 wt. % amylose) having similar type and degree of cationic modification, the lower the amylose content of the starch resulted in better cold-water solubility of the corresponding films (shorter solubility time at both 10° C. and 5° C.). For unmodified starches, Starch D (25 wt. % amylose) and Starch E (0 wt. % amylose), the lower the amylose content of the starch also resulted in more rapid cold-water solubility of the corresponding films at 10° C.

Modification Effects on Solubility: For starches having the same amylose content (25 wt. %), Cationic Starch A, non-ionic Starch C and unmodified Starch D, the modification of the starch achieved more rapid cold-water solubility of the corresponding films at 10° C. For starches having no amylose, Cationic Starch B and unmodified Starch E, the modification of the starch also achieved more rapid cold-water solubility of the corresponding films at 10° C.

### Example 2

Water-Soluble Films with Anionic Polyvinyl Alcohol (Resin B)

In this study, a variety of formulations with different weight ratios of the polyvinyl alcohol to starch were developed which are described by their “PHR” starch in Table 5. The PHR starch is based on 100 parts of the total PVOH and starch in the formulation and can also be determined according to PHR starch=100×Starch_{wt %}/(Starch_{wt %}, +PVOH_{wt %}). The polyvinyl alcohol used in all the formulations in Table 4 was the anionic group-modified polyvinyl alcohol, Resin B (the polyvinyl alcohol modified by Methyl Acrylate (MA)). The starches in Table 2 were all studied respectively in the formulations of Table 5.

TABLE 5
Water-soluble film formulations comprising Resin B and various
starches at different PVOH/starch weight ratios respectively.
All percentages are weight percentages of the dry film.

| | 49 PHR Starch | 43 PHR Starch | 43 PHR Starch |
|---|---|---|---|
| | (Samples 24- | (Sample 29) | (Sample 30) |
| | 28) | Approx. | Approx. |
| Ingredients | Approx. wt. % | wt. % | wt. % |
| Resin B | 38 | 41 | 41 |
| Starches A to E | 36 | 30 | 31 |
| respectively | | | |
| Sorbitol | 5 | 9 | 8 |
| Glycerin | 18 | 17 | 16 |
| Sodium | 1 | <1 | <1 |
| Metabisulfite | | | |
| Anti-foam | <1 | <1 | <1 |
| Anti-block | 2 | 1 | 2 |
| Surfactant | <1 | 1 | 1 |

The aqueous solutions for forming the water-soluble films were prepared by dissolving the components in formulations in Table 5 in methods similar to the methods disclosed herein above in Example 1. The water-soluble films in this study were made by casting the corresponding aqueous solutions in methods similar to the methods disclosed herein above in Example 1.

The resulting films were further tested for their mechanical and solubility properties as shown in Table 6 below.

### Phase Stability of Aqueous Solutions Having Anionic Polyvinyl Alcohol (Resin B)

The phase stability of the aqueous solutions were studied by visual inspection during storage at 90° C. for at least about 24 hours. The test results are shown in Table 6 below.

TABLE 6
The phase stability of the aqueous solutions and the mechanical properties
and solubility of the resulting water-soluble films having Resin B.

| | | PHR | Max Stress | Max Strain | Solubility | Phase |
|---|---|---|---|---|---|---|
| Sample # | Starch | Starch | (MPa) | (%) | (10° C.) (s) | Stability |
| 24 | Starch A | 49 | 26 | 369 | 106 | Yes |
| 25 | Starch C | 49 | N/A | N/A | N/A | No |
| 26 | Starch B | 49 | 24 | 336 | 86 | Yes |
| 27 | Starch D | 49 | 21 | 269 | >300 | Yes |
| 28 | Starch E | 49 | 27 | 312 | 89 | Yes |
| 29 | Starch A | 43 | 26 | 373 | 122 | Yes |
| 30 | Starch A | 43 | 28 | 304 | 70 | Yes |

As shown in Table 6, the liquid solution mixture of Sample 25 made with 49 PHR of non-ionic Starch C was not stable and the PVOH and the starch were phased separated in the liquid solutions. All other aqueous solutions with Resin B were phase stable as initially prepared and during and after storage at 90° C. for at least about 24 hours.

### Mechanical Properties of the Resulting Water-Soluble Films

The mechanical properties of the resulting water-soluble films were tested, and the test results are shown in Table 6 above.

As shown in Table 6, the films formed with cationic Starch A had high maximum stress higher than 20 MPa and high strain at break at starch loading levels of both 43 and 49 PHR, which are good for packaging applications. At starch loading levels of 49 PHR, the films made with cationic Starch A (25 wt. % amylose), cationic Starch B (0 wt. % amylose), and unmodified Starch E (0 wt. % amylose) respectively all demonstrated high maximum stress and maximum strain at break, beneficial for packaging applications, while the film made with unmodified Starch D showed the lowest mechanical properties. The test results demonstrated that unmodified starch with high amylose content resulting in water-soluble films with lower mechanical properties.

### Water Solubility of the Resulting Water-Soluble Films

The water solubility of the resulting different films at 10° C. were tested, and the test results are shown in Table 6 above.

As shown in Table 6, the film (Sample 27) made with unmodified Starch D (25 wt. % amylose) was shown to be not soluble in 10° C. water. This again indicated that Starch D (unmodified, high amylose) is not preferred for water-soluble film applications. However, this may have potential application outside water-soluble films, for example, as an oxygen barrier film used for packaging applications.

### Example 3

### Optical Micrographs of Stretched and Unstretched Film of Sample 31

In this study, Starch F (the octenyl succinic acid (OSA)-modified starch) was studied using the formulation in Table 7, and the film sample prepared is labeled as Sample 31.

TABLE 7
Water-soluble film formulations comprising Resin B and 33 PHR
Starch F. All percentages are weight percentages of the dry film.

| | 33 PHR Starch |
|---|---|
| Ingredient (wt. %) | (Sample 31) |
| Resin B | 44.00% |
| Starch F | 21.50% |
| Sorbitol | 8.46% |
| Glycerin | 19.35% |
| Sodium | 0.09% |
| Metabisulfite | |
| Anti-Foam | 0.46% |
| Other Additives | 3.63% |

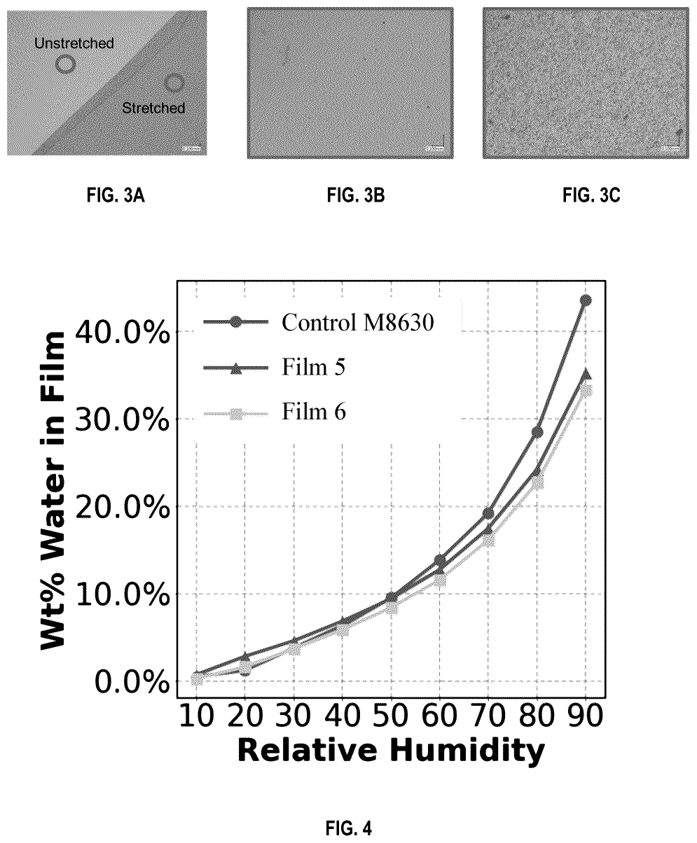

Sample 31 had about 33 PHR Starch F (octenyl succinic acid (OSA)-modified starch) in its formulation as shown in Table 5. This aqueous solution of this formulation and the resulting films were prepared according to the methods similar to the methods disclosed in Example 1. The resulting films had many undesirable properties. Over time the starch in the film became oxidized which led to roll blocking and a color change of the film from clear to brown. The film also exhibited substantial strain whitening upon stretching. Micrographs of stretched and unstretched film are shown in FIG. 3. Without intending to be bound by theory, it is believed that the stress whitening may be due to (solid) phase segregation of the PVOH and the starch at the 10-100 μm scale. This strain whitening behavior was not observed with other PVOH/starch water-soluble films prepared in this study. The test results may suggest that the highly non-polar and bulky OSA modification of the starch is not preferred in water-soluble film applications.

### Example 4

### Capsules Having Pouches Made of the Water-Soluble Films

The capsules having pouches made of the water-soluble films prepared in Examples 1 and 2 were prepared. A liquid composition was enclosed in each of the pouches. The liquid release times (LRT) of the pouches were tested according to the Liquid Release Test described above, and the test results are shown in Table 8 below. As with the descriptions above, the PHR level of starch is based on the total content of starch and PVOH resin.

All capsules were formed to a draw ratio of 2.5 (a draw ratio is calculated by a ratio of the final area to the original area of the film perpendicular to the drawing direction) and samples were tested in room temperature and deionized (D.I.) water. Capsules 1-4 were tested with a first liquid laundry detergent (LLD 1). Only Capsule 5 (Sample 7 from Example 1) was tested with a second LLD (LLD 2) different from the first liquid laundry detergent. Capsules were tested within a week of film to capsule conversion.

TABLE 8
Liquid release time of capsules having pouches
made with different water-soluble films.

| | | | | LRT | LRT | Liquid Laundry |
|---|---|---|---|---|---|---|
| Capsule | Film | PVOH | Starch | Average (s) | Stdev (s) | Detergent |
| 1 | Sample 29 | Resin B | 43 PHR | 143 | 15.2 | LLD 1 |
| | Example 2 | | Starch A | | | |
| 2 | Sample 30 | Resin B | 43 PHR | 163 | 20.7 | LLD 1 |
| | Example 2 | | Starch A | | | |
| 3 | Sample 18 | Resin A | 41 PHR | 135 | 16.2 | LLD 1 |
| | Example 1 | | Starch A | | | |
| 4 | Sample 19 | Resin A | 41 PHR | 139 | 11.6 | LLD 1 |
| | Example 1 | | Starch C | | | |
| 5 | Sample 7 | Resin A | 49 PHR | 250 | 42.6 | LLD 2 |
| | Example 1 | | Starch A | | | |

As shown in Table 8, all Capsules 1-5 made from the starch/PVOH films had liquid release time longer than 30 s threshold which is required by regulatory agencies for liquid laundry detergent. All capsules had a liquid release time of at least 2 minutes but less than 5 minutes. The Capsule 5 made from the film of Sample 7 in Example 1 (having 51 PHR Resin A and 49 PHR Starch A) had a significantly longer liquid release time although this might be due to the use of a different LLD. There was no significant difference between Capsule 3 (41 PHR Starch A) and Capsule 4 (41 PHR Starch C) despite Starch C formulations generally having the faster water solubility.

### Example 5

### Compression Strength of the Capsules

The compression strength of the capsules having pouches made from the films in Examples 1 and 2 were tested the Capsule Compression Test described above. The test results are shown in Table 9.

TABLE 9
Compression strength of capsules

| | | | | | Comp. | Comp. | Early |
|---|---|---|---|---|---|---|---|
| | | | | | Strength | Strength | Seal |
| Capsule | Film | PVOH | Starch | Seal Type | Avg [N] | Stdev [N] | Failures |
| 1 | Sample 18 | Resin A | Starch A | Matte:Matte | 827 | 471 | 20% |
| | Example 1 | | | | | | |
| 2 | Sample 29 | Resin B | Starch A | Matte:Matte | 140 | 140 | 40% |
| | Example 2 | | | | | | |
| 3 | Sample 29 | Resin B | Starch A | Matte:Gloss | 1012 | 204 | 0% |
| | Example 2 | | | | | | |
| 4 | Sample 29 | Resin B | Starch A | Gloss:Gloss | 1219 | 63 | 0% |
| | Example 2 | | | | | | |
| 5 | Sample 19 | Resin A | Starch C | Matte:Matte | 519 | 407 | 40% |
| | Example 1 | | | | | | |
| 6 | Sample 19 | Resin A | Starch C | Gloss:Gloss | 716 | 389 | 20% |
| | Example 1 | | | | | | |
| 7 | Sample 30 | Resin B | Starch A | Matte:Matte | 1337 | 142 | 0% |
| | Example 2 | | | | | | |
| 8 | Sample 30 | Resin B | Starch A | Gloss:Gloss | 1256 | 170 | 0% |
| | Example 2 | | | | | | |
| 9 | Sample 7 | Resin A | Starch A | Matte:Matte | 1478 | 628 | 20% |
| | Example 1 | | | | | | |
| 10 | Sample 7 | Resin A | Starch A | Gloss:Gloss | 920 | 331 | 0% |
| | Example 1 | | | | | | |

In this study, early seal failure was defined as a failure <25% of the maximum compression strength in each sample set. The matte surface of the film refers to the surface touching the band and the release agent transferred to the film, sometimes resulting in higher seal failures.

The compression strength of the capsules is dependent on the mechanical properties of the film and the seal strength. All capsules in this study demonstrated average compression strengths in a range of about 600-1500 N which are well above a typical industry requirement of 300N. The formulations that gave the best matte to matte sealing were Capsules 1, 7, 8, and 9-10. Seal failure can usually be detected by lightly applying pressure to a capsule by hand.

### Example 6

### Residue Testing

Residue tests were conducted on the water-soluble films prepared in Examples 1 and 2 according to the Accelerated Quantitative Residue Assessment test method described herein above. The test results are shown in Table 10 below.

TABLE 10
Residue testing of films prepared in Examples 1 and 2 by scale.

| | Trial | | Starch | | | |
|---|---|---|---|---|---|---|
| Film | Scale | Film | PHR | Starch | % Residue | % Dissolved |
| 1 | B | Sample 29 Example 2 | 41 | Starch A | 2.45% | 97.55% |
| 2 | B | Sample 13 Example 1 | 45 | Starch A | 18.49% | 81.51% |
| 3 | B | Sample 7 Example 1 | 49 | Starch A | 9.68% | 90.32% |
| 4 | B | New Sample 32 | 52 | Starch A | 10.00% | 90.00% |
| 5 | B | New Sample 33 | 80 | Starch A | 20.72% | 79.28% |
| 6 | B | Sample 9 Example 1 | 49 | Starch B | 2.60% | 97.40% |
| 7 | L | Sample 18 Example 1 | 41 | Starch A | 5.73% | 94.27% |
| 8 | L | Sample 19 Example 1 | 41 | Starch C | 5.62% | 94.38% |
| 9 | L | Sample 30 Example 2 | 43 | Starch A | 6.82% | 93.18% |
| 10 | S | Sample 18 Example 1 | 41 | Starch A | 20.34% | 79.66% |

All films were tested without liquid laundry detergent (LLD) exposure. LLD exposure may significantly change residue results. All water used was tap water at 14° C. In Table 10 above, B refers to bench trial cast film samples; L refers to pilot trial cast film samples; and S refers to semi-works trial cast film samples.

As shown in Table 10, Film 6 (49 PHR Starch B) had 7% less residue than Film 3 (49 PHR Starch A). This was reinforced by the data presented in Example 1 that cationic Starch A (25 wt. % amylose) is less soluble in water than cationic Starch B (0 wt. % amylose). Film 4 had very similar residue compared to Film 3 despite having 3 PHR more Starch A. Film 7 and Film 8 had no significant difference in residue despite the difference in starches. Film 10 had a substantially higher residue than that of Film 7. This may possibly be due to differences in processing conditions.

### Example 7

### Differential Scanning Calorimetry (DSC) Thermal Analysis of Select Films

Some of the bench trial cast film samples prepared in Examples 1 and 2 were further analyzed to measure the glass transition temperature (Tg), the melting temperature (Tm), the crystalline temperature (Tc) and the melting and crystalline enthalpies using differential scanning calorimetry (DSC). The thermal analysis test results are shown in Table 11 below.

TABLE 11
Summary of DSC data collected on bench cast starch/PVOH films
compared to a commercial PVOH (Resin A) control film.

| | | | | | | | | Melting | Cryst. | Melting |
|---|---|---|---|---|---|---|---|---|---|---|
| | | | PHR | Tg | Tm1 | Tc | Tm2 | Enthalpy 1 | Enthalpy | Enthalpy 2 |
| Film # | Starch | Resin | Starch | (° C.) | (° C.) | (° C.) | (° C.) | (J/g) | (J/g) | (J/g) |
| 1 | Starch A | Resin A | 41 | 28.6 | 174.0 | 130.8 | 174.1 | 7.86 | 9.59 | 6.37 |
| 2 | Starch A | Resin A | 41 | 28.6 | 177.4 | 130.2 | 173.7 | 8.30 | 10.04 | 6.89 |
| 3 | Starch C | Resin A | 41 | 28.3 | 171.6 | 121.2 | 169.5 | 8.66 | 9.72 | 6.61 |
| 4 | Starch C | Resin A | 41 | 38.7 | 169.8 | 123.9 | 173.1 | 7.89 | 7.97 | 4.92 |
| 5 | Starch E | Resin A | 41 | 28.4 | 169.6 | 127.0 | 172.0 | 5.90 | 4.75 | 2.87 |
| 6 | Starch E | Resin A | 41 | 27.6 | 179.2 | 125.2 | 169.3 | 9.44 | 8.17 | 5.66 |
| 7 | Starch D | Resin A | 41 | 24.9 | 173.1 | 130.8 | 173.4 | 7.12 | 8.31 | 4.90 |
| 8 | Starch D | Resin A | 41 | 25.1 | 173.9 | 130.9 | 173.5 | 6.35 | 7.86 | 4.61 |
| 9 | Starch B | Resin A | 41 | 28.6 | 159.7 | 123.9 | 170.4 | 9.35 | 9.12 | 6.45 |
| 10 | Starch B | Resin A | 41 | 25.1 | 174.8 | 123.4 | 169.6 | 9.12 | 9.79 | 7.06 |
| 11 | Starch A | Resin A | 49 | 49.2 | 176.5 | 133.3 | 176.2 | 6.58 | 7.54 | 4.96 |
| 12 | Starch B | Resin A | 49 | 32.0 | 174.0 | 125.5 | 172.7 | 8.35 | 9.00 | 6.54 |
| 13 | Starch B | Resin A | 49 | 25.1 | 172.9 | 125.1 | 170.9 | 7.83 | 9.88 | 8.31 |
| 14 | Starch A | Resin B | 49 | 18.3 | 176.4 | 135.9 | 176.4 | 11.88 | 13.33 | 9.71 |
| 15 | Starch A | Resin A | 49 | 11.2 | 176.6 | 135.7 | 176.2 | 10.54 | 12.54 | 9.39 |
| 16 | Starch D | Resin A | 49 | 28.6 | 171.0 | 133.5 | 175.5 | 5.29 | 7.32 | 3.94 |
| 17 | Starch D | Resin A | 49 | 24.9 | 171.1 | 130.6 | 172.1 | 6.65 | 8.26 | 5.11 |
| Control | — | — | — | 57.8 | 179.5 | 142.2 | 183.3 | 20.19 | 15.05 | 11.05 |

Differential Scanning calorimetry (DSC) measurements were conducted on a variety of starch/PVOH films. Enthalpy of melting and crystallization are lower for starch/PVOH hybrid films than the control film (a commercial polyvinyl alcohol (Resin A) film without starch). This suggests lower crystallinity for starch/PVOH films compared to existing commercial films without water-soluble starch. This could partially be due to the difference in process conditions at the bench and production scales (i.e., films at the bench scale generally have lower crystallinity); however, it is expected that starch will have lower crystallinity than PVOH. Interestingly, some starches seem to reduce crystallinity more than others. For example, at two different loading levels Starch B/Resin A films (Film 9, 10, 12 and 13) had substantially higher crystallinity than Starch D/Resin A (Film 7, 8, 16 and 17) films. Films 14 and 15 having Starch A and Resin B showed the highest crystallinity among the films tested in this study. This suggests that the type(s) of starch used in the formulation can be used to tune the crystallinity of the final film. This is beneficial because increasing crystallinity improves mechanical properties but may reduce solubility time. Therefore, the ability to engineer crystallinity based on starch selection may allow for the optimization of crystallinity to balance effects of dissolution time and mechanical properties. Further, all the samples tested showed a single Tg.

### Example 8

### DVS Analysis of Select Formulations

Dynamic vapor sorption (DVS) analysis was conducted on some of the samples prepared in Examples 1 and 2 and the test results are shown in Table 12.

TABLE 12
Dynamic Vapor Sorption (DVS) data measuring the water uptake of film at 23° C.

| Film | Bench | | | PHR | RH 10% | RH 25% | RH 50% | RH 80% |
|---|---|---|---|---|---|---|---|---|
| No. | Formulation | PVOH | Starch | Starch | % Moisture in Film | | | |
| 1 | Sample 24 | Resin B | Starch A | 49 | 0.5 | 3.4 | 9.3 | 27.0 |
| | Example 2 | | | | | | | |
| 2 | Sample 26 | Resin B | Starch B | 49 | 0.3 | 2.9 | 9.0 | 26.4 |
| | Example 2 | | | | | | | |
| 3 | Sample 27 | Resin B | Starch D | 49 | 0.5 | 3.3 | 9.3 | 26.7 |
| | Example 2 | | | | | | | |
| 4 | Sample 28 | Resin B | Starch E | 49 | 0.6 | 3.4 | 9.2 | 26.4 |
| | Example 2 | | | | | | | |
| 5 | Sample 18 | Resin A | Starch A | 41 | 0.5 | 3.2 | 8.8 | 25.3 |
| | Example 1 | | | | | | | |
| 6 | Sample 19 | Resin A | Starch C | 41 | 0.8 | 3.6 | 9.3 | 26.0 |
| | Example 1 | | | | | | | |
| 7 | Sample 20 | Resin A | Starch B | 41 | 0.5 | 3.3 | 9.1 | 25.9 |
| | Example 1 | | | | | | | |
| 8 | Sample 21 | Resin A | Starch D | 41 | 0.9 | 3.6 | 9.3 | 25.7 |
| | Example 1 | | | | | | | |
| 9 | Sample 22 | Resin A | Starch E | 41 | 0.6 | 3.4 | 9.2 | 26.6 |
| | Example 1 | | | | | | | |
| 10 | Sample 18 | Resin A | Starch A | 41 | 0.3 | 2.9 | 8.6 | 25.2 |
| | Example 1 | | | | | | | |
| | SXP | | | | | | | |
| 11 | Sample 13 | Resin A | Starch A | 45 | 0.6 | 3.2 | 8.7 | 25.0 |
| | Example 1 | | | | | | | |
| 12 | Sample 14 | Resin A | Starch C | 45 | 0.6 | 3.4 | 9.1 | 25.8 |
| | Example 1 | | | | | | | |
| 13 | Sample 15 | Resin A | Starch B | 45 | 1.3 | 4.0 | 9.7 | 26.4 |
| | Example 1 | | | | | | | |
| 14 | Sample 16 | Resin A | Starch D | 45 | 0.9 | 3.5 | 9.2 | 25.7 |
| | Example 1 | | | | | | | |
| 15 | Sample 17 | Resin A | Starch E | 45 | 0.5 | 3.3 | 9.2 | 26.2 |
| | Example 1 | | | | | | | |
| 16 | Sample 7 | Resin A | Starch A | 49 | 0.1 | 1.9 | 7.3 | 22.9 |
| | Example 1 | | | | | | | |
| 17 | Sample 9 | Resin A | Starch B | 49 | 0.3 | 2.7 | 8.5 | 25.3 |
| | Example 1 | | | | | | | |
| 18 | Sample 10 | Resin A | Starch D | 49 | 0.9 | 3.6 | 9.3 | 25.7 |
| | Example 1 | | | | | | | |
| 19 | Sample 7 | Resin A | Starch A | 49 | 0.3 | 2.7 | 8.4 | 24.7 |
| | Example 1 | | | | | | | |
| | LXP | | | | | | | |
| 20 | Sample 2 | Resin A | Starch A | 55 | 0.2 | 2.8 | 8.9 | 26.3 |
| | Example 1 | | | | | | | |
| 21 | Sample 5 | Resin A | Starch D | 55 | 0.9 | 3.6 | 9.2 | 25.3 |
| | Example 1 | | | | | | | |
| 22 | Sample 1 | Resin A | Starch A | 80 | 0.7 | 3.4 | 9.0 | 25.3 |
| | Example 1 | | | | | | | |
| 23 | Control | Resin A | N/A | 0 | 0.3 | 2.8 | 6.4 | 20.7 |

Dynamic Vapor Sorption (DVS) data shows water uptake and retention at specified humidity. In this experiment the Relative Humidity (RH) was ramped up to 80% RH in 10 steps and then back down to 0% in the next 10 steps. The RH value was held constant until every sample reached an equilibrium moisture and percent moisture could be determined by mass gain. Percent moisture was calculated based on the minimum mass measured of the film after equilibrating for 16 hours at 0% RH and 25° C.

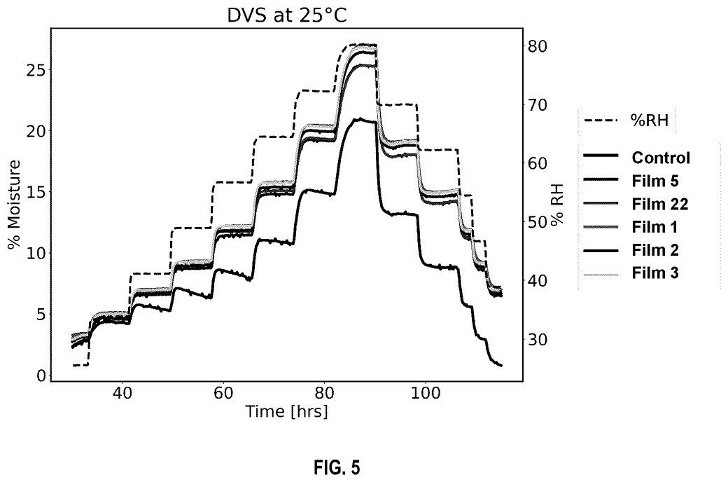

Further, the test results of dynamic vapor sorption after equilibrium at the specified moisture for Film 5 (59 PHR Resin A and 41 PHR Starch A) and Film 6 (59 PHR Resin A and 41 PHR Starch C) at 23° C. are also shown in FIG. 4 and also compared to a control film of Control M8630 (a commercial film having Resin B without water-soluble starch). The dynamic vapor sorption over time test results for Films 1-3, 5, 22 and Resin A-containing Control film (containing Resin A without water-soluble starch) are shown in FIG. 5. In FIG. 5, the order of the data plots, top-to-bottom at around 80-90 hours, is as follows: Film 1, Film 3, Film 2, Film 22/Film 5 (substantially overlapping), Control.

The experimental results in Table 12 and FIGS. 4 and 5 show that there is not large variability between water uptake of between different PVOH/starch films of this study. The DVS water uptakes for Film 5 and Film 6 are very similar to each other at all measured relative humidities and are slightly lower than that of Control MonoSol M8630 film at relative humidity at 50% and higher.

However, it can be clearly seen from the FIG. 5 that all of the PVOH/starch films have very different behavior when compared to the Resin A-containing Control film. For this Control at each new RH value, the weight percentage of moisture in the film rises sharply and then falls. Without intending to be bound by any particular theory, it is believed that this was caused by the crystallization of the amorphous region of the film which leads to less capacity for water uptake in the film. This effect is not observed for any of the PVOH/starch films, suggesting that the additional crystallization does not occur at room temperature with increasing % RH.

### Example 9

Water-soluble films comprising PVOH, starch, and auxiliary agents, in the amounts shown in Table 13, were prepared according to methods described herein. The total starch content of each composition was 0, 10, 20, 30, or 40 PHR, as indicated in Table 13. The PVOH in all films was Resin A. The starch was one of Starches A-E, G, H, or J, or a 1:1 (wt:wt) blend of two cationic starches having a total amount of starch as listed in the tables below.

TABLE 13

| | 0 PHR | 10 PHR | 20 PHR | 30 PHR | 40 PHR |
|---|---|---|---|---|---|
| Ingredient | Starch | Starch | Starch | Starch | Starch |
| PVOH | 73.75% | 66.38% | 59.00% | 51.63% | 43.25% |
| Starch | 0.00% | 7.38% | 14.75% | 22.13% | 28.83% |
| Sorbitol | 5.30% | 5.30% | 5.30% | 5.30% | 5.30% |
| Glycerin | 18.17% | 18.17% | 18.17% | 18.17% | 18.17% |
| Sodium | 0.74% | 0.74% | 0.74% | 0.74% | 0.74% |
| Metabisulfite | | | | | |
| Anti-Foam | 0.02% | 0.02% | 0.02% | 0.02% | 0.02% |
| Anti-Block | 1.73% | 1.73% | 1.73% | 1.73% | 1.73% |
| Surfactant | 0.29% | 0.29% | 0.29% | 0.29% | 0.29% |

Strain at break of films having recipes as listed in Table 13, including Starch A, C, E, or G as the starch, was measured according to the method described herein; results are shown in Table 14.

TABLE 14
Strain at Break values of various PVOH/starch-containing films.

| | | Total Starch Content | | | | |
|---|---|---|---|---|---|---|
| Starch | Modification | 0 PHR | 10 PHR | 20 PHR | 30 PHR | 40 PHR |
| A | Cationic | 375% | 403% | 356% | 301% | 284% |
| C | Hydroxyethyl | 375% | 373% | 389% | 394% | 351% |
| | (low MW) | | | | | |
| G | Hydroxyethyl | 375% | 391% | 358% | 335% | 284% |
| | (high MW) | | | | | |
| E | None | 375% | | | | 300% |

Films containing Starch C, a hydroxyethyl-modified starch, retained flexibility with increased starch loadings up to 40 PHR to a greater extent than otherwise identical films containing Starch E (unmodified starch) or Starch A (cationic starch). Films containing Starch C also retained flexibility with increased starch loadings up to 40 PHR to a greater extent than otherwise identical films containing Starch G, a hydroxyethyl-modified starch having a higher average molecular weight than Starch C.

Young's modulus of films having recipes as listed in Table 13 and including a starch or starch blend as listed in Table 15 was measured according to the method described herein.

TABLE 15
Young's modulus values (in N/mm²) of
various PVOH/starch-containing films.

| | | Total Starch Content | | | | |
|---|---|---|---|---|---|---|
| Starch | Modification | 0 PHR | 10 PHR | 20 PHR | 30 PHR | 40 PHR |
| A | Cationic | 50 | 38 | 40 | 52 | 45 |
| B | Cationic | 50 | 47 | 68 | 41 | 38 |
| H | Cationic | 50 | | | | 31 |
| J | Cationic | 50 | | | | 41 |
| A:B | Cationic | 50 | | | | 49 |
| A:H | Cationic | 50 | 52 | 36 | 35 | 38 |
| A:J | Cationic | 50 | | | | 39 |
| C | Hydroxyethyl | 50 | 44 | 38 | 41 | 45 |
| | (low MW) | | | | | |
| G | Hydroxyethyl | 50 | 59 | 60 | 74 | 82 |
| | (high MW) | | | | | |
| D | None | 50 | | | | 68 |
| E | None | 50 | | | | 74 |

Films comprising unmodified starch exhibited increasing Young's modulus with increasing starch loading (i.e., increasing starch:PVOH ratio), indicative of a more rigid film with increasing starch content. Films comprising Starch G, a hydroxyethylated starch, also exhibited increasing Young's modulus with increasing starch content, though increasing the content of a hydroxyethylated starch having a lower average molecular weight than that of Starch G did not provide the same effect. In particular, increasing the loading of cationic-modified starch, either as a single starch or a blend of two cationic starches, generally did not increase Young's modulus of the resulting films.

As used herein, the term “cook %” refers to the maximum water solubility after gelatinization of a starch which is the maximum weight percentage of starch that dissolves in water under cooking conditions of heating such as direct steam injection and mixing in water at about 95° C. for about 30 minutes.

As used herein and unless specified otherwise, the term “water-soluble film” refers to any film, at a thickness of about 1.5 mil (about 0.038 mm), having a dissolution time of 300 seconds or less in water at a temperature of about 20° C. (68° F.) in accordance with MonoSol Test Method MSTM-205 as set forth herein. For example, the dissolution time optionally can be about 300 seconds or less, about 250 seconds or less, about 200 seconds or less, about 100 seconds or less, about 60 seconds or less, or about 30 seconds or less at a temperature of about 80° C., about 70° C., about 60° C., about 50° C., about 40° C., about 20° C., about 10° C., or about 5° C. The dissolution time optionally can be about 300 seconds or less at a temperature of about 40° C. (104° F.). In embodiments wherein the dissolution temperature is not specified, the water-soluble film, has a dissolution time of 300 seconds or less at a temperature no greater than about 80° C.

As used herein and unless specified otherwise, the term “cold water-soluble” refers to any film, at a thickness of about 1.5 mil (about 0.038 mm), having a dissolution time of 300 seconds or less at 10° C. as determined according to MSTM-205. For example, the dissolution time optionally can be 200 seconds or less, 100 seconds or less, 60 seconds or less, or 30 seconds at a temperature of about 10° C.

As used herein and unless specified otherwise, the term “5° C. cold water-soluble” refers to any film, at a thickness of about 1.5 mil (about 0.038 mm), having a dissolution time of 300 seconds or less at 5° C. as determined according to MSTM-205. For example, a 1.5 mil (about 38 μm) thick water-soluble film can have a dissolution time in water of 300 seconds or less, 200 seconds or less, 100 seconds or less, 60 seconds or less, 30 seconds or less, or 20 seconds or less at a temperature of about 5° C.

“Comprising” as used herein means that various components, ingredients or steps that can be conjointly employed in practicing the present disclosure. Accordingly, the term “comprising” encompasses the more restrictive terms “consisting essentially of” and “consisting of.” The present compositions can comprise, consist essentially of, or consist of any of the required and optional elements disclosed herein. The invention illustratively disclosed herein suitably may be practiced in the absence of any element or step which is not specifically disclosed herein.

All percentages, parts and ratios referred to herein are based upon the total dry weight of the water-soluble film, total solid contents or article of the present disclosure, as the case may be, and all measurements made are at about 25° C., unless otherwise specified.

All ranges set forth herein include all possible subsets of ranges and any combinations of such subset ranges. By default, ranges are inclusive of the stated endpoints unless stated otherwise. Where a range of values is provided, it is understood that each intervening value between the upper and lower limit of that range and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also contemplated to be part of the disclosure.

It is expressly contemplated that for any number value described herein, e.g. as a parameter of the subject matter described or part of a range associated with the subject matter described, an alternative which forms part of the description is a functionally equivalent range surrounding the specific numerical value (e.g. for a dimension disclosed as “20 cP” an alternative embodiment contemplated is “about 40 cP”). Likewise, a value described by “about” expressly includes as an alternative embodiment the specific value itself (e.g. for an endpoint described as “about 40” an alternative embodiment contemplated is “40”).

As used herein and unless specified otherwise, the terms “wt. %” and “wt %” are intended to refer to the composition of the identified element in “dry” (non water) parts by weight of the entire water-soluble film, total solid content, or article.

As used herein and unless specified otherwise, the term “PHR” (“phr”) is intended to refer to the composition of the identified element in parts per one hundred parts total polymers or parts per one hundred parts in total the PVOH and water-soluble starch in the water-soluble film or aqueous solution.

The term “Renewable Carbon Index (“RCI”)” refers to the fraction (or percentage) of the carbon atoms in the average structure of, for example, an anionic surfactant, hydrophilic syndetic, hydrophobic syndetic or optionally a solvent which are derived from feedstocks other than petroleum or natural gas. Typically, and desirably, when such components of water-soluble films are produced from natural materials or in a sustainable manner, the RCI will be in excess of 0.75 or “75%”, due to the use of materials found in nature, or to the use of feedstocks derived from sustainable sources such as plants, fungi or algae, products of bacterial fermentation processes, or products of treatments of plant-, fungal- or algae-derived biomass. The major challenges in the formulation of water-soluble films with desirably high RCIs are the selection of a few suitable materials that are economically viable, while delivering performance that is as good as or better than the conventional products.

The starch are materials of desirably high RCI and are derived from raw material sources such as plants.

As used herein, the terms “substantially” or “essentially” refers to being largely but not necessarily wholly that which is specified, such as in an amount of at least about 80 wt. %, at least about 85 wt. %, at least about 90 wt. %, at least about 91 wt. %, at least about 92 wt. %, at least about 93 wt. %, at least about 94 wt. %, at least about 95 wt. %, at least about 96 wt. %, at least about 97 wt. %, at least about 98 wt. %, at least about 99 wt. %, or at least about 99.5 wt. % of the specified substance, or in a range of about 80-100 wt. %, about 90-100 wt. %, about 95-100 wt. %, about 96-100 wt. %, about 97-100 wt. %, about 98-100 wt. %, or about 99-100 wt. % of the specified substance.

As used herein, the term “bulk phase separation” refers to phase separation with a phase domain less than about 2000 μm, or less than about 1000 μm, or less than about 900 μm, or less than about 800 μm, or less than about 700 μm, or less than about 600 μm, or less than about 500 μm, or less than about 400 μm, or less than about 300, or less than about 200 μm, or less than about 100 μm, or less than about 50 μm, or less than about 10 μm, or even less than about 1 μm.

The term “consisting essentially of” as used herein, limits the scope of a claim to the specified materials or steps and those that do not materially affect the basic and novel characteristic(s) of the claimed invention.

The term “consisting of” as used herein, excludes any element, step, or ingredient not specified in the claim.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

As used herein the term “comprising” or “comprises” is used in reference to compositions, methods, and respective component(s) thereof, that are essential to the invention, yet open to the inclusion of unspecified elements, whether essential or not. Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components or process steps, the present technology also specifically includes embodiments consisting of, or consisting essentially of, such materials, components or processes excluding additional materials, components or processes (for consisting of) and excluding additional materials, components or processes affecting the significant properties of the embodiment (for consisting essentially of), even though such additional materials, components or processes are not explicitly recited in this application.

As used herein the term “consisting essentially of refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

“A” and “an” as used herein indicate “at least one” of the item is present; a plurality of such items may be present, when possible.

“About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. As used herein, the term “about” when used in connection with a value may refer to ±10% variation from the value. Other than in the operating examples, or where otherwise indicated, all numbers expressing quantities of ingredients or reaction conditions used herein should be understood as modified in all instances by the term “about.”

As used herein, the term “substantially no,” “essentially free” or “substantially free” as used in reference to a particular component may mean that any of the component present constitutes less than 10% by weight, such as less than 9%, less than 8%, less than 7%, less than 6%, less than 5%, less than 4%, less than 3%, less than 2%, less than 1%, less than 0.5% or less than 0.1% by weight.

As used herein, and unless specified otherwise the term “partially” refers to a range of more than 0% and lower than 100%.

As used herein, the term “room temperature” may refer to a temperature in a range of 25° C.±5° C., or 25° C.±3° C.

As used herein, the term “substantially unchanged” by a process (e.g., reacting or heating) refers to a change in value of a characteristic of less than 20%. In embodiments, “substantially unchanged” refers to a change in value of a characteristic of less than 20%, less than 10%, less than 5%, less than 1%, less than 0.5%, or less than 0.1% relative to the value of the characteristic before the process.

As used herein, the term “and/or” includes any and all combinations of one or more of the associated listed items.

As used herein, the term “between” in the context of a range is inclusive of the two ends of the range, unless specified otherwise.

The abbreviation, “e.g.” or “i.e.” are used herein to indicate a non-limiting example. Thus, the abbreviation “e.g.” or “i.e.” is synonymous with the term “for example.” Where used herein, the terms “example” and “such as,” particularly when followed by a listing of terms, are merely exemplary and illustrative and should not be deemed to be exclusive or comprehensive.

The foregoing description is given for clearness of understanding only, and no unnecessary limitations should be understood therefrom, as modifications within the scope of the disclosure may be apparent to those having ordinary skill in the art.

All patents, publications and references cited herein are hereby fully incorporated by reference. In case of conflict between the present disclosure and incorporated patents, publications and references, the present disclosure should control.

1. A water-soluble film comprising:
a water-soluble polyvinyl alcohol (PVOH); and
a water-soluble starch,
wherein the water-soluble starch has a cook % of at least about 5 wt. %,
wherein the water-soluble starch is present in an amount in a range of about 5-65 wt. % by weight of the water-soluble film, and
wherein the PVOH and the water-soluble starch are miscible or have a phase domain smaller than 2000 μm in the water-soluble film.

2.-4. (canceled)

5. The water-soluble film of claim 1, wherein the water-soluble film has a renewable carbon index (RCI) higher than about 50%.

6. (canceled)

7. The water-soluble film of claim 1, wherein the water-soluble starch has a cook % of at least about 10 wt. %, or at least about 15 wt. %.

8.-10. (canceled)

11. The water-soluble film of claim 1, wherein the water-soluble starch comprises an amylose content in a range of 0-50 wt. % of the water-soluble starch.

12. (canceled)

13. (canceled)

14. The water-soluble film of claim 1, wherein the water-soluble starch is present in an amount in a range of about 20-60 wt. % by weight of the water-soluble film.

15. (canceled)

16. (canceled)

17. The water-soluble film of claim 1, wherein the water-soluble starch comprises a non-ionic group-modified starch having a level of modification in a range of about 0.1-10 mol. %.

18. (canceled)

19. The water-soluble film of claim 1, wherein the water-soluble starch comprises a cationic group-modified starch having a degree of modification in a range of about 0.01-10 mol. %, or about 0.1-1 mol %.

20. (canceled)

21. The water-soluble film of claim 16, wherein the cationic group-modified starch comprises cationic quaternary ammonium group-modified starch having a structure of Formula A, wherein R₁, R₂, and R₃ each independently are H or a C₁-C₁₀ alkyl or C₁-C₁₀ hydroxyalkyl group, wherein R₄ is a linear or branched C₁-C₁₀ alkylene or C₁-C₁₀ hydroxyalkylene group, optionally substituted with one or more heteroatom-containing groups, and wherein X is an ether or an ester linkage connecting R₄ to the starch.

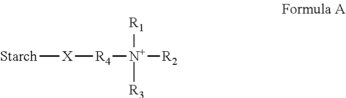

22. The water-soluble film of claim 21, wherein the R₁, R₂ and R₃ are identical C₁-C₄ alkyl groups and R₄ is a C₁-C₆ hydroxyalkylene group.

23. (canceled)

24. The water-soluble film of claim 21, wherein R₁, R₂ and R₃ each are a methyl group and R₄ is a C₃-C₆ hydroxyalkylene group.

25. (canceled)

26. (canceled)

27. The water-soluble film of claim 21, wherein the cationic group-modified starch comprises a starch modified with a 2-diethylaminoethyl salt, a 2,3-epoxypropyltrimethylammonium salt, or a 2-hydroxy-3-(trimethylammonium)propyl salt, or a combination thereof.

28.-31. (canceled)

32. The water-soluble film of claim 1, wherein the polyvinyl alcohol comprises an anionic group-modified polyvinyl alcohol having a degree of modification in a range of about 0.1-10 mol. %, or about 1.0-5.0 mol. %.

33. (canceled)

34. The water-soluble film of claim 32, wherein the anionic group-modified polyvinyl alcohol comprises a polyvinyl alcohol modified with itaconic acid, monomethyl maleate (MMM), methyl acrylate (MA), aminopropyl sulfonate, maleic acid, maleic anhydride, n-vinylpyrrolidone, n-vinylcaprolactam, a derivative of any of the foregoing, or a combination thereof.

35. The water-soluble film of claim 34, wherein the anionic group-modified polyvinyl alcohol comprises the polyvinyl alcohol modified with monomethyl maleate, methyl acrylate, or a combination thereof.

36. The water-soluble film of claim 1, further comprising a plasticizer present in a range of about 5.0-40.0 wt. % of by weight of the water-soluble film.

37. The water-soluble film of claim 36, wherein the plasticizer comprises sorbitol, glycerine, glycerol, diglycerol, propylene glycol, dipropylene glycol, ethylene glycol, diethylene glycol, triethylene glycol, a polyethylene glycol up to MW 400, 2-methyl-1,3-propanediol, ethanolamines, trimethylolpropane (TMP), a polyether polyol, isomalt, maltitol, xylitol, erythritol, adonitol, dulcitol, pentaerythritol, mannitol, a sugar alcohol, or a combination thereof.

38. The water-soluble film of claim 36, wherein the plasticizer comprises a bio-based plasticizer.

39. The water-soluble film of claim 38, wherein the bio-based plasticizer comprises glycerin and/or sorbitol.

40.-42. (canceled)

43. The water-soluble film of claim 1, further comprising one or more of an anti-foaming agent, an antioxidant, a disinfectant, an anti-blocking agent, a filler, sodium metabisulfite, sodium hydroxide, a matting agent, a slip agent, a dispersant, or a combination thereof.

44. The water-soluble film of claim 1, wherein the water-soluble film has a solubility time in water in a range of 30-300 second at a temperature in a range of 5-95° C. according to MSTM-205.

45. The water-soluble film of claim 44, wherein the solubility time is in the range of 30-300 second at a temperature of about 10° C. and about 5° C.

46. The water-soluble film of claim 1, wherein the water-soluble film has a maximum stress of at least about 10 MPa.

47. The water-soluble film of claim 1, wherein the water-soluble film has a strain at break of at least of about 150%.

48. The water-soluble film of claim 1, wherein a weight ratio of the polyvinyl alcohol to the water-soluble starch is in a range of about 10:1 to about 1:8, or about 9:1 to about 1:7, or about 5:1 to about 1:6, or about 4:1 to 1:2, or about 4:1 to about 1:1.

49.-52. (canceled)

53. The water-soluble film-comprising of claim 1, wherein:
the water-soluble polyvinyl alcohol comprises a water-soluble anionic group-modified polyvinyl alcohol (PVOH) having a degree of modification in a range of about 1-5 mol. %; and
the water-soluble starch comprises a water-soluble cationic group-modified starch having a degree of modification in a range of about 0.05-5 mol. % and a 5 wt. % aqueous solution Brookfield viscosity in a range of about 1-200 cP at 20 rpm and 87.8° C.,
wherein the cationic group-modified starch has a cook % of at least about 5 wt. %,
wherein the cationic group-modified starch is present in an amount in a range of about 20-60 wt. % by weight of the water-soluble film, and
wherein the anionic group-modified PVOH and the cationic group-modified starch are miscible or have a phase domain smaller than 2000 μm in the water-soluble film.

54. An aqueous solution comprising:
a water-soluble polyvinyl alcohol (PVOH);
a water-soluble starch; and
water,
wherein the water-soluble starch has a cook % of at least about 5 wt. %, or at least about 10 wt. %, or at least about 15 wt. %,
wherein the aqueous solution has a total solid content of at least 15 wt. % by weight of the aqueous solution,
wherein the water-soluble starch is present in an amount in a range of about 5-65 wt. % by weight of the total solid content, and
wherein the water-soluble polyvinyl alcohol (PVOH) and the water-soluble starch are miscible or have no bulk phase separation in the aqueous solution for at least 24 hours by visual inspection at a temperature in a range of about 20-100° C.

55.-72. (canceled)

73. The aqueous solution of claim 54, wherein the water-soluble starch comprises a cationic group-modified starch having a degree of modification in a range of about 0.01-10 mol. %, or about 0.1-1 mol. %.

74. (canceled)

75. The aqueous solution of claim 73, wherein the cationic group-modified starch comprises a cationic quaternary ammonium group-modified starch having a structure of Formula A, wherein R₁, R₂, and R₃ each independently are H or a C₁-C₁₀ alkyl or C₁-C₁₀ hydroxyalkyl group, wherein R₄ is a linear or branched C₁-C₁₀ alkylene or C₁-C₁₀ hydroxyalkylene group, optionally substituted with one or more heteroatom-containing groups, and wherein X is an ether or an ester linkage connecting R₄ to the starch. 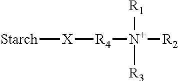
Formula A

76.-85. (canceled)

86. The aqueous solution of claim 54, wherein the polyvinyl alcohol comprises an anionic group-modified polyvinyl alcohol having a degree of modification in a range of about 0.1-10 mol. %, or about 1-5 mol. %.

87. (canceled)

88. The aqueous solution of claim 86, wherein the anionic group-modified polyvinyl alcohol comprises a polyvinyl alcohol modified with itaconic acid, monomethyl maleate (MMM), methyl acrylate (MA), aminopropyl sulfonate, maleic acid, maleic anhydride, n-vinylpyrrolidone, n-vinylcaprolactam, a derivative of any of the foregoing, or a combination thereof.

89. The aqueous solution of claim 88, wherein the anionic group-modified polyvinyl alcohol comprises a polyvinyl alcohol modified with monomethyl maleate, methyl acrylate, or a combination thereof.

90.-101. (canceled)

102. A method of forming a water-soluble film, comprising:
casting the aqueous solution of claim 54 onto a substrate at a specified thickness; and
drying water from the cast aqueous solution to form the water-soluble film.

103. An article comprising:
a pouch made of the water-soluble film of claim 1 defining an interior pouch volume.

104. The article of claim 103, further comprising a chemical composition contained in the interior pouch volume.

105. The article of claim 104, wherein the chemical composition is a household care composition.

106. The article of claim 105, wherein the household care composition is a liquid laundry detergent or a dishwashing detergent.

107.-109. (canceled)

110. The article of claim 103, wherein the pouch has a release time no more than 300 seconds after mixing in water at a temperature of about 15° C. when measured according to MSTM-126.

111. The article of claim 103, wherein the pouch has a release time in a range of 30-150 seconds after mixing in water at about room temperature when measured according to MSTM-126.

112. The water-soluble film of claim 17, wherein the non-ionic group-modified starch is a hydroxyethyl-modified starch, a hydroxypropyl-modified starch, or a combination thereof.

113. The water-soluble film of claim 112, wherein the hydroxyethyl-modified starch is present in the film in an amount in a range of about 10 PHR to about 80 PHR, or about 10 PHR to about 40 PHR.

114. The water-soluble film of claim 113, characterized by having a strain at break greater than 300%, when measured according to the Strain at Break Test.

115. The water-soluble film of claim 1, wherein the water-soluble polyvinyl alcohol comprises bio-based polyvinyl alcohol.

116. The water-soluble film of claim 115, wherein the ratio of the amounts (by weight) of bio-based polyvinyl alcohol and non-bio-based polyvinyl alcohol is in a range of about 99:1 to about 1:99, or about 95:5 to about 5:99, or about 80:20 to about 20:80, or about 70:30 to about 30:70, or about 60:40 to about 40:60.
